(19) United States
(12) Patent Application Publication
(10) Pub. No.: US 2012/0102418 A1
(43) Pub. Date: Apr. 26, 2012

(54) Sharing Rich Interactive Narratives on a Hosting Platform

(75) Inventors: Joseph M. Joy, Redmond, WA (US); Michael S. Cooper, Vashon, WA (US); Kanchen Rajanna, Bangalore (IN)

(73) Assignee: MICROSOFT CORPORATION, Redmond, WA (US)

(21) Appl. No.: 13/337,299

(22) Filed: Dec. 27, 2011

Related U.S. Application Data
(63) Continuation-in-part of application No. 13/008,732, filed on Jan. 18, 2011.
Application No. 13/008,732 is a continuation-in-part of application No. 13/008,484, filed on Jan. 18, 2011.
Application No. 13/008,484 is a continuation-in-part of application No. 13/008,616, filed on Jan. 18, 2011.
Application No. 13/008,616 is a continuation-in-part of application No. 13/008,324, filed on Jan. 18, 2011.
Application No. 13/008,324 is a continuation-in-part of application No. 12/347,868, filed on Dec. 31, 2008, now Pat. No. 8,046,691.

(51) Int. Cl. G06F 3/048; G06F 21/00

(52) U.S. Cl. 715/762; 726/30

(57) ABSTRACT

This patent relates to techniques associated with rich interactive narratives (RINs) and other RIN-related content, including techniques for sharing and monetizing such content. For example, a RIN-related content item (e.g., a themed RIN book) might be obtained from a hosting platform, edited, and re-published on the hosting platform. In some circumstances, the edit might include or serve as one or more annotations. One or more sharing restrictions associated with the published content item can be enforced. This enforcement can then be utilized to monetize the published content item by virtue of one or more sharing arrangements.

### CROSS-REFERENCE TO RELATED APPLICATIONS

This application is a continuation-in-part of, and claims priority from, U.S. patent application Ser. No. 13/008,732, filed Jan. 18, 2011, U.S. patent application Ser. No. 13/008,484, filed Jan. 18, 2011, U.S. patent application Ser. No. 13/008,616, filed Jan. 18, 2011, and U.S. patent application Ser. No. 13/008,324, filed Jan. 18, 2011, which in turn are all continuation-in-parts of, and all claim priority from, U.S. patent application Ser. No. 12/347,868, filed Dec. 31, 2008, now U.S. Pat. No. 8,046,691.

### BACKGROUND

Creating compelling, interactive, and engaging media content (or content) using computing device can be a daunting task. This is especially true if the author of the content is not a developer or programmer. While there are many tools currently available that do a good job of allowing a user to create a constrained or restricted definition of content, there is a dearth of tools available for creating rich content.

Generally, constrained content includes traditional media such as images, video, and presentations. For example, there are many tools that allow a user to create and edit videos and images and to create presentations. Each of these tools is powerful, but they are constrained to the creation of a particular type of constrained content.

Rich content can include complex forms of media as well as interactive multimedia. In addition, rich content can include media obtained from all over the Web. For example, media on the Web includes interactive maps and visualization tools, such as Pivot (a software application from Microsoft that allows users to interact with and search large amounts of data), and PhotoSynth (a software application from Microsoft that generates a three-dimensional model of a group of digital photographs).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques associated with rich interactive narratives (RINs) and other RIN-related content are described, including techniques for sharing and monetizing such content. For example, in accordance with the described techniques, a content item that includes at least one media data item represented by at least one RIN can be defined. These consumables, which may be referred to herein as RIN books, can be created, edited, and/or otherwise shared at a very granular level, just as individual RINs and RIN components can. Thus, RIN books and other RIN-related content can provide a favorable alternative to traditional entertainment mediums such as interactive television, movies, etc.

The granular level by which RINs, RIN components, and RIN books can be created and/or edited can permit extremely rich and personalized styling of such items. The rich and personalized style of a RIN or RIN book is manifest in that RIN's/RIN book's theme. A RIN's or RIN book's theme can be thought of as the unique “look and feel” of that RIN/RIN book that defines the end-to-end styling and user experience that it provides.

In at least one embodiment, functionality associated with one or more RIN experience tools can be utilized to create, edit, access, publish, distribute, acquire, and/or otherwise share RIN-related content. For example, a themed RIN book can be obtained, edited and then re-published as a derivative work (i.e., a derivative RIN book). Said another way, others can leverage experiences and experiences streams from a published RIN-related content (e.g., RIN books, RIN documents, etc.) to create their own derivative content. For example, a user might create a personalized summary of a RIN that includes references to specific locations or states within specific experience streams in the RIN. The RIN can thus be augmented with additional textual or multimedia annotations contributed by the user. The result might be a derivative work that in turn may be re-published

In this regard, a user might edit a RIN book while the user is interactively exploring a linear and/or non-linear scripted path of an experience stream provided by the RIN book. Alternatively or additionally, the user may not be interactively exploring the RIN book when they edit the RIN book. In some cases an edit may not change, or affect, the RIN book's theme—at least significantly. In other cases, however, the edit may significantly change the theme.

For example, the user might express their impressions by adding media data items such as one or more text note annotations and/or sound clip annotations describing their experience. Alternatively or additionally, the user might express their expertise by adding one or more annotations that include other types of RIN-related content. For instance, the user might utilize one or more RINs, RIN components, and/or more complex media data items to edit the RIN book. As a result, the annotation(s) might include one or more new interactive explorative experiences (e.g., a new scripted path, etc.) that in some circumstances may significantly change the RIN book's theme.

In at least one embodiment, a RIN books hosting platform (e.g., cloud-based application platform) can be configured to allow RIN-related content to be shared. In this regard, users such as content authors (creators/editors), owners, distributors, retailers, and/or end users may utilize the RIN books hosting platform as a forum for sharing the RIN-related content.

For example, a RIN-related book and another RIN-related content item published on the RIN books hosting platform might be obtained from the RIN books hosting platform. The RIN-related content item may then be utilized to edit the RIN-related book, which may then be re-published on the RIN books hosting platform. In some circumstances, the edit might include or serve as one or more annotations that express a user's impressions, expertise, etc.

In at least one embodiment, the RIN books hosting platform can also be configured to allow RIN-related content to be monetized. To accomplish this, any number of sharing arrangements might be supported by virtue of configurable sharing controls provided by the RIN books hosting platform. These configurable sharing controls may enforce restrictions associated with the sharing limitations for some or all of the RIN-related content items published on the RIN books hosting platform.

For example, a RIN related content item can be published on the RIN books hosting platform. One or more sharing restrictions associated with the published RIN-related content item can be enforced by one or more of the controls. The enforcement of this sharing restriction(s) can then be utilized to monetize the content item by virtue of a sharing arrangement. For instance, a fee specific to the RIN-related content item and/or associated with a membership/subscription to the RIN books hosting platform might be required for creating, editing, publishing, distributing, accessing, and/or otherwise sharing the RIN-related content item.

Embodiments of the above-mentioned RIN authoring system and method facilitate the creation and/or editing of RIN documents in a visual and graphical manner. An instance of a RIN constructed in accordance with the data model, mentioned above and described in detail below can be captured in a RIN document or file, which may be considered logically as an integral unit. Therefore, the term RIN as used herein may refer to a RIN and/or a RIN document for capturing an instance of the RIN.

Embodiments of the system and method allow someone having no programming or coding background to easily create and/or edit RIN documents. In addition, embodiments of the system and method are pluggable and extensible, which means that an author or other type of user can create and/or edit rich content by using media technology that currently exists and/or that may exist in the future. In some cases the content is obtained by bringing in media and multi-media from local sources and from Web sources.

A RIN document is a document that combines rich multimedia content from a variety of sources in a narrative format with interactive exploration. This combination is a compelling way to present and absorb information, and is much more powerful that the narrative or interactive exploration in isolation. The RIN document is a new media type that is not tied to one particular implementation of technology. In fact, the RIN document is an extensible specification for the orchestration of multiple visualization technologies to create rich and compelling interactive narratives.

In at least one embodiment, an experience stream may be created by obtaining one or more data bindings associated with an experience that may be presented to a user and defining a trajectory that includes one or more individual key frames of a keyframe sequence defining a timeline. The experience stream can then be defined based on the data binding(s) obtained and trajectory.

A distinction can be made between an experience that is an environment associated with a data binding(s) and presentation of that environment, and an experience stream that is the data that defines a scripted path through the environment, and thus the data that produces the scripted behavior of the scripted path that is perceived by the user.

Embodiments of the RIN authoring system and method allow the author to easily and quickly generate engaging RIN documents in a simple graphical and visual manner. Using embodiments of the system and method, an author can define keyframes using one graphical user interface for multiple pluggable experience streams and orchestrate the keyframe sequences (known as trajectories or paths) through those keyframes. As explained in detail below, the phrase “experience stream” includes a scripted path through a specific environment and the associated environmental data, artifacts, and trajectory. The author may also choose to have embodiments of the system and method automatically generate portions of the RIN document while the author manually generates the remainder. The author and/or one or more other users may then be free to go back and make additions to or edit the created RIN document using embodiments of the system and method.

Embodiments of the RIN authoring system can include graphical user interface containing a media library, having experience streams obtained from a variety of sources and a timeline for temporally ordering selected experience streams. The timeline can have a plurality of different tracks, allowing the inclusion of various layers of audio and visual experience streams in the RIN document.

A keyframe creation and editing module allows an author to define keyframes and their associated attributes and trajectories. The author is free to add as many experience streams to the timeline as desired, and in whatever ordering. The result is a RIN document. A narrative properties module allows the author to add information to the RIN document, such as title, author, description, and so forth. A RIN document preview module facilitates the preview of the created RIN document in a preview window so that the author can review his creation. In some embodiments this preview window uses Silverlight® by Microsoft® Corporation of Redmond, Wash., in a RIN player. This gives the “What you see is what you get” (WYSIWYG) experience to the author. A RIN document publishing module provides a way for the author to publish the RIN document so that others may view.

Embodiments of the RIN authoring method include having the author select experience streams associated with interactive experiences (that may be provided or more experience streams and/or other RIN-related content) from the media library. The author can then drag and drop the selected experience stream from the media library to the timeline. The author can place the experience stream at a location on the timeline when the experience stream should appear in the RIN document. Moreover, the author can select an experience stream from the timeline and can edit this selected experience stream to define keyframes that indicate a state of a viewer's experience at viewing the interactive experience at any point in time that the author wants to capture.

The selection of the experience stream from the timeline launches the discovery of the type of experience stream selected and its corresponding experience-specific user interface. This experience-specific user interface enables the author to define and edit keyframes for the particular type of experience stream. For example, an interactive map visualization experience stream will have one type of experience-specific user interface, while a PhotoSynth experience stream will have a different type of experience-specific user interface.

The experience-specific user interface allows the author to define keyframes from the experience stream. These keyframes indicate what the author wants a viewer to see at any point in time in the RIN document. Using the experience-specific user interface, the author can define for each keyframe a zoom level a duration of time to stay at each keyframe, and the speed to go from one keyframe to another. Moreover, using the experience-specific user interface the author can define a trajectory for the keyframes, which is a sequence of how the keyframes are shown in the RIN document.

The author can add as many experience streams as desired. Further, the author can define and edit keyframes for these experience streams as desired. Once the author is finished adding experience streams, then the author has the option to add narrative properties to the RIN document. In addition, the author can optionally have embodiments of the RIN authoring system and method generate a visual table of contents. In some embodiments this visual table of contents is animated using the experience streams and keyframes. The visual table of contents is automatically created using metadata, experience streams, keyframes, and other data associated with the RIN document.

Once the author has created the RIN document, embodiments of the method allow the author to preview the RIN document in the preview window. If the author desires additional changes, these changes can be made using the above-described method. If the author is satisfied with the RIN document that has been created, then the author may publish it for others to view and enjoy.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings.

FIG. 1 is a simplified diagram of a rich interactive narrative (RIN), including a narrative, scenes and segments.

FIG. 2 is a simplified diagram of a RIN segment including one or more experience streams, at least one screenplay, and a resource table.

FIG. 3 illustrates a relative position and size of an exemplary group of four experience stream viewports.

FIG. 4 is a simplified diagram of an experience stream made up of data bindings and a trajectory. The data bindings include environment data, as well as artifacts and highlighted regions. The trajectory includes keyframes and transitions, and markers.

FIG. 4A illustrates an example technique or method that may be implemented in accordance with at least one embodiment.

FIG. 5 is a simplified diagram of an experience stream trajectory along with markers, artifacts and highlighted regions.

FIG. 6 is a block diagram of an embodiment of a system for processing RIN data to provide a narrated traversal of arbitrary media types and user-explorable content of the media.

FIG. 6A illustrates an example block diagram of a reference player system that may be implemented in accordance with at least one embodiment

FIG. 7 is a block diagram of a generalized and exemplary environment representing one way of implementing the creation, deposit, retention, accessing and playing of RIN.

FIG. 8 is a block diagram illustrating a general overview of embodiments of the RIN authoring system and method implemented in the RIN implementation environment.

FIG. 9 is a flow diagram illustrating the general operation of embodiments of the RIN authoring system and method shown in FIG. 8.

FIG. 10 is a flow diagram illustrating the operational details of embodiments of the keyframe creation and editing module shown in FIG. 8.

FIG. 11 illustrates a simplified example of a general-purpose computer system on which various embodiments and elements of the RIN authoring system and method, as described herein, may be implemented.

FIG. 12 illustrates an example themed RIN book that may be implemented in accordance with at least one embodiment.

FIGS. 13-17 illustrate an example computing environment in which a RIN book and/or other RIN-related content items that may be implemented in accordance with at least one embodiment.

FIG. 17A illustrates individual content item types of an example RIN book that may be implemented in accordance with at least one embodiment.

FIG. 17B illustrates example relationships that might exist between RIN books in accordance with at least one embodiment.

FIG. 18 illustrates an example technique or method that may be implemented in accordance with at least one embodiment.

FIG. 19 illustrates an example implementation environment in which a RIN books hosting platform may be implemented in accordance with at least one embodiment.

FIG. 20 illustrates an example computing environment in accordance with at least one embodiment.

FIG. 21 illustrates an example technique or method that may be implemented in accordance with at least one embodiment.

FIG. 22 illustrates an example system in which the described techniques may be implemented in accordance with at least one embodiment.

FIGS. 23-26 illustrate an example computing environment in which a console associated with a RIN book and/or other RIN-related content items may be implemented in accordance with at least one embodiment.

FIG. 27 illustrates an example environment in accordance with at least one embodiment.

FIG. 28 illustrates an example of how a resource resolution module might be implemented in accordance with at least one embodiment.

FIG. 29 illustrates an example technique or method that may be implemented in accordance with at least one embodiment.

FIG. 30 illustrates an example interactive explorative situation in accordance with at least one embodiment.

FIG. 31 illustrates an example RIN segment state in accordance with at least one embodiment.

FIG. 32 illustrates an example implementation environment in which a RIN books hosting platform may be implemented in accordance with at least one embodiment.

FIG. 33 illustrates an example virtual storefront instance in accordance with at least one embodiment.

FIG. 34 illustrates an example system in which the described techniques may be implemented in accordance with at least one embodiment.

### DETAILED DESCRIPTION

### Overview

Techniques associated with rich interactive narratives (RINs) and other RIN-related content are described, including techniques for sharing and/or deriving content and monetizing such content. For example, in accordance with the described techniques, a content item with at least one media data item represented by at least one RIN can be defined. These consumables, which may be referred to herein as RIN books, can be created, edited, and/or otherwise shared at a very granular level, just as individual RINs and RIN components can. Thus, RIN books and other RIN-related content can provide a favorable alternative to traditional entertainment mediums such as interactive television, movies, etc.

The granular level by which RINs, RIN components, and RIN books can be created and/or edited permits an extremely rich and highly personalized styling of such items. The rich and personalized style of a RIN or RIN book is manifest in that RIN's/RIN book's theme. A RIN's or RIN book's theme can be thought of as the unique “look and feel” of that RIN/RIN book that defines the end-to-end styling and user experience that it provides.

Thus, a themed RIN book might include a distinct design theme and identity that uniquely represents it—in a similar manner to a theme of a book, magazine, movie, website, or other type of media item. For example, a themed RIN book might be designed and identified with a title such as “The Complete Human Body”, “Recipes From Around the World, 1st Edition”, “Flight-100 years of Aviation”, “Grand Canyon Adventure”, and the like.

The theme of a RIN book can be determined by the RIN's attributes. Without limitation, these attributes can include one or more fonts, colors, templates user interface (UI) characteristics and controls, interaction characteristics and behaviors attributed to the RIN book, and/or any other aspect that results in the unique “look and feel” that defines the end-to-end styling and user experience that that RIN book provides.

In at least one embodiment, functionality associated with one or more RIN experience tools can be utilized to create, edit, access, publish, distribute, acquire, and/or otherwise share RIN-related content items.

A RIN or RIN book may be edited, for instance, by a user while the user is interactively exploring a scripted path of an interactive explorative experience provided by the RIN or RIN book. More particularly, and as explained in more detail below, a RIN, and thus a RIN book, can include any number of individual experience streams that include one or more linear and/or non-linear scripted paths through a specific environment. In addition, individual experience streams can also include environmental data (e.g., media data items), artifacts, highlights, and a trajectory that are associated with the scripted path.

For example, in at least one embodiment, a themed RIN book can be obtained, edited (e.g., in a manner that changes the RIN book's theme), and then re-published as a derivative work (i.e., a derivative RIN book). In this regard, the user might edit the RIN book while the user is interactively exploring a scripted path of an experience stream provided by that item. Alternatively or additionally, the user may not be interactively exploring the RIN book when they edit the RIN book.

As explained herein, RIN-related content items such as RIN books and RINs may be edited in a variety of ways. For example, the RIN-related items might be edited with media data items such as one or more text note annotations and/or sound clip annotations. Alternatively or additionally, a content item may be edited in other more specific ways, such as with one or more RINs, RIN components, and/or more complex media data items that add new interactive explorative content. As a result, the edits might provide a new rich user experience that changes the RIN book's theme. For example, the edits might include a new interactive explorative pathway through the RIN book that includes the user's annotations.

RIN-related content such as RIN books can be transformed to a variety of suitable forms (e.g., stand-alone, device-dependent, etc.) and shared in a variety of suitable ways. For example, this content might be published and/or otherwise shared on a hosting platform or on one more individual devices (computing and/or non-computing device(s)), such as on a projection device, television device, camera device, computing device, etc. In at least one embodiment, a RIN books hosting platform (e.g., cloud-based application platform) can be configured to allow RIN-related content to be shared. In this regard, users such as content authors (creators/editors), owners, distributors, retailers, and/or end users may utilize the RIN books hosting platform as a forum for sharing the RIN-related content.

For example, a RIN-related book and another RIN-related content item published on the RIN books hosting platform might be obtained from the RIN books hosting platform. The RIN-related content item may then be utilized to edit the RIN-related book, which may then be re-published on the RIN books hosting platform. In some circumstances, the edit might include or serve as one or more annotations that express a user's impressions, expertise, etc. For purposes of discussion, the term re-publishing, as used herein, may refer to publishing an edited version of a previous item (e.g., as a derivative work).

In at least one embodiment, the RIN books hosting platform can also be configured to allow RIN-related content to be monetized. To accomplish this, any number of sharing arrangements might be supported by virtue of configurable sharing controls provided by the RIN books hosting platform. These configurable sharing controls may enforce restrictions associated with the sharing limitations for all or some of the RIN-related content items published on the RIN books hosting platform.

For example, a RIN related content item can be published on the RIN books hosting platform. One or more sharing restrictions associated with the published RIN-related content item can be enforced by one or more of the controls. The enforcement of this sharing restriction(s) can then be utilized to monetize the content item by virtue of one or more associated sharing arrangements. For instance, a fee specific to the RIN-related content item and/or associated with a membership/subscription to the RIN books hosting platform might be required for creating, editing, publishing, distributing, accessing, and/or otherwise sharing the RIN-related content item.

Embodiments of the above-mentioned RIN authoring system and method facilitate the creation and/or editing of RIN documents in a visual and graphical manner. An instance of a RIN constructed in accordance with the data model mentioned above and described in detail below can be captured in a RIN document or file, which may be considered logically as an integral unit. Therefore, the term RIN as used herein may refer to a RIN and/or a RIN document for capturing an instance of the RIN.

Embodiments of the system and method allow someone having no programming or coding background to easily create and/or edit RIN documents. In addition, embodiments of the system and method are pluggable and extensible, which means that an author or other type of user can create and/or edit rich content by using media technology that currently exist and that may exist in the future. The content is obtained by bringing in media and multi-media from local sources and from Web sources.

A RIN document is a document that combines rich multimedia content from a variety of sources in a narrative format with interactive exploration. This combination is a compelling way to present and absorb information, and is much more powerful than the narrative or interactive exploration in isolation. The RIN document is a new media type that is not tied to one particular implementation of technology. In fact, the RIN document is an extensible specification for the orchestration of multiple visualization technologies to create rich and compelling interactive narratives.

In at least one embodiment, an experience stream may be created by obtaining one or more data bindings associated with an experience that may be presented to a user and defining a trajectory that includes one or more individual key frames of a keyframe sequence defining a timeline. The experience stream can then be defined based on the data binding(s) obtained and trajectory.

A distinction can be made between an experience that is an environment associated with the data binding(s) and presentation of that environment, and an experience stream that is the data that defines a scripted path through the environment, and thus the data that produces the scripted behavior of the scripted path that is perceived by the user.

Embodiments of the RIN authoring system and method allow the author to easily and quickly generate engaging RIN documents in a simple graphical and visual manner. Using embodiments of the system and method, an author can define keyframes using one graphical user interface for multiple pluggable experience streams and orchestrate the keyframe sequences (known as trajectories or paths) through those keyframes. As explained in detail below, the phrase “experience stream” includes a scripted path through a specific interactive experience's environment and the associated environmental data, artifacts, and trajectory. The author may also choose to have embodiments of the system and method automatically generate portions of the RIN document while the author manually generates the remainder. The author and/or one or more other users then is free to go back and make additions to or edit the created RIN document using embodiments of the system and method.

Embodiments of the RIN authoring system include a graphical user interface containing a media library, experience streams associated with interactive experiences obtained from a variety of sources and a timeline for temporally ordering selected experience streams over these interactive experiences. The timeline can have a plurality of different tracks, allowing the inclusion of various layers of audio and visual experience streams in the RIN document. Linear segments of RIN content may be linked together nonlinearly, by attaching behaviors to affordances (buttons, embedded artifacts) within an experience that trigger the playing of a new segment of a RIN document.

A keyframe creation and editing module allows an author to define keyframes and their associated attributes and trajectories. The author is free to add as many experience streams to the timeline as desired, and in whatever ordering. The result is a RIN document. A narrative properties module allows the author to add information to the RIN document, such as title, author, description, and so forth. A RIN document preview module facilitates the preview of the created RIN document in a preview window so that the author can review his creation. In some embodiments this preview window uses Silverlight® by Microsoft® Corporation of Redmond, Wash., in a RIN player. This gives the “What you see is what you get” (WYSIWYG) experience to the author. A RIN document publishing module provides a way for the author to publish the RIN document so that others may view and edit the RIN book.

Embodiments of the RIN authoring method include having the author select experience streams associated with interactive experiences from the media library. The author then drags and drops the selected experience from the media library to timeline. The author places the experience stream at a location on the timeline when the experience stream should appear in the RIN segment. Moreover, the author selects an experience stream from the timeline and is able to edit this selected experience stream to define keyframes that indicate a state of a viewer's experience at viewing the RIN document at any point in time that the author wants to capture.

The selection of the experience stream from the timeline launches the discovery of the type of experience stream selected and its corresponding experience-specific user interface. This experience-specific user interface enables the author to define and edit keyframes for the particular type of experience stream. For example, an interactive map visualization experience stream will have one type of experience-specific user interface, while a PhotoSynth experience stream will have a different type of experience-specific user interface.

The experience-specific user interface allows the author to define keyframes from the experience stream. These keyframes indicate what the author wants a viewer to see at any point in time in the RIN document. Using the experience-specific user interface, the author can define for each keyframe serializable logical state that represents the configuration and visual aspects of the experience at a point in time. For example, for a map experience, the state would include the latitude, longitude, map style, and some measure of zoom level. In addition, a keyframe can contain a duration of time to stay at each keyframe, and the speed and transition style to go from one keyframe to another. Moreover, using the experience-specific user interface the author can define a trajectory for the keyframes, which is a sequence of how the keyframes are shown in the RIN document.

The author can add as many experience streams as desired. Further, the author can define and edit keyframes for these experience streams as desired. Once the author is finished adding experience streams, then the author has the option to add narrative properties to the RIN document. In addition, the author can optionally have embodiments of the RIN authoring system and method generate a visual table of contents which may itself be implemented as an interactive experience. In some embodiments this visual table of contents is animated using the experience streams and keyframes. The visual table of contents may be manually created, or automatically created using metadata, experience streams, keyframes, and other data associated with the RIN document.

The authoring tools may also include support for creating experiences and embedding these experiences with artifacts, and binding those artifacts to behaviors, such as launching another RIN segment. Thus created experiences can then be included as experience streams in the timelines of RIN Segments.

Once the author has created the RIN document, embodiments of the method allows the author to preview the RIN document in the preview window. If the author desires additional changes, these changes can be made using the above-described method. If the author is satisfied with the RIN document that has been created, then the author may publish it for others to view and enjoy.

As mentioned above, the described techniques permit users to share their expressions by creating and editing a RIN or RIN book and, in some circumstances, re-publishing the edited RIN/RIN book as a derivative work. As a simple example of sharing a RIN book, consider the example RIN book “Recipes From Around the World, 1st Edition” described above. Assume that this consumable includes an electronic book (E-book) of recipes and at least one RIN that together provide an interactive explorative user experience associated with various recipes. A user might choose to publish this RIN book on a RIN books hosting platform.

Another user might access and interactively explore the RIN book (e.g., for free, by checking it out, for a lease or purchase fee, etc.). The user might also decide to edit the RIN book. The permission to edit the book may or may not require additional steps (e.g., checking it out, paying a fee, etc.) other than those taken to access the RIN book. For example, the user might express their impressions by adding media data items such as one or more text note annotations and/or sound clips describing their experience of preparing the dish (e.g., making pasta, dicing a garlic clove, sautéing the garlic, etc.).

Alternatively or additionally, the user might express their expertise by adding other types of RIN-related content describing the homeopathic healing properties of garlic. In this case, the user might utilize one or more RINs, RIN components, and/or more complex media data items to edit the RIN book content, such as an additional interactive explorative experience for instance. As a result, the edits might provide a new rich user experience that changes the RIN book's theme. For example, the edits might include a new scripted path through the RIN book that includes the user's annotations.

After editing the RIN book, the user might retain the edited RIN book for his/her own purposes. Alternatively or additionally, in the case where the RIN book's theme has been changed by adding annotations and other interactive content describing the homeopathic healing properties of garlic, the user might decide to re-publish the edited book on the RIN books hosting platform as a new derivative RIN book.

As noted above, the new derivative RIN book may provide an interactive explorative user experience regarding the dish's preparation and/or garlic's homeopathic healing properties. The user may thus also decide to rename the new derivative RIN book (e.g., “Recipes From Around the World, 1st Edition—with Homeopathic Properties of Garlic)”. Permission to re-publish the consumable may or may not require additional steps (e.g., checking it out, paying a fee, etc.) other than those taken to access the consumable.

In at least one embodiment, the user might require a fee for other users to access and/or edit the new derivative RIN book. For example, the user might determine that the added annotations and/or other edits provide a new interactive explorative user experience that justifies requiring the fee. In some circumstances, the user might be subject to a sharing arrangement (e.g., contract and/or agreement) with another entity. For example, the fee might be at least partially shared with the publisher of the original RIN book “Recipes From Around the World, 1st Edition”.

Multiple and varied implementations are described herein. Generally, any of the features/functions described with reference to the figures can be implemented using software, hardware, firmware (e.g., fixed logic circuitry), manual processing, or any combination thereof. The terms “module”, “tool”, and/or “component” as used herein may generally represent software, hardware, firmware, or any combination thereof. For instance, the terms “tool” and “module” can represent software code and/or other types of instructions that perform specified tasks when executed on a computing device or devices.

Generally, the illustrated separation of modules, tools or components and functionality into distinct units may reflect an actual physical grouping and allocation of such software, firmware, and/or hardware. Alternatively or additionally, this illustrated separation can correspond to a conceptual allocation of different tasks to the software, firmware, and/or hardware. Furthermore, it is to be appreciated and understood that the illustrated modules, tools, and/or components and functionality described herein can be located at a single site (e.g., as implemented by a computing device), or can be distributed over multiple locations (e.g., as implemented over multiple computing devices).

In the following description of embodiments of a rich interactive narrative (RIN) authoring system and method reference is made to the accompanying drawings, which form a part thereof, and in which is shown by way of illustration a specific example whereby embodiments of the RIN authoring system and method may be practiced. It is to be understood that other embodiments may be utilized and structural changes may be made without departing from the scope of the claimed subject matter.

### I. Rich Interactive Narrative Data Model

In general, embodiments of the rich interactive narrative (RIN) data model described herein are made up of abstract objects that can include, but are not limited to, narratives, segments, screenplays, resource tables, experience streams, sequence markers, highlighted regions, artifacts, keyframe sequences and keyframes. The sections to follow will described these objects and the interplay between them in more detail. It should be noted that this RIN data model also is described in a co-pending application entitled “Data Model and Player Platform for Rich Interactive Narratives,” which was assigned Serial Number No. 13/008,324 and was filed on Jan. 18, 2011.

I.A. Narrative and Scenes

The RIN data model provides seamless transitions between narrated guided walkthroughs of arbitrary media types and user-explorable content of the media, all in a way that is completely extensible. In the abstract, the RIN data model can be envisioned as a narrative that runs like a movie with a sequence of scenes that follow one after another (although like a DVD movie, a RIN could be envisioned as also having isolated scenes that are accessed through a main menu). A user can stop the narrative, explore the environment associated with the current scene (or other scenes if desired), and then resume the narrative where it left off.

A scene is a sequentially-running chunk of the RIN. As a RIN plays end-to-end, the boundaries between scenes may disappear, but in general navigation among scenes can be non-linear. In one implementation, there is also a menu-like start scene that serves as a launching point for a RIN, analogous to the menu of a DVD movie.

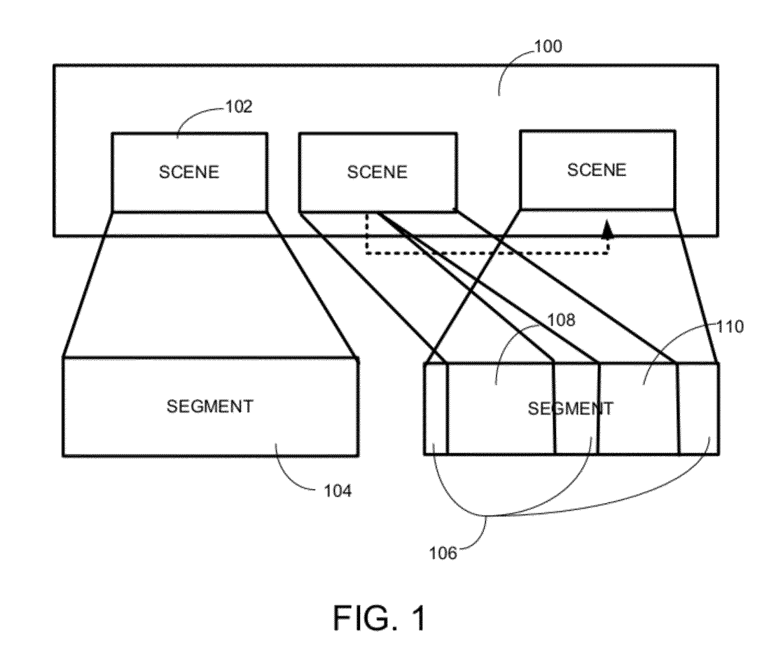

However, a scene is really just a logical construct. The actual content or data that constitutes a linear segment of a narrative is contained in objects called RIN segments. FIG. 1 is a simplified diagram of a rich interactive narrative (RIN), including a narrative, scenes and segments. As shown in FIG. 1, a scene 102 of a RIN 100 can be composed of a single RIN segment 104, or it can be put together using all or portions of multiple segments 106, 108, 110 (some of which can also be part of a different scene). Thus, a scene can be thought of as references into content that is actually contained in RIN segments. Further, it is possible for a scene from one RIN to reference RIN segments from other RINs. This feature can be used to, for example, create a lightweight summary RIN that references portions of other RINs. Still further, one RIN segment may play a first portion of an experience stream and the next RIN segment plays a remaining portion of the segment. This can be used to enable seamless transitions between scenes, as happens in the scenes of a movie.

In one embodiment of the RIN data model, a provision is also made for including auxiliary data. All entities in the model allow arbitrary auxiliary data to be added to that entity. This data can include, for example (but without limitation), the following. It can include metadata used to describe the other data. It can also include data that fleshes out the entity, which can include experience-stream specific content. For example, a keyframe entity (i.e., a sub-component of an experience stream, both of which will be described later) can contain an experience-stream-specific snapshot of the experience-stream-specific state.

The auxiliary data can also be data that is simply tacked on to a particular entity, for purposes outside the scope of the RIN data model. This data may be used by various tools that process and transform RINs, in some cases for purposes quite unrelated to playing of a RIN. For example, the RIN data model can be used to represent annotated regions in video, and there could be auxiliary data that assigns certain semantics to these annotations (say, identifies a “high risk” situation in a security video), that are intended to be consumed by some service that uses this semantic information to make some business workflow decision (say precipitate a security escalation). The RIN data model can use a dictionary entity called Auxiliary Data to store all the above types of data. In the context of the narrative, metadata that is common across the RIN segments, such as, for example, descriptions, authors, and version identifiers, are stored in the narrative's Auxiliary Data entity.

I.B. RIN Segment

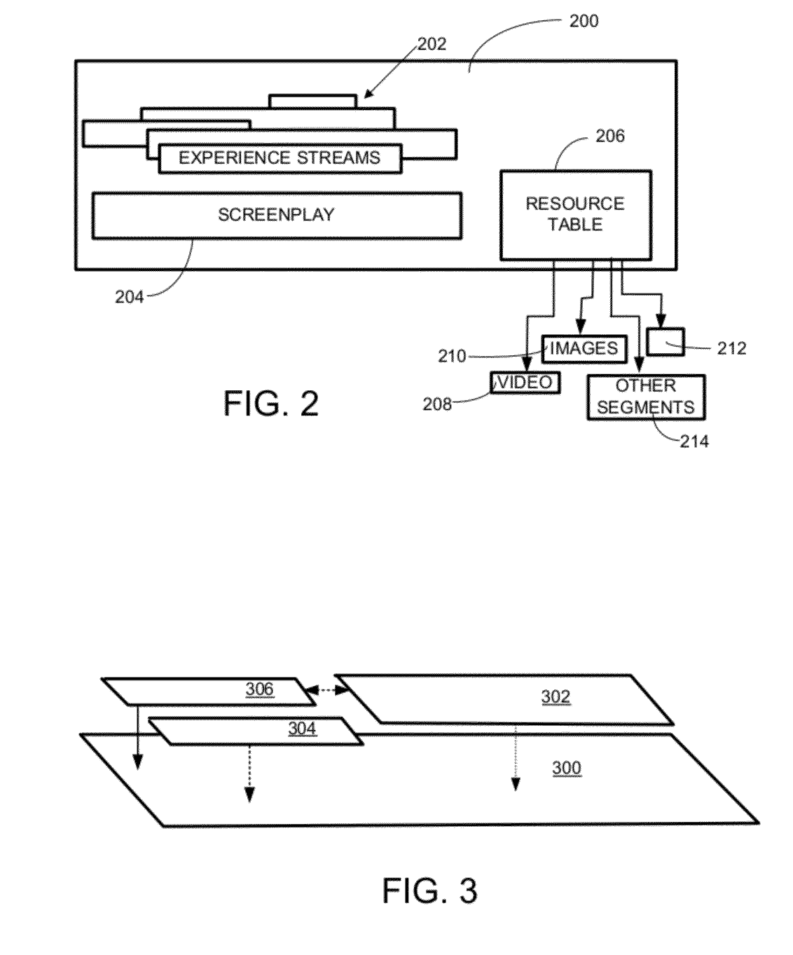

A RIN segment contains references to all the data necessary to orchestrate the appearance and positioning of individual experience streams for a linear portion of a RIN. FIG. 2 is a simplified diagram of a RIN segment including one or more experience streams, at least one screenplay, and a resource table. Referring to FIG. 2, the highest level components of the RIN segment 200 include one or more experience streams 202 (in the form of the streams themselves or references to where the streams can be obtained), at least one screenplay 204 and a resource table 206. The RIN segment can also include arbitrary auxiliary data as describe previously. In one implementation, a RIN segment takes the form of a 4-tuple (S, C, O, A). S is a list of references to experience streams; C (which is associated with the screenplay) is a list layout constraints that specify how the experience streams share display screen and audio real estate; O (which is also associated with the screenplay) is a set of orchestration directives (e.g., time coded events); and A (which is associated with the one or more resource tables) is a list of named, time coded anchors, used to enable external references. In some embodiments, any one or more of these items may reference external data to complete the specification of Segment behavior. For example, the layout constraints may reference external Theme-specific Cascading Style Sheets (CSS) for specific details about layout.

In general, the experience streams may be composed to play a linear segment of the narrative. Each experience stream includes data that enables a scripted traversal of a particular environment. Experience streams can play sequentially, or concurrently, or both, with regard to other experience streams. However, the focus at any point of time can be on a single experience stream (such as a Photosynth), with other concurrently playing streams having secondary roles (such as adding overlay video or a narrative track). Experience streams are described in more detail below.

In general, a screenplay is used to orchestrate the experience streams, dictating their lifetime, how they share screen and audio real estate, and how they transfer events among one another. Only one screenplay can be active at a time when rendering a particular RIN Segment. However, in one implementation, multiple screenplays can be included to represent variations of content. For example, a particular screenplay could provide a different language-specific or culture-specific interpretation of the RIN segment from the other included screenplays. Furthermore, multiple RIN Segments can be playing concurrently. This may happen, for example, when one RIN Segment contains an interactive experience that invokes, as part of this experience, additional RIN Segments as embedded content.

More particularly, a screenplay includes orchestration information that weaves multiple experience streams together into a coherent narrative. The screenplay data is used to control the overall sequence of events and coordinate progress across the experience streams. Thus, it is somewhat analogous to a movie script or an orchestrator conductor's score. The screenplay also includes layout constraints that, coupled with optional style-specific resources such as CSS files, dictate how the visual and audio elements from the experience streams share display screen space and audio real estate as a function of time. In one implementation, the screenplay also includes embedded text that matches a voiceover narrative, or otherwise textually describes the sequence of events that make up the segment. It is also noted that a screenplay from one RIN segment can reference an experience stream from another RIN segment.

However, the orchestration information associated with the screenplay can go beyond simple timing instructions such as specifying when a particular experience stream starts and ends. For example, this information can include instructions whereby only a portion of an experience stream is played rather than the whole stream, or that interactivity capabilities of the experience stream be disabled. Further, the screenplay orchestration information can include data that enables simple interactivity by binding user actions to an experience stream. For example, if a user “clicks” on prescribed portion of a display screen, the screenplay may include an instruction which would cause a jump to another RIN segment in another scene, or to shut down a currently running experience stream. Thus, the screenplay enables a variety of features, including non-linear jumps and user interactivity.

An experience stream generally presents a scene from a virtual “viewport” that the user sees or hears (or both) as he or she traverses the environment. For example, in one implementation a two-dimensional (2D) viewport is employed with a pre-defined aspect ratio, through which the stream is experienced, as well as, optionally, audio specific to that stream is heard. The term viewport is used loosely, as there may not be any viewing involved. For example, the environment may involve only audio, such as a voiced-over narrative, or a background score.

With regard to the layout constraints, the screenplay includes a list of these constraints which are applicable to the aforementioned viewports created by the experience streams involved in the narrative. In general, these layout constraints indicate the z-order and 2D layout preferences for the viewports, well as their relative sizes.

For example, suppose four different experience streams are running concurrently at a point in time in a narrative. Layout constraints for each experience stream dictate the size and positioning of each streams viewport. FIG. 3 illustrates a relative position and size of an exemplary group of four experience stream viewports. Referring to FIG. 3, an exemplary configuration of the viewports 300, 302, 304, 306 for each of the four experience streams is shown relative to each other. In addition, in implementations where audio is involved, the layout constraints specify the relative audio mix levels of the experience streams involving audio. These constraints enable the proper use of both screen real estate and audio real estate when the RIN is playing. Further, in one implementation, the relative size and position of an experience stream viewport can change as a function of time. In other words, the layout can be animated.

Thus, each experience associated with an experience stream(s) is a portal into a particular environment. The experience stream projects a view onto the presentation platform's screen and sound system along a timeline. A narrative is crafted by orchestrating multiple experience streams into a storyline. The RIN segment screenplay includes layout constraints that specify how multiple experience stream viewports share screen and audio real estate as a function of time.

In some embodiments, the layout constraints also specify the relative opacity of each experience stream's viewport. Enabling experience streams to present a viewport with transparent backgrounds give great artistic license to authors of RINs. In one implementation, the opacity of a viewport is achieved using a static transparency mask, designated transparent background colors, and relative opacity levels. It is noted that this opacity constrain feature can be used to support transition functions, such as fade-in/fade-out.

In some embodiments, the detailed layout information can be specified in external, theme-specific layout files appropriate for the lower level presentation environment, such as CSS files for HTML presentation, and XAML files for Silverlight® and WPF® presentation by Microsoft® Corporation. In this case, the information in the screen play is coupled with the style identification to determine the specific external resource files to be used to determine layout details.

With regard to audio layout constraints, in one implementation, these constraints are employed to share and merge audio associated with multiple experience streams. This is conceptually analogous to how display screen real estate is to be shared, and in fact, if one considers 3D sound output, many of the same issues of layout apply to audio as well. For example, in one version of this implementation a relative energy specification is employed, analogous to the previously-described opacity specification, to merge audio from multiple experience streams. Variations in this energy specification over time are permissible, and can be used to facilitate transitions, such as audio fade-in/fade-out.

As for the aforementioned resource tables, they are generally a repository for all, or at least most, of the resources referenced in the RIN segment. All external Uniform Resource Identifiers (URIs) referenced in experience streams are resource table entries. Resources that are shared across experience streams are also resource table entries. Referring again to FIG. 2, one exemplary implementation of the resource table includes reference metadata that enables references to external media (e.g., video 208, standard images 210, gigapixel images 212, and so on), or even other RIN segments 214, to be robustly resolved. In some implementations, the metadata also includes hints for intelligently scheduling content downloads; choosing among multiple options if bandwidth becomes a constraint; and pausing a narrative in a graceful manner if there are likely going to be delays due to ongoing content uploads.

I.C. RIN Experience Streams

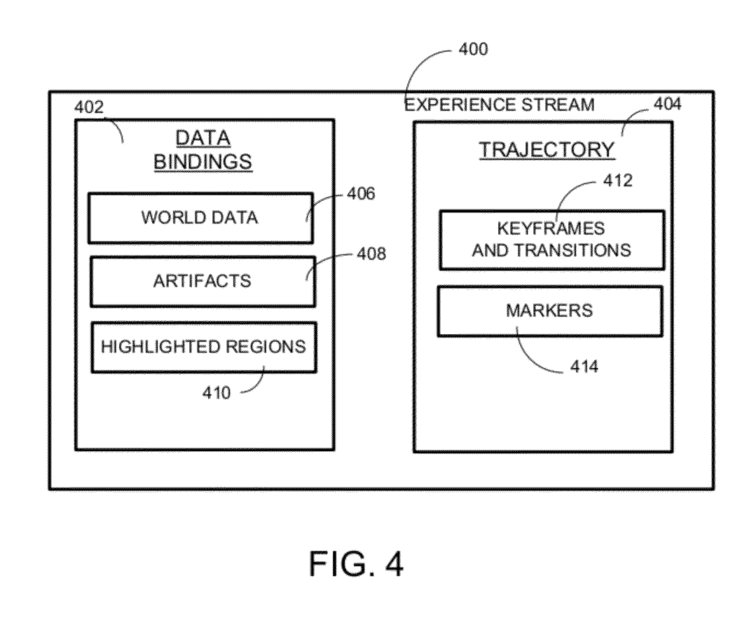

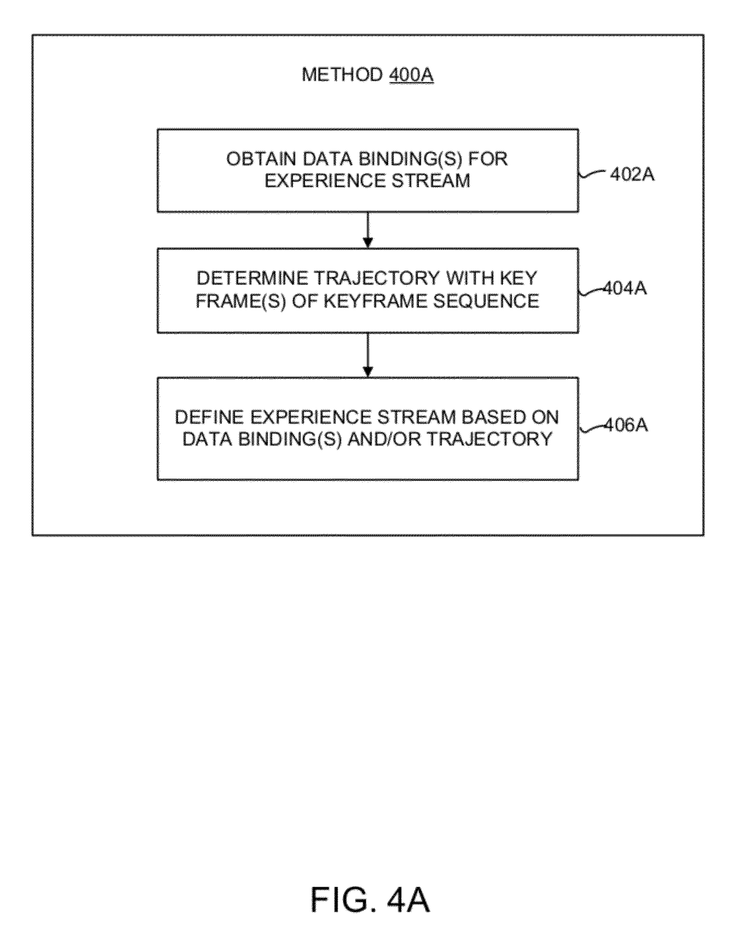

The term “experience stream” is generally used to refer to the data that defines a scripted path through a specific environment. In addition, experience streams support pause-and-explore and extensibility aspects of a RIN. FIG. 4 is a simplified diagram of an experience stream made up of data bindings and a trajectory. In the embodiment illustrated in FIG. 4, an experience stream 400 is made up of data bindings 402 and a trajectory 404. The data bindings include environment data 406, as well as artifacts 408 and highlighted regions 410. The trajectory includes keyframes and transitions 412 and markers 414. An experience stream can also include auxiliary data as describe previously.

For example, this auxiliary data can include provider information and world data binding information. Provider information is used in processes that render RINs, as well processes that enable authoring or processing of RINs, to bind to code that understands the specific experience stream (i.e., that understands the specific environment that constitutes the experiences, and that can interpret the data contained in the experience stream). The world data binding information defines the concrete instance of the environment over which the experience streams runs, as well as binding data to populated embedded artifacts (objects embedded within the environment that are populated from external data sources and which may exhibit their own interactive behaviors).

Formally, in one implementation, an experience stream is represented by a tuple (E, T, A), where E is environmental data, T is the trajectory (which includes a timed path, any instructions to animate the underlying data, and viewport-to-world mapping parameters as will be described shortly), and A refers to any artifacts and region highlights embedded in the environment (as will also be described shortly).

Data bindings refer to static or dynamically queried data that defines and populates the environment through which the experience stream runs. Data bindings include environment data (E), as well as added artifacts and region highlights (A). Together these items provide a very general way to populate and customize arbitrary environments, such as virtual earth, photosynth, multi-resolution images, and even “traditional media” such as images, audio, and video. However, these environments also include domains not traditionally considered as worlds, but which are still nevertheless very useful in conveying different kinds of information. For example, the environment can be a web browser; the World Wide Web, or a subset, such as the Wikipedia; interactive maps; 2D animated scalable vector graphics with text; or a text document; to name a few.

Consider a particular example of data bindings for an image experience stream in which the environment is an image—potentially a very large image such as a gigapixel image. An image experience stream enables a user to traverse an image, embedded with objects that help tell a story. In this case the environmental data defines the image. For example, the environment data could be obtained by accessing a URL of the image. Artifacts are objects logically embedded in the image, perhaps with additional metadata. Finally, highlights identify regions within the image and can change as the narrative progresses. These regions may or may not contain artifacts.

Artifacts and highlights are distinguished from the environmental data as they are specifically included to tell a particular story that makes up the narrative. Both artifacts and highlights may be animated, and their visibility may be controlled as the narrative RIN segment progresses. Artifacts and highlights are embedded in the environment (such as in the underlying image in the case of the foregoing example), and therefore will be correctly positioned and rendered as the user explores the environment. It is the responsibility of an experience stream renderer to correctly render these objects. It is also noted that the environment may be a 3D environment, in which case the artifacts can be 3D objects and the highlights can be 3D regions.

It is further noted that artifacts and region highlights can serve as a way to do content annotation in a very general, extensible way. For example, evolving regions in a video or photosynth can be annotated with arbitrary metadata. Similarly, portions of images, maps, and even audio could be marked up using artifacts and highlights (which can be a sound in the case of audio).

There are several possibilities for locating the data that is needed for rendering an experience stream. This data is used to define the world being explored, including any embedded artifacts. The data could be located in several places. For example, the data can be located within the aforementioned Auxiliary Data of the experience stream itself. The data could also be one or more items in the resource table associated with the RIN segment. In this case, the experience stream would contain resource references to items in the table. The data could also exist as external files referenced by URLs, or the results of a dynamic query to an external service (which may be a front for a database). It is noted that it is not intended that the data be found in just one of these locations. Rather the data can be located in any combination of the foregoing locations, as well as other locations as desired.

The aforementioned trajectory is defined by a set of keyframes. Each keyframe captures the state of the experience at a particular point of time. These times may be in specific units (say seconds), relative units (run from 0.0 to 1.0, which represent start and finish, respectively), or can be gated by external events (say some other experience stream completing). Keyframes in RINs capture the “information state” of an experience (as opposed to keyframes in, for instance, animations, which capture a lower-level visual layout state). An example of an “information state” for a map experience stream would be the world coordinates (e.g., latitude, longitude, elevation) of a region under consideration, as well as additional style (e.g., aerial/road/streetside/etc.) and camera parameters (e.g., angles, tilt, etc). Another example of an information state, this time for a relationship graph experience stream, is the graph node under consideration, the properties used to generate the neighboring nodes, and any graph-specific style parameters.

Each keyframe also represents a particular environment-to-viewport mapping at a particular point in time. In the foregoing image example, the mappings are straightforward transformations of rectangular regions in the image to the viewport (for panoramas, the mapping may involve angular regions, depending on the projection). For other kinds of environments, keyframes can take on widely different characteristics.

The keyframes are bundled into keyframe sequences that make up the aforementioned trajectory through the environment. Trajectories are further defined by transitions, which define how inter-keyframe interpolations are done. Transitions can be broadly classified into smooth (continuous) and cut-scene (discontinuous) categories, and the interpolation/transition mechanism for each keyframe sequence can vary from one sequence to the next.

A keyframe sequence can be thought of as a timeline, which is where another aspect of a trajectory comes into play—namely markers. Markers are embedded in a trajectory and mark a particular point in the logical sequence of a narrative. They can also have arbitrary metadata associated with them. Markers are used for various purposes, such as indexing content, semantic annotation, as well as generalized synchronization and triggering. For example, context indexing is achieved by searching over embedded and indexed sequence markers. Further, semantic annotation is achieved by associating additional semantics with particular regions of content (such as a particular region of video is a ball in play; or a region of a map is the location of some facility).

A trajectory can also include markers that act as logical anchors that refer to external references. These anchors enable named external references to be brought into the narrative at pre-determined points in the trajectory. Still further a marker can be used to trigger a decision point where user input is solicited and the narrative (or even a different narrative) proceeds based on this input. For example, consider a RIN that provides a medical overview of the human body. At a point in the trajectory of an experience stream running in the narrative that is associated with a marker, the RIN is made to automatically pause and solicit whether the user would like to explore a body part (e.g., the kidneys) in more detail. The user indicates he or she would like more in-depth information about the kidneys, and a RIN concerning human kidneys is loaded and played.

A trajectory through a photosynth is easy to envision as a tour through the depicted environment. It is less intuitive to envision a trajectory through other environments such as a video or an audio only environment. As for a video, a trajectory through the world of a video may seem redundant, but consider that this can include a “Ken Burns” style pan-zoom dive into subsections of video, perhaps slowing down or even reversing time to establish some point. Similarly, one can conceive of a trajectory through an image, especially a very large image, as panning and zooming into portions of an image, possibly accompanied by audio and text sources registered to portions of the image. A trajectory through a pure audio stream may seem contrived at first glance, but it is not always so. For example, a less contrived scenario involving pure audio is an experience stream that traverses through a 3D audio field, generating multi-channel audio as output. Pragmatically, representing pure audio as an experience stream enables manipulation of things like audio narratives and background scores using the same primitive (i.e., the experience stream) as used for other media environments.

It is important to note that a trajectory can be much more than a simple traversal of an existing (pre-defined) environment. Rather, the trajectory can include information that controls the evolution of the environment itself that is specific to the purpose of the RIN. For example, the animation (and visibility) of artifacts is included in the trajectory. The most general view of a trajectory is that it represents the evolution of a user experience—both of the underlying model and of the users view into that model.

A distinction that may be made is between the term experience and experience stream. An experience can be thought of as the interactive environment associated with the data binding(s) and presentation of that environment to a user. An experience stream can be thought of as the data that defines a scripted path through the environment, and thus the data that produces the scripted behavior of the scripted path that is perceived by the user.

To facilitate the reader's understanding, FIG. 4A illustrates a flowchart of a technique or method 400A for creating an experience stream, in accordance with at least one embodiment. At block 402A one or more data bindings can be obtained for an experience stream that defines a scripted path through an environment. The data binding(s) can be associated with an experience that may be presented to a user. As explained herein, the data bindings may comprise queried data that defines and populates the specific environment. Individual data bindings can include, without limitation, world data 406, artifacts 408, and highlighted regions 410 for instance.

At block 404A a trajectory can be determined that includes one or more individual key frames of a keyframe sequence. The keyframe sequence can define a timeline and at least one transition. At block 406A, the experience stream can be defined based on the data binding(s) obtained at block 402A and/or the trajectory determined at block 404A.

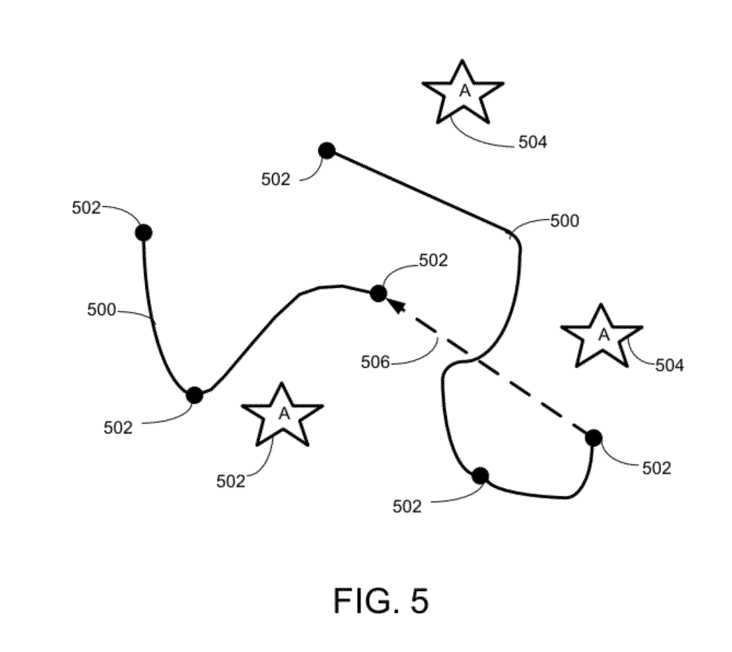

In view of the foregoing, an experience stream trajectory can be illustrated as shown in FIG. 5. FIG. 5 is a simplified diagram of an experience stream trajectory along with markers, artifacts and highlighted regions. The bolded graphics illustrate a trajectory 500 along with its markers 502 and the stars indicated artifacts or highlighted regions 504. The dashed arrow 506 represents a “hyper jump” or “cut scene”—an abrupt transition, illustrating that an experience stream is not necessarily restricted to a continuous path through an environment.

### II. Rich Interactive Narrative System Overview

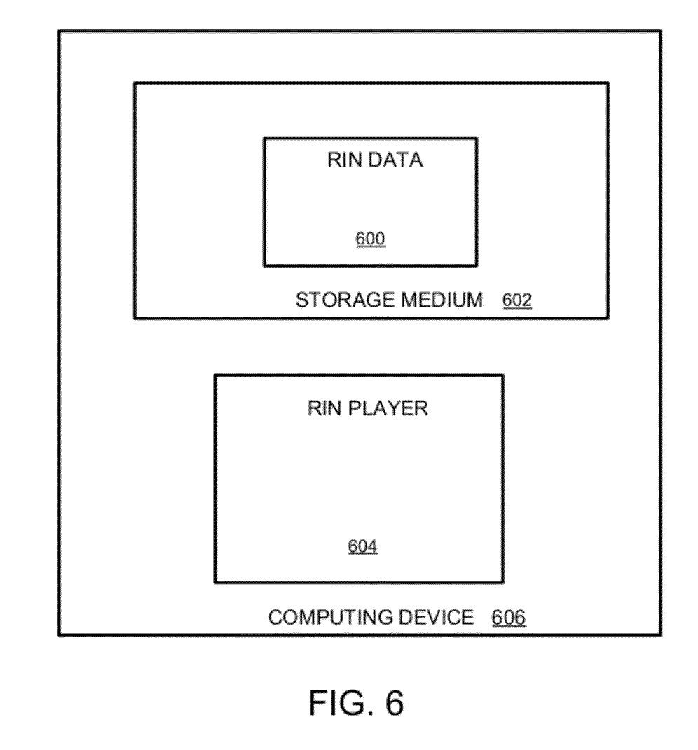

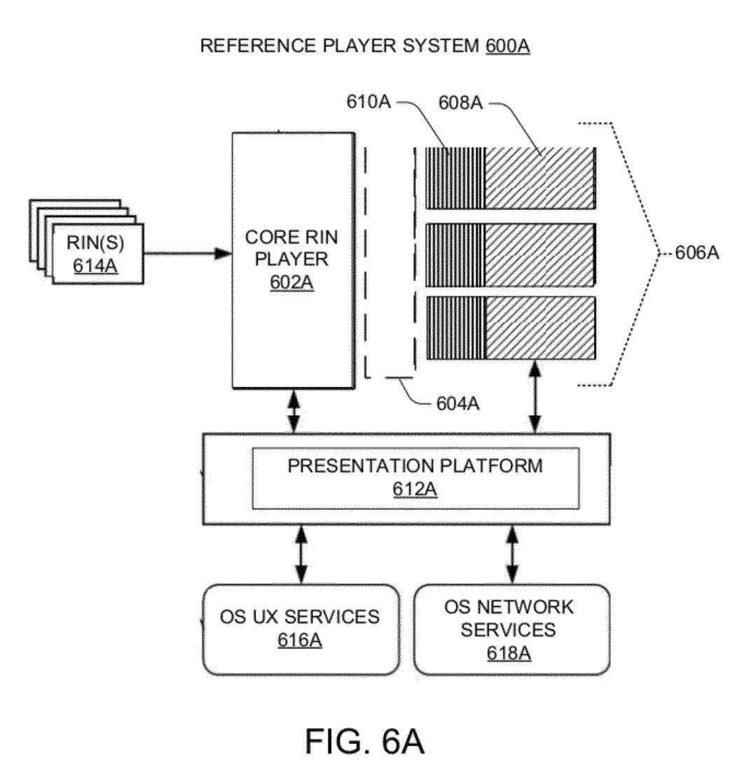

Given the foregoing RIN data model, the following exemplary system of one embodiment for processing RIN data to provide a narrated traversal of arbitrary media types and user-explorable content of the media can be realized. FIG. 6 is a block diagram of an embodiment of a system for processing RIN data to provide a narrated traversal of arbitrary media types and user-explorable content of the media. In this exemplary RIN system, the RIN data 600 is stored on a computer-readable storage medium 602 (as will be described in more detail later in the exemplary operating environments section) which is accessible during play-time by a RIN player 604 running on a user's computing device 606 (such as one of the computing devices described in the exemplary operating environments section). The RIN data 600 is input to the user's computing device 606 and stored on the local or networked computer-readable storage medium 602.

As described previously, this RIN data 600 includes a narrative having a prescribed sequence of scenes, where each scene is made up of one or more RIN segments. Each of the RIN segments includes one or more experience streams (or references thereto), and at least one screenplay. Each experience stream includes data that enables traversing a particular environment created by one of the aforementioned arbitrary media types whenever the RIN segment is played. In addition, each screenplay includes data to orchestrate when each experience stream starts and stops during the playing of the RIN and to specify how experience streams share display screen space or audio playback configurations.

As for the RIN player 604, this player accesses and processes the RIN data 600 to play a RIN to the user via an audio playback device, or video display device, or both, associated with the user's computing device 606. The RIN player 604 can dynamically load experience stream providers as required to render experience streams referenced in the RIN segments. The player can interact with the experience stream providers through an application programming interface (API). The player and experience stream providers may utilize presentation platform services available on the computing device 606, which in turn can be implemented using native platform-specific APIs. The player and the experience providers can also handle user input, to enable the user to pause and interact with the experience streams that make up the RIN.

It should be noted that a further discussion of the operation and details of a RIN player, such as the RIN player 604, are provided in the description herein in the U.S. patent application Ser. No. 13/008,324, filed Jan. 18, 2011, and which this application is a continuation-in-part of. Nevertheless, to facilitate the reader's understanding, FIG. 6A illustrates an example block diagram of a reference player system 600A that includes a core RIN player 602A and that may be configured to perform playback of RINs and/or other RIN-related content (e.g., RIN books).

In at least one alternative or additional embodiment, all or part of the reference player system 600A may be implemented with all or part of one or more of the RIN players, player platforms, and/or presentation platforms described herein (including in the U.S. patent application Ser. No. 13/008,324). In this example, the core RIN player 602A can contain an internal orchestrator configured to interpret RIN screenplays. The core RIN player 602A can also be configured to dynamically load one or more experience stream providers and send experience stream data to the experience stream provider(s).

The reference player system 600A can also include an experience stream provider interface 604A that can be configured to communicably couple the core RIN player 602A to one or more third party experience stream providers 606A. The third party experience stream provider(s) 606A may include pre-existing third party visualization libraries 608A that can be coupled to provider code 610A.

The provider code may be configured to implement the experience stream provider interface 604A on top of APIs exposed by the pre-existing third party visualization libraries 608A. Alternatively or additionally, the third party experience stream providers 606A may be written from scratch directly to the APIs that may be exposed by a low-level presentation platform 612A. In either or both cases, the provider code 610A can be configured to be responsible for executing experience stream provider functions, such as scripting a path through the experience based on keyframes and other data present in an experience stream.

The core RIN player 602A can be configured to playback any of one or more individual RINs 614A. In at least one embodiment, this can be accomplished by using the third party experience stream providers 606A. The playback of the RIN(a) 614A can be displayed to a user via the low-level presentation platform 612A, such as by a browser or other suitable application configured to provide the APIs to a computing device.

In at least one embodiment, the low-level presentation platform 612A can be configured to display the playback of the RIN(s) 614A on a suitable type of display device such as, for example, a computer monitor, camera device, television, projection device, virtual reality display, computing device, or the like. Furthermore, the low-level presentation platform 612A can be configured to utilize the services of one or more client devices' native operating system (OS) user experience (UX) services 616A. Alternatively or additionally, the low-level presentation platform 612A can also be configured to leverage operating system (OS) network services 618A to provide access to resources via one or more networks such as an intranet and/or the Internet for instance.

II.A. RIN Implementation Environment

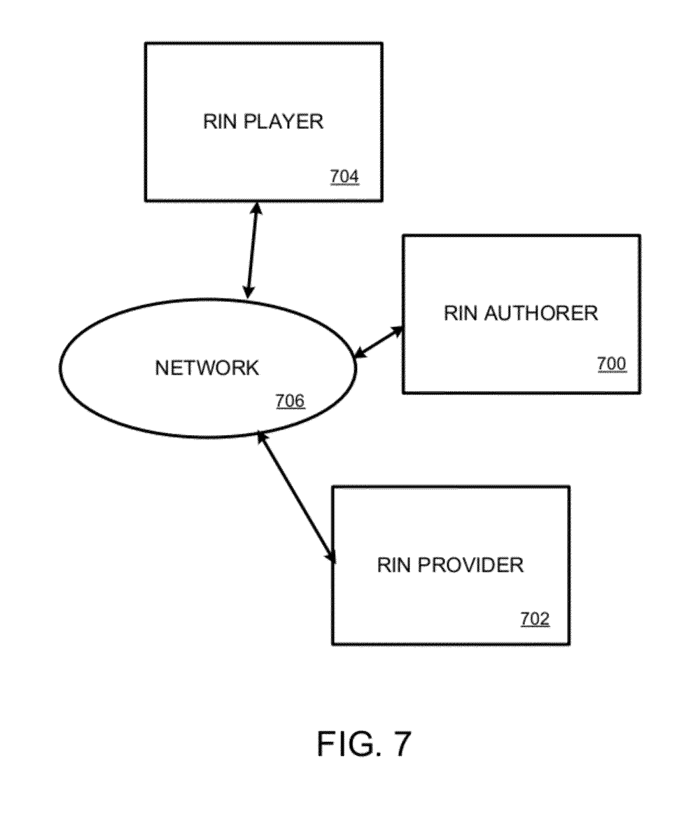

A generalized and exemplary environment representing one way of implementing the creation, deposit, retention, accessing and playing of RIN is illustrated in FIG. 7. FIG. 7 is a block diagram of a generalized and exemplary environment representing one way of implementing the creation, deposit, retention, accessing and playing of RIN. As noted above, an instance of a RIN constructed in accordance with the previously-described data model is captured in a RIN document or file. This RIN document is considered logically as an integral unit, even though it can be represented in units that are downloaded piecemeal, or even assembled on the fly.

A RIN document can be generated in any number of ways. It could be created manually using an authoring tool. It could be created automatically by a program or service. Or it could be some combination of the above.

RIN documents, once authored are deposited with one or more RIN providers as collectively represented by the RIN provider block 702 in FIG. 7. The purpose of a RIN provider is to retain and provide RINs, on demand, to one or more instances of a RIN player. The RIN player or players are represented by the RIN player block 704 in FIG. 7.

In the example shown in FIG. 7, the RIN authors, RIN providers and RIN player are in communication over a computer network 706, such as the Internet or a proprietary intranet. However, this need not be the case. For example, in other implementations any one or more of the RIN authors, RIN providers and RIN players can reside locally such that communications between them is direct, rather than through a computer network.

### III. Rich Interactive Narrative Authoring System Overview

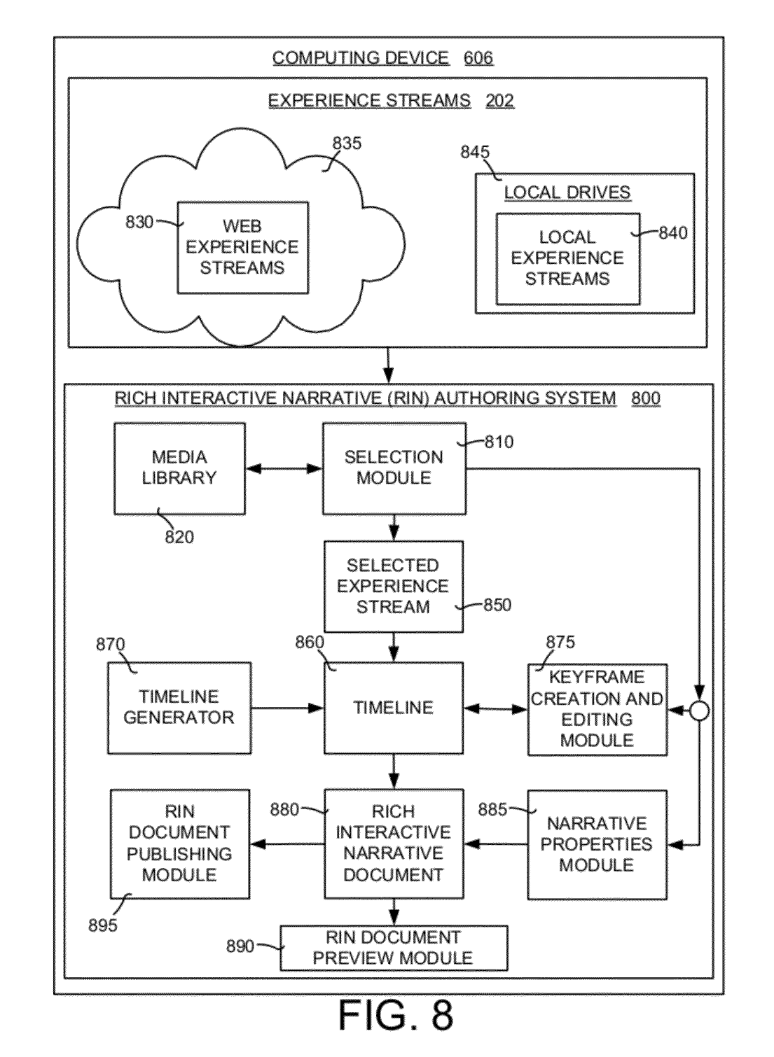

FIG. 8 is a block diagram illustrating a general overview of embodiments of the RIN authoring system 800 and method implemented in the RIN implementation environment. In at least one embodiment, the RIN authoring system 800 allows for multiple RIN Segments to be authored and linked in a linear and/or non-linear manner to provide individual RINs in accordance with an author's (i.e., RIN creator's) wishes.

Note that FIG. 8 is merely one way in which embodiments of the RIN authoring system 800 and method may be implemented, and is shown merely for illustrative purposes. It should be noted that there are several other ways in which embodiments of the RIN authoring system 800 and method may be implemented, which will be apparent to those having ordinary skill in the art.

In particular, it should be noted that a RIN document does not have to be authored by using embodiments of the RIN authoring system 800 and method. In fact, the RIN document can be authored by having the author construct the implementation code (such as an XML file) for the document. In this case, the author would have no visual or graphical feedback when authoring the RIN document. Embodiments of the system 800 and method are designed to provide an author with this visual and graphical feedback and to lower the barrier to creating the RIN document such that authors having no programming or coding experience can still author the RIN document.

In general, embodiments of the RIN authoring system 800 and method allow an author to create a RIN document in a graphical manner without the need for the user to perform any programming or to write code. In addition, embodiments of the RIN authoring system 800 and method facilitate the importing of traditional media such as images, video, and text, as well as richer, more complex forms of media, such as deep zoom images, PhotoSynths, relationship graphs, and Pivot documents. This is extensible to allow importing of many more forms of media using the extensibility framework of embodiments of the authoring system 800.

Each piece of media (traditional or complex) can be placed on a timeline, in one of several layers. Furthermore a logical “path” or trajectory can be defined (by creating or defining individual “keyframes” and positioning them on the timeline) that enables a scripted walkthrough of the particular piece of media. The timing of the progression through a path through each form of media can be adjusted so that when played the various pieces come together to form a compelling whole in the form of a RIN segment of a RIN document. Creation of new keyframes, editing of existing keyframes and deletion of keyframes also is supported by embodiments of the RIN authoring system 800 and method.

Embodiments of the RIN authoring system 800 and method also support editing of an entire or a portion of existing RIN documents. In some embodiments of the system 800 and method, support for adding new experiences is facilitated without the need for recompilation. This is achieved by importing experience stream modules using dynamic loading facilities (such as Silverlight® Managed Extensibility Framework by Microsoft® Corporation). A new component can be introduced by having it expose certain standard interfaces that embodiments of the RIN authoring system 800 and method will use to create new keyframes, bind the experience to data, and so forth. Moreover, embodiments of the system 800 and method support the preview of the RIN document, the adjustment of timings on the timeline, and the adjustment of adjusting of audio levels.

As shown in FIG. 8, embodiments of the RIN authoring system 800 and method are disposed on the computing device 606 (that was originally shown in FIG. 6). Embodiments of the system 800 and method include a selection module 810, through which a user or author (not shown) can manually make selections of various entities while authoring and creating a RIN document. One selection made by the author is the selection of experience streams 202 from the media library 820. In other words, through the selection module 810 (usually in the form of a user interface), the author can select various types of one or more interactive experiences associated with the experience streams 202, including video, images, interactive maps, PhotoSynths, and virtually any type of media or multimedia that now exists or will exist in the future.

The media library is populated with the experience streams 202, and thus one or more experiences associated with these experience streams, in a variety of different ways. In FIG. 8, at least two sources of the experience streams 202, and thus of the one or more experiences, are shown. A Web experience stream of Web experience streams 830 is an experience stream that can be obtained from the Web 835. In this regard, the Web experience streams 830 can be associated with one or more experiences that can thus be obtained from the Web. The author can either choose to interact directly with the website containing the Web experience streams 830 or can have the media library 820 obtain it from the website. In addition, local experience streams 840 can reside on local drives 845 of the computing device 606. The local experience streams can be associated with one or more experiences that can reside on, and thus be obtained from, the local drives 845. In addition, the media library may obtain experience streams, and thus one or more experiences, from the resource tables 206 and or any other virtual or physical device in communication with the computing device 606.

In some embodiments of the RIN authoring system 800 and method, the author drags and drops a selected experience stream 850, and thus a selected experience, from the media library 820 to a timeline 860. The timeline 860 is generated, either automatically by embodiments of the system 800 or manually by the author, using a timeline generator 870. The timeline generator 870 also is used to specify a number of layers (or tracks) on the timeline 860. For example, in some embodiments the timeline 860 contains multiple tracks including a media track (for dragging and dropping experience streams containing media and multimedia content), an audio overlay track (for dragging and dropping experience streams containing audio that will play over the media and multimedia experience streams at a specified time), and a background audio track (for dragging and dropping experience streams containing audio that will play in the background). These layers (or tracks) can be added by third-party developers without recompiling by extensibility mechanisms using dynamic loaded modules (such as Silverlight®'s Managed Extensibility Framework).

Embodiments of the system 800 and method also include a keyframe creation and editing module (also known as Path Editor) 875. The keyframe creation and editing module 875 allows an author (through the selection module 810) to define a keyframe in an experience 202 and then define the trajectory or path of the keyframe through time. The author can select additional experience streams to add to the timeline until the author is satisfied with the creation. The result is a RIN document 880.

Accordingly, multiple RIN segments may be created in this way, and linked together in various ways. For example, a visual table of contents experience could present visual tiles, each of which link to a particular portion of a RIN Segment. Alternatively, embedded artifacts within an experience could be bound to an on-click behavior that launches the referenced RIN Segment. The aggregate of media, experiences and RIN Segments can form a RIN document.

A narrative properties module 885 can be used by the author through the selection module 810 to attach narrative properties (such as title, description, author, and so forth) to the RIN document 880. In addition, the narrative properties module 885 can automatically generate a visual table of contents, as explained in detail below. The author then can preview the RIN document 880 using a RIN document preview module 890. Based on the preview, the author may choose to further refine the RIN document 880 using embodiments of the system 800 and method described above. When the author is satisfied with the RIN document 880, it can be published using a RIN document publishing module 895.

### IV. Rich Interactive Narrative Authoring Operation

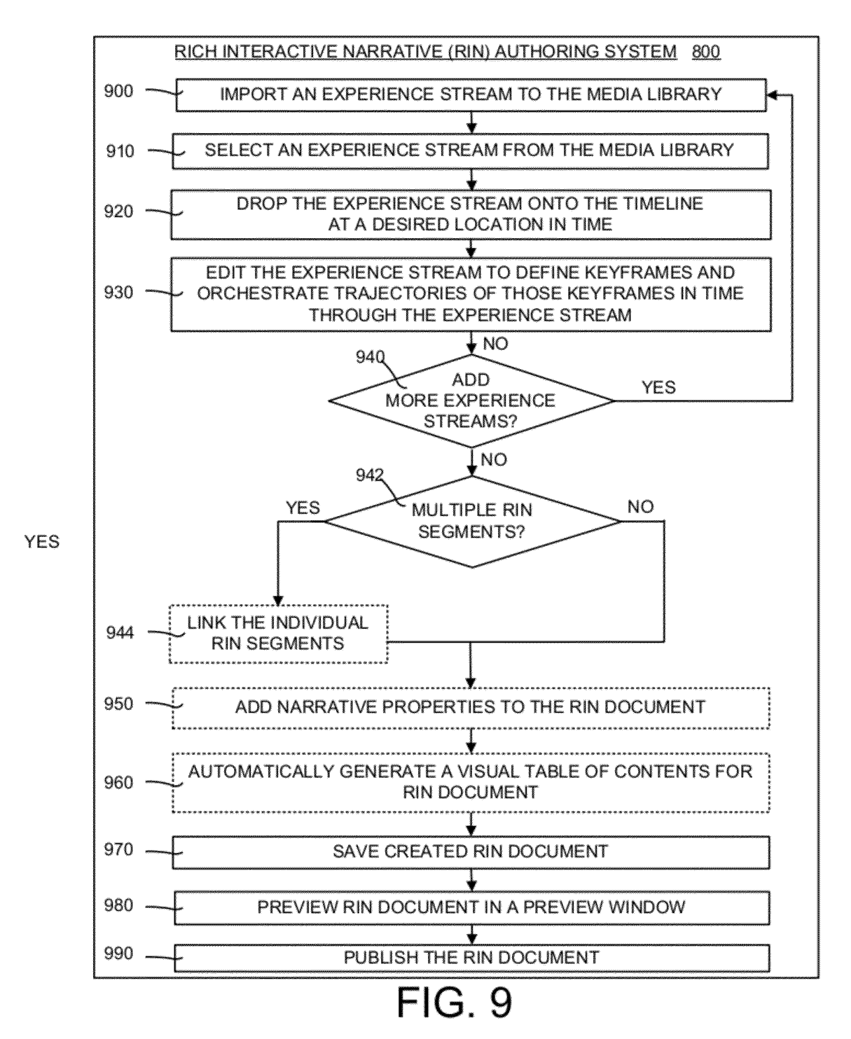

FIG. 9 is a flow diagram illustrating the general operation of embodiments of the RIN authoring system 800 and method shown in FIG. 8, focusing on the authoring of individual segments. This process can be repeated for each segment that makes up the RIN document. In general, embodiments of the RIN authoring system 800 and method facilitate the authoring of a RIN document in a graphical manner. In some embodiments, the RIN authoring system 800 and method are implemented in a graphical user interface (GUI) (not shown).

This GUI has three main parts, including a graphical representation of the media library 820, a preview window that plays and previews the RIN document for the author, and a timeline 860 where the author can place the experience streams. In addition, the GUI can include a toolbar that contains various buttons or tabs for navigating around the GUI including a “publish” button, a “new narrative” button, a “save” button, a “publish” button, and a “preview” button.

Referring to FIG. 9, the method begins by importing an experience stream to the media library 820 (box 900). In some embodiments the author clicks on the “new narrative” button to begin the process of importing experience streams to the media library. The content that can be imported includes maps, video, audio, graphs, and virtually any existing or future media or multimedia content. It should be noted that the media library 820 is quite extensible and is not hard coded. As noted above, the content or experience streams can be imported from the Web or from local drives.

The author then selects an experience stream from the media library 820 (box 910). In alternate embodiments, the author can interact directly with a website to obtain the experience stream, thereby bypassing the media library. The author then drags and drops the selected experience stream onto the timeline 860 at a desired location in time (box 920), thereby creating an instance of an experience stream. In some embodiments, the timeline 860 contains three tracks. These tracks include an interactive media (or foreground) track for the experience streams, an audio overlay track for placing audio that will play over the foreground experience audio, and a background audio track for placing audio that will play in the background. It should be noted that the number of tracks that the timeline 860 contains can be virtually any integer number.

Embodiments of the RIN authoring method then allow the author to edit the experience stream that has been dropped onto the timeline 860 (box 920). In particular, the experience stream can be edited to define one or more keyframes in the experience stream and to orchestrate trajectories or paths in time between the keyframes through the experience stream. This editing process is described in more detail below.

A determination can then be made as to whether the author would like to add more experience streams to the timeline 860 (box 940). If so, then the author can repeat the process of selecting an experience stream, dragging and dropping the selected experience stream onto the timeline 860, and editing the experience stream as desired. If not, and the user is satisfied, then a determination can be made as to whether there are multiple RIN segments associated with the experience stream(s) resulting from the importing, selecting, dropping, and/or editing as designated by boxes 900 through 930 (box 942). If it is determined that there are multiple RIN segments (“yes”), then the individual RIN segments can be linked (box 944). The author then has the option of adding narrative properties to the RIN document (box 950).

With respect to linking the individual RIN segments at block 944, individual RIN segments can be referenced from within a particular RIN segment, from within an experience of the particular RIN segment, and/or from within an embedded artifact of the particular RIN segment such that a desired non-linear interactive explorative navigation experience can be provided. For example, a visual table of contents can be provided with each table of content listing or item being linked to a particular offset and duration associated with one or more of the multiple RIN segments.

If, however, it is determined that there are not multiple RIN segments (“no”), then there are not individual RIN segments to be linked and the author has the option of adding narrative properties to the RIN document (box 950). These narrative properties might include a title, description, author, aspect ratio, and so forth. Note that the dotted line surrounding boxes 944, 950, and 960 are used to indicate that these are optional process actions.

Next, the author can have embodiments of the system 800 automatically create a visual table of contents of the RIN document (box 960). In some embodiments, the author can press a button on the GUI and automatically have the visual table of contents created. The visual table of contents is created by embodiments of the system 800 using metadata (such as the metadata stored in the resource table 206). In addition, keyframes, timing, and other data from the RIN document are used to create the visual table of contents. The visual table of contents, which may itself be a RIN experience, then is added to the RIN document.

The author then can save the created RIN document (box 970). In some embodiments, the author clicks on the “save” button in the GUI to save the created RIN document. The author then can preview the RIN document in a preview window of the GUI (box 980). In some embodiments, the author can click on the “preview” button to preview the newly-authored RIN document. If the author is satisfied, then the author can publish the RIN document at a website or other repository (box 990). In some embodiments, this is achieved by the author clicking the “publish” button in the GUI.

### IV.A. Kevframe Creation and Editing Process

As noted above, a keyframe in the context of an experience stream such as a video or an image determines to what part of the image the user wants to pan and zoom. In some embodiments, the author can click on the experience stream on the timeline and a Path Editor GUI will appear for the author to use. This allows the author to select keyframes and sections of an image as keyframes. It should be noted that often an experience stream will have multiple keyframes. The same powerful GUI is used for various experience streams that support path editing.

Keyframes represent a point in time. In other words, the keyframe is a snapshot of what needs to be presented to a viewer at a point in space of the experience. In the most general sense, the keyframe is the state of the user experience or user interface at any point in space at a given time that the author wants to capture. The keyframe represents an experience state and defines, at any point in space at a given time, what/how the author wants a particular experience stream to appear. Once the keyframes are captured, the author indicates where on the timeline 860 that the keyframes should appear. The author also needs to specify the sequence, and the rough timing of when they appear and disappear (in other words, a trajectory or a path).

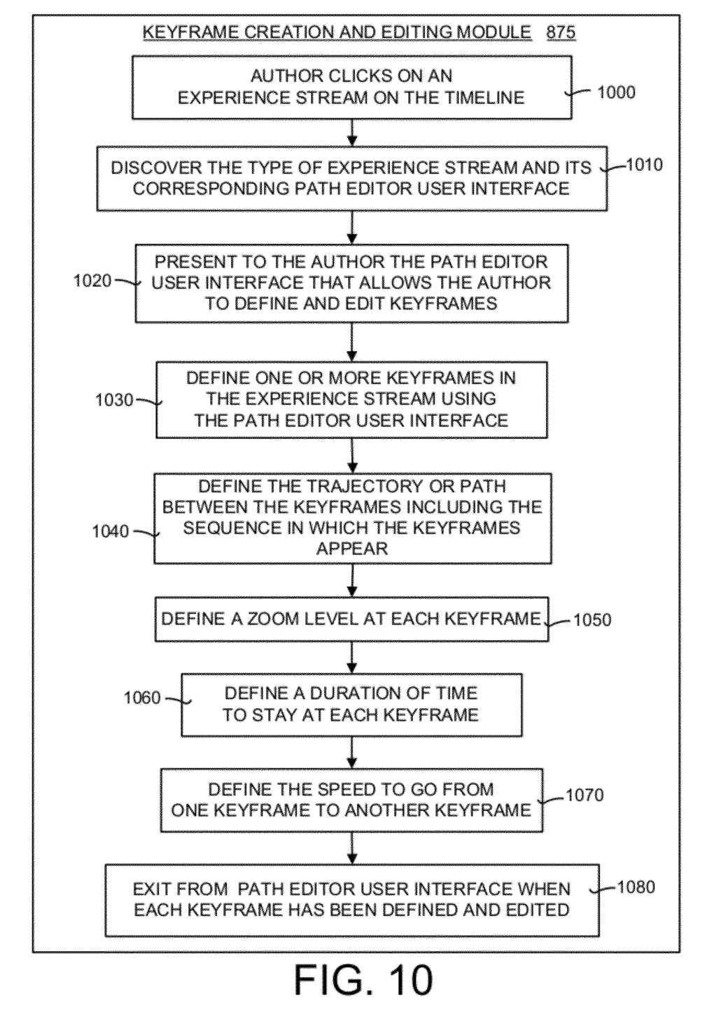

FIG. 10 is a flow diagram illustrating the operational details of embodiments of the keyframe creation and editing module 875 shown in FIG. 8. The method begins by having the author click on an experience stream that has been dropped onto the timeline 860 (box 1000). Embodiments of the module 875 then discover the type of experience stream that the author has clicked on and associate it with Path Editor user interface (box 1010).

Embodiments of the module 875 then present to the author the Path Editor user interface (box 1020). This Path Editor user interface allows the author to define and edit keyframes. As used in this context, editing keyframes also means to define various properties associated with the keyframe as well as to define the trajectory or path between a sequence of keyframes.

More specifically, the author uses the Path Editor user interface to define one or more keyframes in the experience stream (box 1030). Moreover, the author defines a trajectory or path between two or more keyframes (box 1040). This includes the sequence in which the keyframes appear. In other words, the author can place the defined keyframes on the timeline 860 in the order in which the author would like them to appear.

The author also uses the Path Editor user interface to define various features and attributes of a keyframe. In particular, the author may define a zoom level at each keyframe (box 1050). The author also defines a duration of time to stay at each keyframe during the playback of the RIN document (box 1060). In addition, the author defines a speed at which to go from one keyframe to another keyframe (box 1070). These attributes and features are part of defining and editing the keyframe. Once each of the keyframes has been defined and edited, then the author can exit from the Path Editor user interface (box 1080).

### IV.B. Overlays and Popups

In some embodiments of the RIN authoring system 800 and method, authors are able to place overlays over background content to show related information. These overlays can contain basic media types such as image, video or text with hyperlinks. Moreover, these overlays also can contain complex interactive media, such as Photosynth or other RINs. Clicking on these may produce behaviors such as opening a full screen panel containing detailed information on the clicked content.

In some embodiments of the RIN authoring system 800 and method, these popup layers are implemented as experience streams with a path and keyframes. Inclusion of these overlays and popups are easily made using embodiments of the RIN authoring system 800 and method by providing a separate overlay “track” similar to tracks provided for audio and experience stream.

### IV.C. Narratives Inside Other Narratives

In some embodiments of the RIN authoring system 800 and method, a narrative can contain other narratives. In these embodiments, users can add other narratives to an existing narrative by importing it directly into media library and adding it to experience stream layers, as with any other experience stream. This is useful to build a narrative to talk about other narratives.

The original narrative is called a “parent narrative,” while those narratives playing inside the parent narrative are called “child narratives.” It should be noted that, at the author's discretion, only a section of a child narrative can be played inside a parent narrative. Thus, an author can build a narrative about highlights on other narratives. Since narrative itself is imported, the imported narrative has all the interactive capabilities as the original narrative.

### IV.D. Transitions Between Experience Streams

In some embodiments of the RIN authoring system 800 and method, various inbuilt transitions are provided between experience streams. These transitions can be of various types such as fade in, fade out, cross fade, spiral in, spiral out, and so forth. Using extensibility, developers are able to easily add new transitions by implementing an interface and dropping the implementation assembly in the authoring tool folder.

### IV.E. Use of RIN Player for Preview

Building a system to correctly preview the experience streams can be difficult. One solution is to use an embodiment of the RIN player 604 as a previewer. When this is done, a number of hooks first need to be built between embodiments of the RIN authoring system 800 and the RIN player 604 for updating changes in real time and seeing changes in real time in preview area.

### IV.F. Video Projection

Video projection can be used in some embodiments of the RIN authoring system 800 and method. Video projection enables an author to create a pre-rendered video based on the interpolation generated using the Path Editor. This allows a faster response time for the narration where core experience streams (like Photosynth and Deep Zoom) might take an extended time to load during narration. When the user gets in to the interaction mode in embodiments of the RIN player 604, the actual exploratory experience is shown to the user during playing the video projection is shown. In some embodiments video projection can be invoked by selecting the experience on the time line and selecting a “Video Projection” option on the context menu.

### V. Exemplary Operating Environment

Embodiments of the RIN authoring system 800 and method described herein are operational within numerous types of general purpose or special purpose computing system environments or configurations.

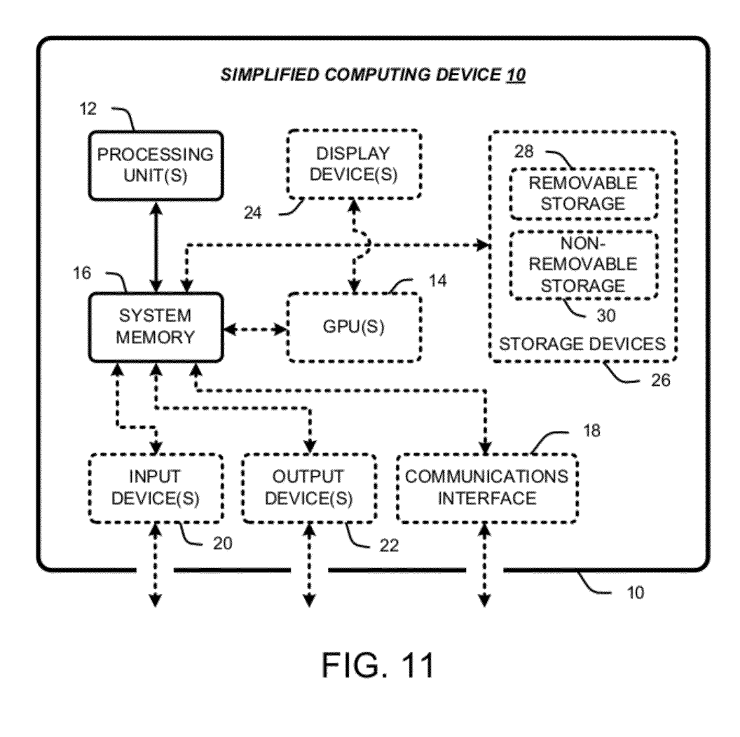

FIG. 11 illustrates a simplified example of a general-purpose computer system on which various embodiments and elements of the RIN authoring system 800 and method, as described herein, may be implemented. It should be noted that any boxes that are represented by broken or dashed lines in FIG. 11 represent alternate embodiments of the simplified computing device, and that any or all of these alternate embodiments, as described below, may be used in combination with other alternate embodiments that are described throughout this document.

For example, FIG. 11 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement embodiments of the RIN authoring system 800 and method described herein, the device should have a sufficient computational capability and system memory to enable basic computational operations. In particular, as illustrated by FIG. 11, the computational capability is generally illustrated by one or more processing unit(s) 12, and may also include one or more CPUs 14, either or both in communication with system memory 16. Note that that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 11 may also include other components, such as, for example, a communications interface 18. The simplified computing device of FIG. 11 may also include one or more conventional computer input devices 20 (e.g., pointing devices, keyboards, audio input devices, video input devices, haptic input devices, devices for receiving wired or wireless data transmissions, etc.). The simplified computing device of FIG. 11 may also include other optional components, such as, for example, one or more conventional computer output devices 22 (e.g., display device(s) 24, audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 11 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices. Computer storage media does not include transitory instances of computer-readable instructions and as such can be characterized as non-transitory.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media. But not within the scope of computer storage media.

Further, software, programs, and/or computer program products embodying some or all of the embodiments described herein, including of the RIN authoring system 800 and method described herein, or portions thereof, may be stored, received, transmitted, or read from any desired combination of computer or machine readable media or storage devices and communication media in the form of computer executable instructions or other data structures.

Finally, embodiments described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### VI. Additional Embodiments

It is noted that any or all of the aforementioned embodiments throughout the description may be used in any combination desired to form additional hybrid embodiments. Specifically, embodiments of the RIN authoring system 800 and method may be used to author all or just a portion of a RIN document. The author has the ability to combine automatic and manually authored portions of the RIN document.

For example, an initial version of the RIN document could be automatically generated, and this could be followed by manual addition or editing of the RIN document using embodiments of the RIN authoring system 800 and method. This in turn could be followed by additional automatically generated pieces by embodiments of the RIN authoring system 800 and method, such as the visual and animated table of contents.

Moreover, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### VII. RIN Books and Other RIN-Related Content

Recall from above that data (e.g., media data) associated with rendering an experience stream of a RIN can be located in a variety of places, such as within the aforementioned auxiliary data of the experience stream, one or more resource tables associated with the RIN, one or more external referenced files, dynamic query results, etc. Individual data items providing data, and one or more RINs for representing this data, can collectively be considered a RIN book since a user can access and interactively explore and/or edit this data, as represented by the RIN(s).

As noted above, the ability to create and/or edit RINs, and thus RIN books, at a very granular level permits authors and editors to create highly personalized themed RIN books which a have a unique “look and feel”. Thus, a themed RIN book might include a distinct design theme and identity that uniquely represents the consumable—in a similar manner to a book, magazine, movie, website, or other type of media data item. For example, in the context of the above examples, a themed RIN book might be designed and identified broadly as “Grand Canyon Adventure” with attributes that result in a unique “look and feel”. This theme can determine how the environment provided by the RIN book is perceived by a user as he/she interactively explores a scripted path through that environment.

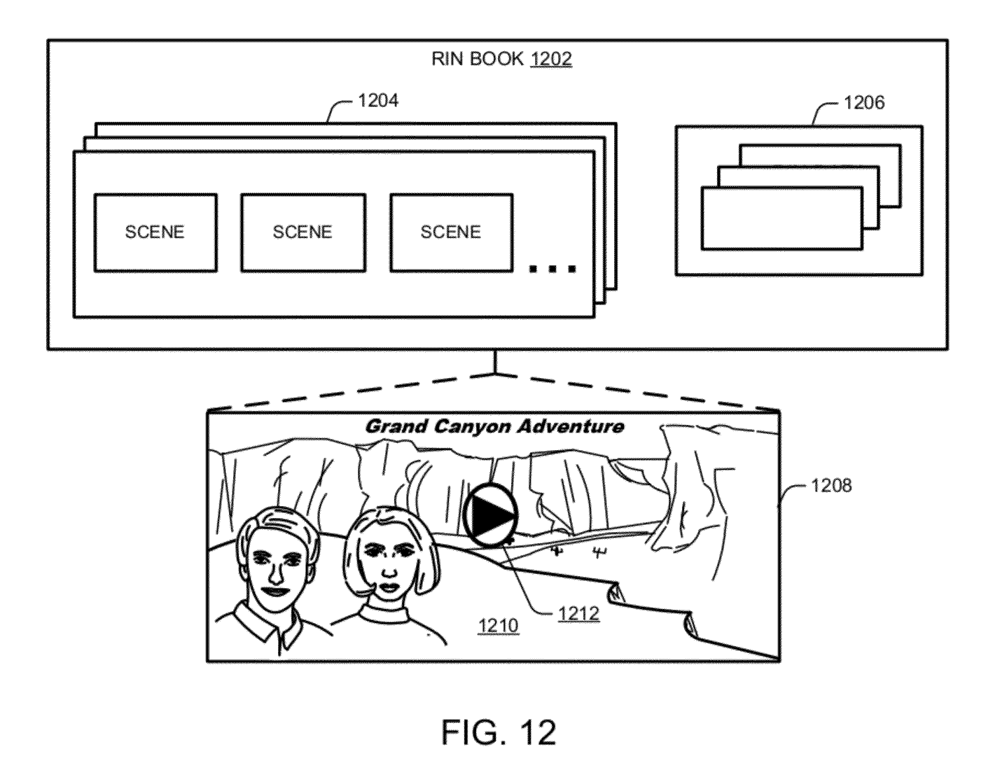

To facilitate the reader's understanding, FIG. 12 illustrates an example themed RIN book 1202 that includes one or more RINs 1204 and one or more data items 1206 associated with the RIN(s) 1204. Note that explained in detail above, the RIN(s) 1204 may be associated with any number of associated scenes. Assume that here in this example, the RIN book 1202 is a themed RIN book designed and identified (i.e., named) “Grand Canyon Adventure”. Also assume that the RIN book 1202 provides a rich interactive explorative experience 1208 with a unique “look and feel” associated with exploring the Grand Canyon.

Recall from above that a RIN, and thus a RIN book, may include a menu-like start scene that serves as a launching point for a RIN, analogous to the menu of a DVD movie. Accordingly, note that here a menu-like start scene 1210 with a selectable play control 1212 is shown. The selectable play control 1212 provides one way in which a user might access (e.g., play) or otherwise initiate the interactive exploration of the rich interactive explorative experience 1208.

### VII.A. Example RIN Book Computing Environment

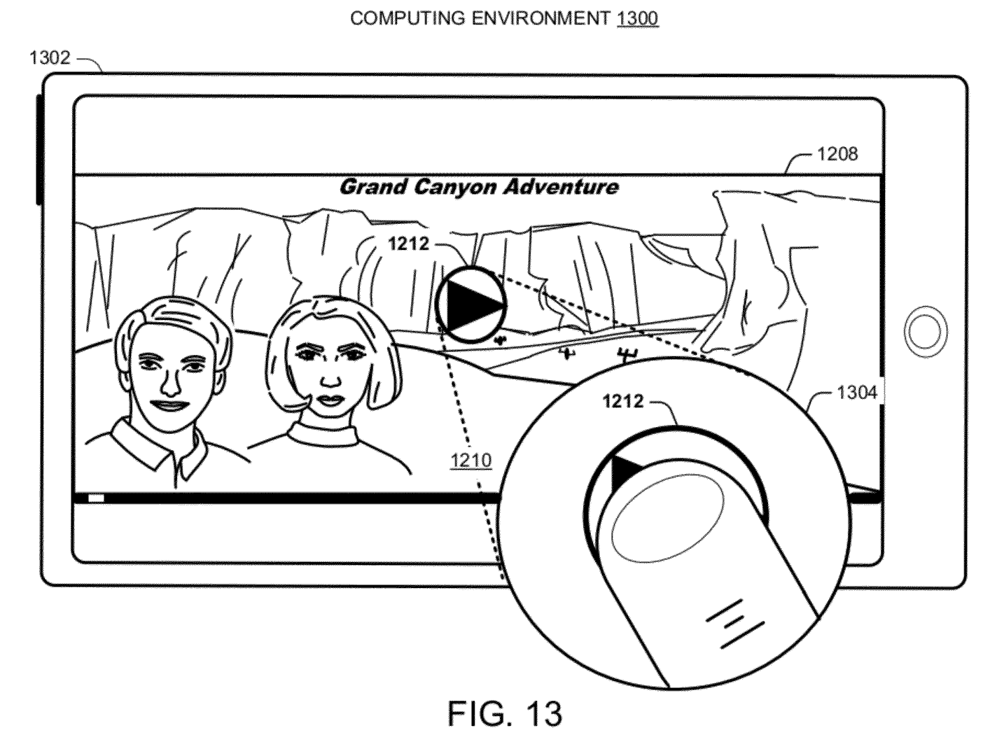

To further facilitate the reader's understanding, FIG. 13 illustrates an example computing environment 1300 in which a RIN book and/or other RIN-related content items may be implemented in accordance with the described techniques. For discussion purposes, the computing environment 1300 is described here in the context of the example RIN book 1202 described above being implemented on a hand-held computing device 1302. Here, computing device 1302 includes a touch-screen display configured to receive user inputs, such as a phone, smart phone, tablet-type computer, or the like. However, it is to be appreciated and understood that this is but one example, and these techniques are applicable to any kind of computing device.

In this example, note that the menu-like start scene 1210 of “Grand Canyon Adventure” is displayed on a user interface (UI) in the touch-screen display of the hand-held computing device 1302. Any type and combination of data items, such as a photosynth, video file, sound file, etc., can be utilized. Additionally, note that the selectable play control 1212 is displayed in the menu-like start scene 1210. Thus, the computing device 1210 may be utilized by a user to access the RIN book 1202 and the interactive explorative experience 1208. Additionally, in at least one embodiment, the computing device 1210 may also be utilized by the user to edit, distribute, publish, or otherwise share the RIN book 1202.

In this regard, the RIN book 1202 may be implemented on the computing device 1302 via a presentation platform that supports playing/rendering, authoring, editing, and/or publishing/re-publishing RIN books. The presentation platform can provide the user interface (UI) with a viewing window in which experience stream viewports associated with the RIN book 1202 can be displayed.

Examples of such a platform(s) might include, without limitation, Microsoft® Corporation's Silverlight®, Adobe® System Incorporated's Flash®, an HTML and/or Javascript® supported system of Oracle Corporation of Redwood City, Calif., etc. For discussion purposes, assume that here, as shown in callout 1304, a user selects the selectable play control 1212 in order to initiate the interactive explorative experience 1208.

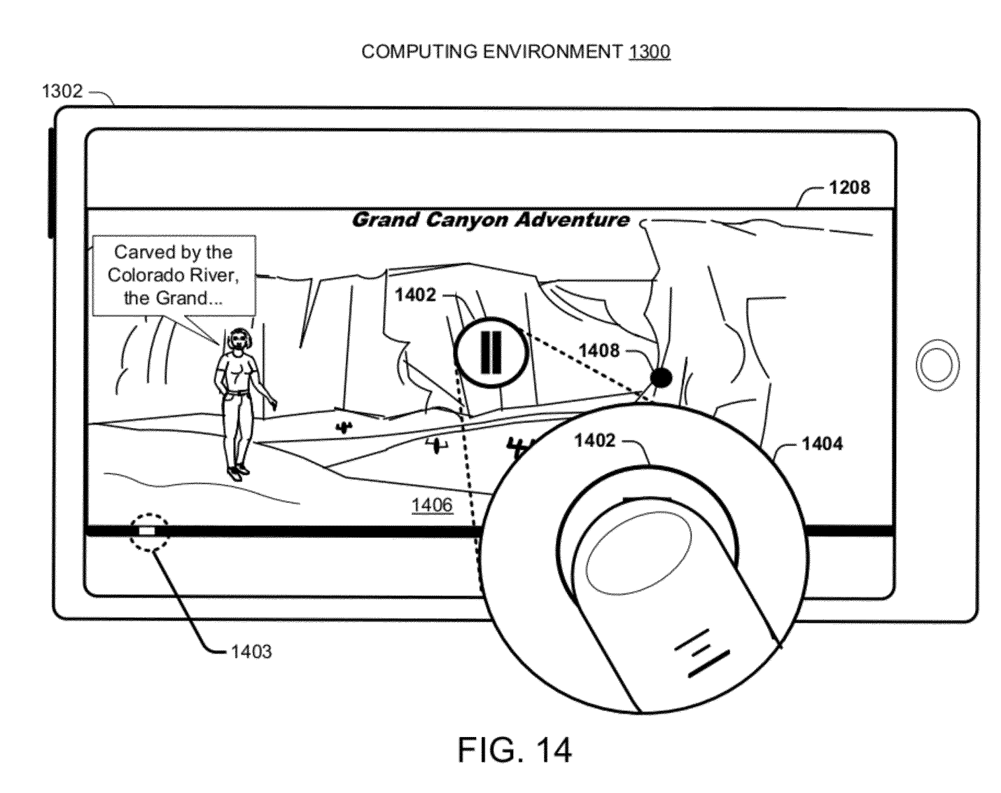

Referring to FIG. 14, recall that a user can stop a narrative of a RIN (e.g., pause the interactive explorative experience 1208), explore the environment associated with a particular presented current scene and/or edit the RIN, and then resume the narrative. Therefore, also assume that while interactively exploring a scripted path of the “Grand Canyon Adventure”, the user decides to select the pause/stop control 1402 at a certain point of time 1403 along the scripted path (i.e., along the timeline of the interactive explorative experience 1208), as shown in callout 1404. In certain embodiments, the pause/stop control can be configured to remain hidden by default and to surface (i.e., appear”) when the user indicates an intention to interact, such as by touching the display or tilting the hand-held computing device 1302.

Note that the scene displayed in the user interface (Up when the user selects the selectable pause/stop control 1402 (i.e., at point of time 1403) is referenced here as scene 1406. The scene 1406 depicts a zoomed portion of the canyon depicted in the menu-like start scene 1210. Note that the host's visible and/or audible comments are provided in this scene. Thus, the scene 1406 is one of any number of scenes associated with the interactive explorative experience 1208. Said another way, the scene 1406 is composed of portions of one or more RIN Segments (e.g., RIN segment(s) 200) which in turn is an orchestration of one or more experience streams of one or more RINs that provide the interactive explorative experience 1208.

Continuing, now assume that the user is interested in a geographical rock formation depicted in the region at and/or near location point 1408 in the scene 1406. For example, the user might have a personal opinion or observation that he/she wishes to share (e.g., “This rock formation is beautiful, especially as the sun is setting.”). Alternatively or additionally, the user might wish to share more objective expertise or knowledge about the formation (e.g., more scientific geological information). To accomplish this, during the interactive explorative experience 1208 the user may decide to edit the RIN book 1208 by adding annotations or other types of edits.

More particularly, the user might add one or more simple text notes, new RINs and/or data items, modify the RIN(s) 1204, and/or modify the existing data item(s)s 1206. In at least one embodiment, the user might utilize an authoring system, such as the RIN authoring system described above for instance, to edit the RIN book 1208 in an online and/or offline fashion. For example, the user might add a new RIN. Alternatively or additionally, the user might edit one or more of the RINS 1204 by adding and/or editing one or more screenplays, experience streams (e.g., data bindings and/or trajectory experience stream portions) and/or resource table resources referenced by one or more of the RIN(s) 1204.

In the context of screenplays for instance, the user may create, select, and/or edit key frames (representing a state at a certain point in space at a given time), overlays and popups, and/or transitions between experience streams. The user can also add narratives inside other narratives (e.g., by adding and/or editing experience stream layers, adding a new RIN, etc.) such that a “child narrative” is effectively included inside a “parent narrative” of the RIN book 1202.

As a practical example, assume that at point of time 1403 along the scripted path, the user decides to share a personal observation about the geographical rock formation depicted in the region at and/or near location point 1408 as a text note annotation. Operationally, a marker may be manually and/or automatically embedded at the point along the scripted path (e.g., at point of time 1403 and/or one or more other points of time) that serves as a marker and/or anchor for text note annotation and/or other content (e.g., a text note and/or input box) to be made available and/or automatically initiated (e.g., at point of time 1403).

In at least one embodiment, the RIN player and/or RIN book might provide the user with a RIN book console having controls to facilitate navigating an interactive explorative experience and/or posting annotations, such as text notes and/or sound clips. An example of such a console and the user's interaction with various controls of the console will be described further below.

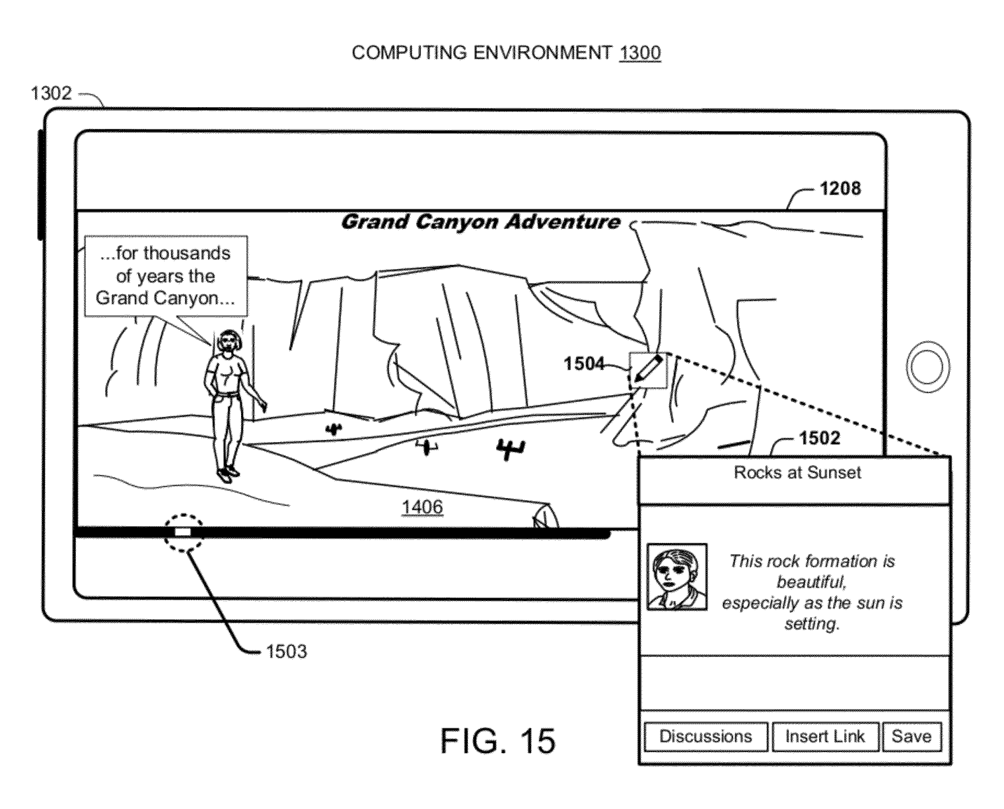

For now however, assume that as shown in the callout 1502 of FIG. 15, the user has added a text note annotation that is designated by one or more embedded markers and discoverable starting at point of time 1403 and at least through a point of time 1504. Also assume that the text note annotation is entitled “Rocks at Sunset” and states: “This rock formation is beautiful, especially as the sun is setting.” Observe that in this example, the text note annotation includes a photograph of the user to help associate them as the author of the text note annotation.

This annotation might be made discoverable during some or all of the interactive explorative experience in any of a variety of ways. For example, note that here a small selectable icon 1504 has been positioned at and/or near the location point 1408. As noted above, the embedded marker(s) can ensure that the selectable icon 1504 is discoverable starting at point of time 1403 and at least through point of time 1504. In at least one embodiment, the small selectable icon 1504 might be a semi-transparent overlay or other such representation intended to reduce and/or minimize the user's distraction from the interactive user experience 1208.

As another alternative or additional example, assume that during the interactive explorative experience 1208, at scene 1406 the user decides to share his/her geological expertise about the geographical rock formation. To accomplish this, the user might edit the RIN book 1202 to include a new RIN named “Discovering Grand Canyon Rock Formations”. This new narrative might, for instance, provide a new interactive explorative experience (with annotations) about the geographical rock formation.

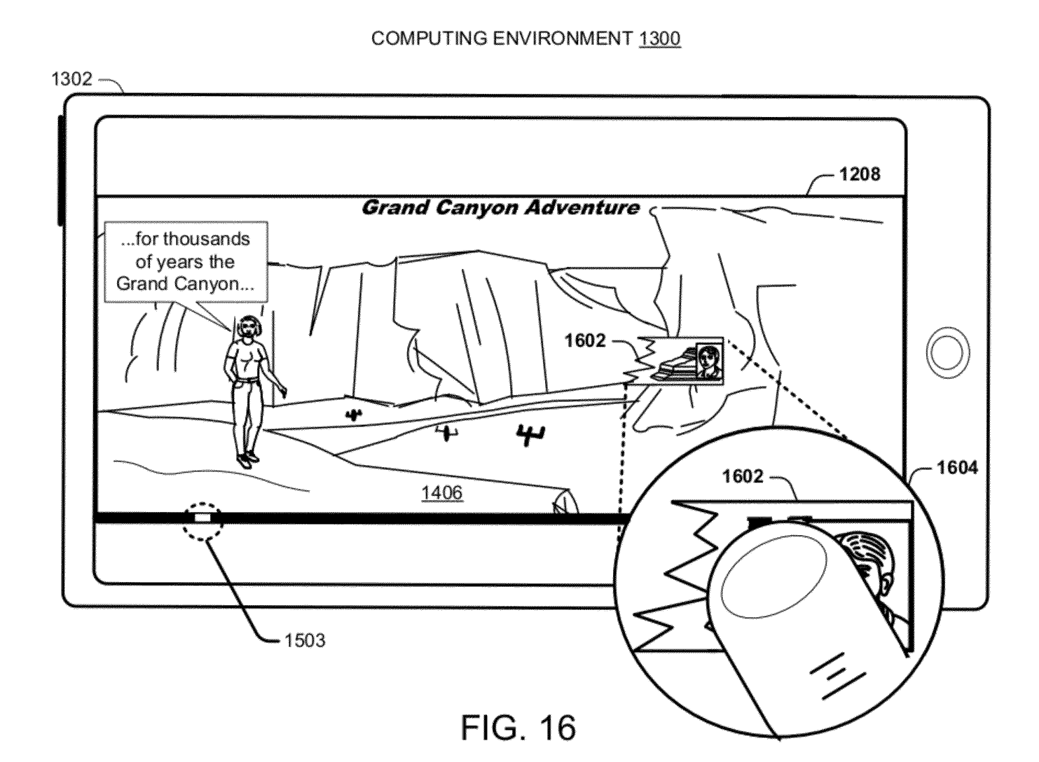

After editing the RIN book 1202 to include the new narrative, assume here that the user wishes to include a user-selectable indication (e.g., an icon and/or other type of clue) in one or more scenes of the interactive explorative experience 1208 to facilitate discovery and/or initiation of the new geographical narrative. For example, as illustrated in FIG. 16, in the context of the scene 1406 assume that the user adds a selectable icon 1602 at/or near the location point 1408.

As with the text note annotation example above, one or more embedded markers can ensure that the selectable icon 1602 is discoverable starting at point of time 1403 and at least through the point of time 1504.

Observe that in this example, the selectable icon 1602 also includes a photograph of the user to help associate them as the author of the icon and of the new RIN “Discovering Grand Canyon Rock Formations”. In at least one embodiment, the selectable icon 1602 might be a semi-transparent overlay or other such representation intended to minimize the user's distraction from the interactive user experience 1208.

Also assume that the new geographical narrative, when initiated (e.g., automatically by a user's selection of the selectable icon 1602), includes a transition between the one or more experience streams of the RIN(s) 1204 associated with the interactive explorative experience 1208 and the new RIN “Discovering Grand Canyon Rock Formations”.

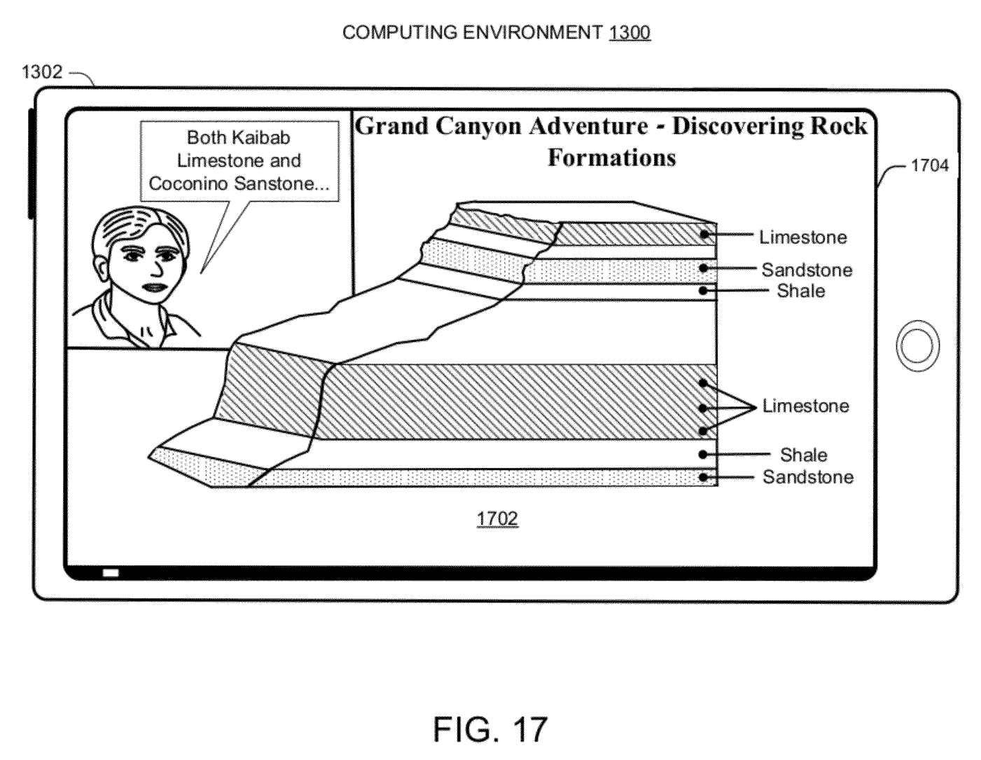

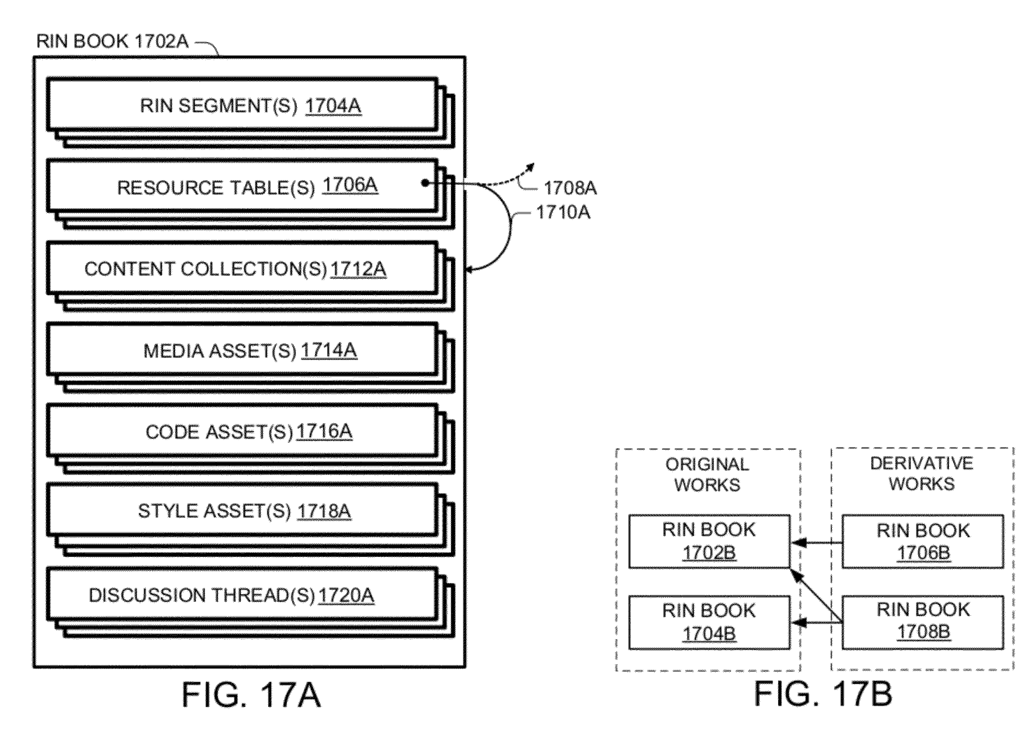

As a practical example, now assume that the user or another user selects the selectable icon 1602, as shown in the callout 1604. As a result, and as shown in scene 1702 illustrated in FIG. 17, the user or other user can be provided with a new interactive explorative experience 1704 for “Discovering Grand Canyon Rock Formations”. Note that in this example, the user's annotations, in the form of one his/her visible and/or audible comments, are provided in this scene.

Finally, as described below, after editing the user might then decide to re-publish the edited RIN book 1208 as a new derivative RIN book. The user might even re-name the new derivative RIN book (e.g., “Grand Canyon Adventure—Discovering Rock Formations”).

### VII.B. Example RIN Book Structure

Recall that individual data items providing data, and one or more RINs for representing this data, can collectively be considered a RIN book since a user can access and interactively explore and/or edit this data, as represented by the RIN(s). On a more granular note, RIN books can be described with respect to the individual content item types that can make up a RIN book.

Accordingly, to assist the reader's understanding, FIG. 17A illustrates individual content item types that can make up an example RIN Book 1702A, in accordance with at least one embodiment. More particularly, the RIN Book 1702A can include one or more RIN Segments 1704A that can provide orchestrations of linear narrative segments of the RIN Book 1702A. The RIN Book 1702A can also include references to resources. These references may be specified in one or more resource tables 1706A.

References specified in the resource table(s) 1706A may include references to external resources 1708A and/or references to internal resources 1710A. External references 1708A may refer to resources that do not form a part of the RIN Book 1702A. For example, this may include web references to live feeds from external services, references to content of other RIN Books, etc. Internal references 1710A may refer to (or within) content that forms part of the RIN Book 1702A.

Content Collections 1712A can be used to populate a variety of RIN Book content, including embedded artifacts, content browser galleries, visual tables of contents, etc. The RIN Book 1702A may also include one or more media assets 1714A such as, for example, text, audio, video and other types of media data items that may form an integral part of the RIN Book 1702A. The RIN Book 1702A may also include one or more custom experience providers and/or pluggable controls that form Code assets 1716A. Code asset(s) 1716A can include, for example, software configured to produce interactive behavior such as gaming logic specific to the RIN Book 1702A. The RIN Book 1702A may have custom styles (e.g., icons, buttons, etc) that can form one or more style assets 1718A. A RIN Book also may maintain one or more shared discussion threads 1720A that contain annotations within the RIN book 1702A.

As explained above, once a RIN book (or other RIN-related content) is published or otherwise shared by an author, others can leverage experiences and experiences streams from the published RIN book and/or other published RIN-related content (e.g., RIN books, RIN documents, etc.) to create their own derivative content. For example, a user might create a personalized summary of a RIN and/or RIN book that includes references to specific locations or states within specific experience streams in the RIN, augmented with additional textual or multimedia annotations contributed by the use. The result might be a derivative work that may be in turn be re-published.

To assist the reader's understanding, FIG. 17B illustrates example relationships that might exist between two original RIN books 1702B and 1704B and two other derivative RIN books 1706B and 1708B. For discussion purposes assume that RIN books 1702B and 1704B are original works and RIN books 1706B and 1708B are derivatives of one or both of the RIN book 1702B and/or 1704B. More particularly, here the RIN book 1706B includes and/or references content (e.g., one or more RIN segments, collections, data media items, etc.) from the RIN book 1702B and is thus a derivative work the RIN book 1702B. The RIN book 1708B, in turn, includes and/or references content from both the RIN book 1702B and 1704B, and is thus a derivative work of both the RIN book 1702B and 170B.

### VII.C. RIN Book Method

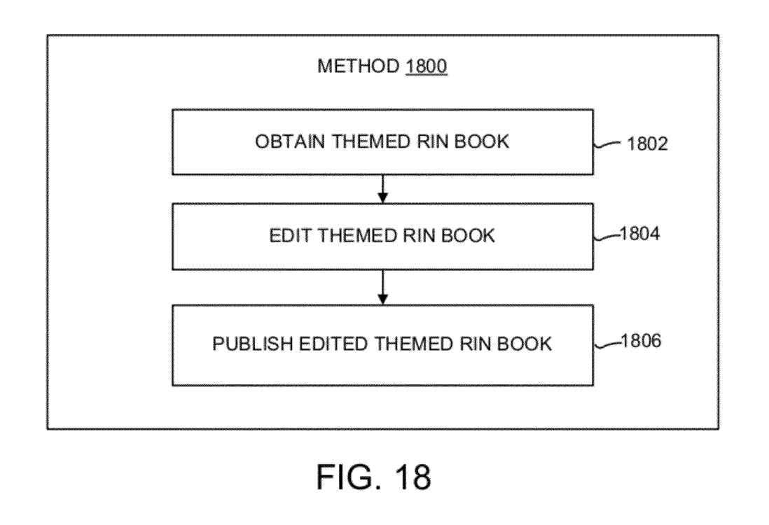

FIG. 18 illustrates a flowchart of a technique or method 1800 that is consistent with at least one described technique for creating, editing, and sharing RIN books.

At block 1802, a RIN book can be obtained. The RIN book may be obtained in a variety of ways. For example, the RIN book might be created. More particularly individual data items providing data and one or more RINs for representing this data can collectively be considered a RIN book, such as illustrated in FIG. 17A for instance. Thus, creating the RIN book may include creating one or more of the individual data items and/or RIN(s). Alternatively or additionally, one or more previously-created data items and/or RINs might be accessed and utilized to create the RIN book.

In at least one embodiment, a user might utilize one or more RIN experience tools to obtain the RIN book. For example, the RIN experience tool(s) might include functionality provided by a presentation platform that supports accessing (e.g., playing/rendering) and/or acquiring (e.g., downloading, etc.) the RIN book. Operationally, in at least one embodiment, the RIN book may be published or otherwise shared on a RIN books hosting platform and obtained via a RIN-related content provider (e.g., the RIN provider described herein).

At block 1804, the RIN book can be edited. In at least one embodiment, a user might utilize the above-mentioned RIN experience tool(s) to edit the RIN book. As explained in detail above, editing may include the user adding text note and/or sound clip annotations. Alternatively or additionally, the user might express their expertise by adding other types of RIN-related content. For example, the user might add a new RIN segment and/or edit one or more of the RIN book's existing RIN segments. As a result, the RIN book might include new annotations, new data items, and/or even one or more new interactive explorative experiences.

In at least one embodiment, one or more RIN-related content items may be added as one or more embedded artifacts and/or highlights to the RIN book. Recall that artifacts and highlights are embedded in the environment (e.g., in an image, video, and/or other media data item), and can be correctly positioned and rendered as the user explores the environment. As explained above for instance, artifacts and region highlights can serve as a way to perform content annotation in a very general, extensible way. For example, evolving regions in a video or photosynth can be annotated with arbitrary metadata. Similarly, portions of images, maps, and even audio could be marked up using artifacts and highlights (which can be a sound in the case of audio).

In some circumstances, in accordance with the described techniques, a user might edit the RIN book while the user is interactively exploring a scripted path of an experience stream provided by that item. Alternatively or additionally, the user may not be interactively exploring the RIN book when they edit the RIN book. In either case however, RIN books may be edited in a variety of ways. For example, one or more annotations and/or other types of edits might be made at one or more particular points of time along the path of a RIN's interactive explorative experience.

Recall that each scripted path through a particular environment is defined by a sequence of one or more keyframe sequences that make up a trajectory of an experience stream. Also recall that each keyframe captures the state of the interactive explorative experience at a particular point in time and represents a particular environment-to-viewport mapping at that particular point in time. Therefore, an annotation and/or other type of edit to an experience stream of a RIN book at a particular point of time can correspond to at least one keyframe of that experience stream's trajectory.

Furthermore, since each interpolation between two keyframes is defined by a transition, an annotation and/or other type of edit that corresponds to multiple keyframes may correspond with at least one transition. Similarly, since individual markers are embedded in a scripted path and mark a particular point in the logical sequence of a narrative, an annotation and/or other type of edit may correspond with one or more markers.

As but one example, one or more regions/locations in a scene associated with one or more experience streams of a RIN and/or RIN book may be annotated at one or more points of time in a general way with artifacts, highlights, etc. One or more markers may be automatically and/or manually embedded at the region(s)/location(s) and point(s) of time, and act as an anchor(s) for each annotation. Such general annotations may or may not change the theme of the annotated content item.

Alternatively or additionally, the region(s)/locations(s) in the scene may be edited in other more substantial ways, such as with other types of new content (e.g., new RIN-related content and/or media data) and/or changes (e.g., changes to screenplay orchestration information, experience stream environmental data and/or trajectories, etc.). As such, in some circumstances a RIN and/or RIN book can be edited with annotations that provide one or more new interactive explorative experiences.

Again, one or more markers may be used as an anchor(s) for the edit(s), including as an anchor or point by which the new content may be brought into a particular scene. In addition, the marker(s) can be used as a trigger and/or decision for new content. For example, the trigger may automatically launch a new experience stream, pause at the marker to request feedback from the user (e.g., a menu or decision as to whether or not to interactively explore new content), etc.

As noted above, the ability to create and/or edit RINs and RIN books at a very rich and granular level permits authors and editors to create highly personalized themed RIN books which a have a unique “look and feel”. Consider, for instance, the example described above where the unique “look and feel” of the RIN book “Grand Canyon Adventure” was edited to include the new geographical narrative named “Discovering Grand Canyon Rock Formations”, which also has a unique “look and feel” as well.

Accordingly, in at least one embodiment, the theme of the edited RIN book can be changed by adding, removing, and/or modifying RIN-related content associated with the theme. In such cases, the edited RIN book may be considered a derivative work of the original RIN book (i.e., a derivative RIN book), such as illustrated in FIG. 17B for instance. For example, as noted above, a RIN and/or RIN book might be edited with annotations that include one or more new RINs, and thus a new interactive explorative experience(s).

At block 1806, the edited RIN book can be published or otherwise made available. As described above, in at least one embodiment this can include publishing the edited RIN book as a new derivative RIN book on a RIN books hosting platform, such as a cloud-based application platform for instance. The platform can be configured to allow the consumable RIN, and other consumable RIN-related content items (e.g., other consumable RINS, RINs, RIN components, and/or data items) to be shared and, in some circumstances, even monetized.

As but one example, a fee may be required to access or otherwise utilize individual content items published or otherwise shared. In at least some embodiments, digital rights management (DRM) techniques and/or other types of access controls may be utilized to ensure that such shared content items are not accessed and/or utilized without the proper fee being paid and/or proper access controls satisfied.

These access controls can be utilized for all or part of a shared content item, and may be associated with different levels of access. For instance, accessing a shared RIN book might be free while utilizing the consumable to create derivative content (e.g., by editing) might be associated with a fee. As another example, advertising/marketing information might be embedded in individual content items and/or otherwise associated with accessing and/or utilizing individual shared content items.

### VIII. RIN Books Hosting Platform

Recall from above that a RIN Books hosting platform (e.g., cloud-based application platform) can be configured to allow RIN-related content items to be shared and, in some circumstances, monetized. For example, users such as content authors (creators, editors, etc.), owners, distributors, retailers, and/or end users can utilize the RIN books hosting platform as a forum for creating, editing, publishing, distributing, accessing, and/or otherwise sharing the RIN-related content. In this regard, any number of sharing arrangements might be supported.

For example, a free platform sharing model might allow any user to freely engage in any sharing activities, such as creating (e.g., online or offline), publishing, distributing, accessing, and acquiring the RIN-related content. For instance, a user might freely create a RIN-related content item utilizing his/her own content items and/or freely available content items that have been published by other users on the RIN books hosting platform.

Alternatively or additionally, a more restrictive platform sharing model (e.g., a museum-like, educational-like model and/or retail market place model) might limit one or more the sharing activities of some or all published RIN-related content items. These one or more sharing limitations might be based on any number and type of sharing restriction criteria. Without limitation, this sharing restriction criteria might include user-specific restriction criteria (e.g., age, user membership, date/time, etc,) and/or item-specific restriction criteria (e.g., DRM protection, embedded advertising, a fee requirement for partial or full sharing, etc.).

To facilitate various sharing arrangements, a RIN Books hosting platform may implement virtual storefronts, each of which implements a particular set of policies as required by a particular publisher (e.g., organization or individual user). Feature options can include any number of configurable sharing controls which may impose and enforce various sharing limitations for all or some of the RIN-related content items published on the RIN Books hosting platform. For example, platform-level sharing controls might be configured to enforce platform-level requirements such as platform authentication/password requirements, fee payment requirements, date and/or time requirements, etc.

Alternatively or additionally, data item-level sharing controls might be configured to enforce data item-level requirements such as item-specific authentication/password requirements, DRM protections, embedded advertisements (e.g., for free or reduced fee access), different allowed sharing levels (e.g., access but no editing or acquiring), etc.

In at least one embodiment, one or more of the above-mentioned sharing arrangements can permit individual published RIN-related content items to be monetized. For example, the RIN books hosting platform might be utilized to implement an online marketplace where individual RIN-related content items can be shared. In this regard, in operation the configurable sharing controls provided by the RIN books hosting platform might be utilized to implement various types of monetization schemes to be implemented for at least some of the individual published items. For instance, a membership fee might be required for a user to perform one or more specific sharing activities related to a particular published item, such as creating, editing, publishing, distributing, accessing (e.g., playing/rendering, interactively exploring, etc.), and/or acquiring (e.g., downloading, etc,) that item.

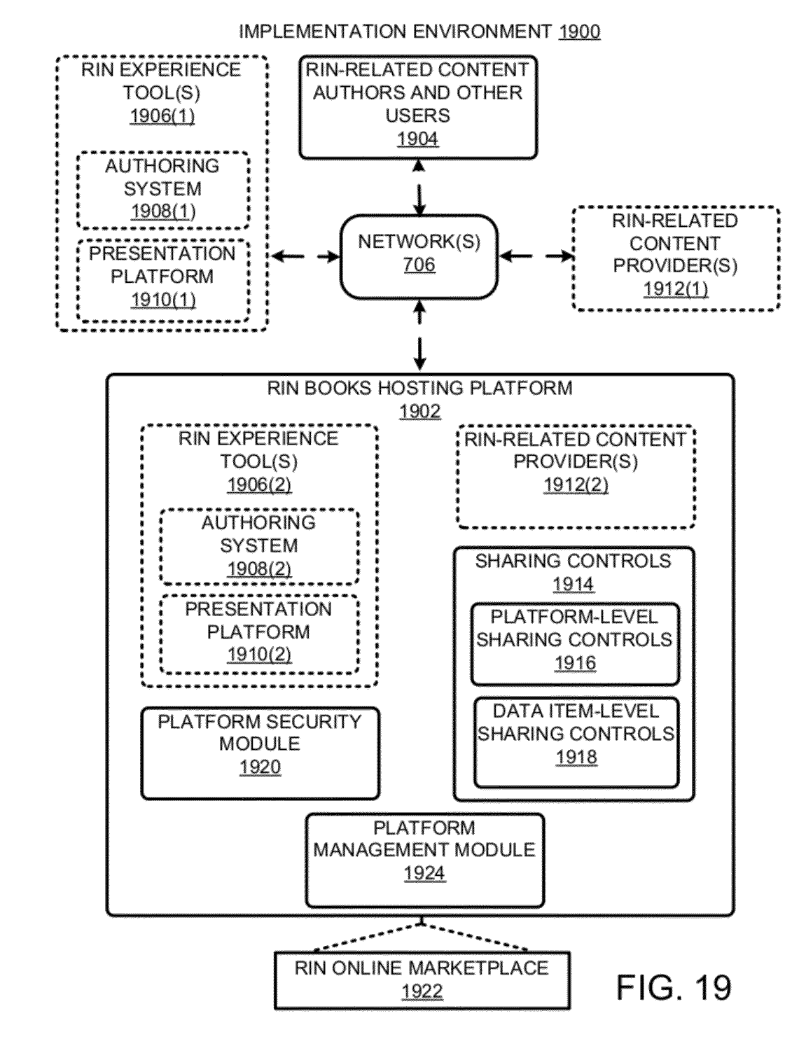

To further facilitate the reader's understanding, FIG. 19 illustrates an example implementation environment 1900 in which an example RIN Books hosting platform 1902 may be implemented in accordance with the described techniques. Note that in this example, the implementation environment 1900 is presented in the context of the one or more network(s) 706 of the generalized and exemplary environment illustrated in FIG. 7 and described above.

In this regard, recall from above that once created and/or edited by one or more authors, RINs may be deposited with one or more providers (e.g., the RIN provider(s) experience stream providers, media providers, etc.). Also recall that the authors and/or providers may communicate via the network(s) 706 which, for instance, may include the Internet, a proprietary network, etc. Alternatively or additionally, the authors and/or providers may communicate via some other means, such as directly for instance. In addition, the authors and/or providers can also communicate via the network(s) 706 and/or via some other means with one or more players (e.g., player 704 described above).

With respect to the RIN authors, note that RIN books, RINs, RIN components, and other RIN-related content may be created and/or edited by users which, for purposes of discussion, may be referred to herein as authors. One example of how this can be accomplished is via the RIN authoring system and method described in detail above. In addition, users other than authors may desire to view or otherwise access RIN-related content. Accordingly, for discussion purposes here RIN-related content authors and other users 1904 are shown as being able to communicatively link with the network(s) 706.

As noted above, RIN-related content may be associated with a variety of sharing activities. One way in which sharing activities may be performed is via the example RIN authoring system and method described in detail above. For instance, without limitation an author might access, create and/or edit, and/or publish/re-publish a RIN or other RIN-related content via the example RIN authoring system.

Alternatively or additionally, an author may access, modify, and or acquire RIN-related documents such as RIN books, RINs, RIN components, etc. by employing a presentation platform, such as the example presentation platform described in detail herein in the U.S. patent application Ser. No. 13/008,324, filed Jan. 18, 2011, and which this application is a continuation-in-part of. In this regard, recall that the presentation platform may allow a player, such as the example RIN player described herein, to be implemented. Also recall that in at least one embodiment, the modification(s) can be made on the fly while being interactively explored.

In operation, an application such as the above mentioned player (e.g., RIN player) may be utilized to download all or part of a RIN, experience stream, media data item, or other RIN-related content from one or more providers to a user's computing device via the network(s) 706. Alternatively or additionally, the presentation platform may be utilized to allow the user to access all or part of the RIN-related content without downloading, such as through a browser application via the network(s) 706.

In at least one embodiment, the player can be embodied at least in part on the user's computing device. Alternatively or additionally, the player can be embodied or otherwise made available by the RIN books hosting platform or other source. In either case, functionality of the player can be accessed via an application/user interface specific to the player, or not specific to the player—such as via the above-mentioned browser application for instance. This latter scenario can be advantageous when the user's computing device is a relatively small device such as a mobile and/or hand-held computing device (e.g., computing device 1302).

To assist the reader's understanding, here one or more RIN experience tools 1906 is shown as being able to communicatively link with the network(s) 706. RIN experience tool(s) 1906 can include or otherwise provide various functionalities that allow authors or other users to perform one or more RIN-related content item sharing activities. More particularly, note that here in this example the RIN experience tool(s) 1906 can include, without limitation, an authoring system 1908 (e.g., the example authoring system described herein) and/or a presentation platform 1910 (e.g., the example presentation platform described herein).

As a practical example, in at least one embodiment, one or more of the RIN experience tool(s) 1906 can be configured to receive a user request for a RIN-related content item such as a RIN, RIN component, or RIN book for instance. The RIN-related content item might be shared in an accessible location, such as on the RIN books hosting platform 1902 for instance.

Responsive to receiving the user request, the RIN experience tool(s) 1906 can be utilized to facilitate importing or otherwise obtaining the requested RIN-related content item and then editing the content item. Stated another way, one or more of the RIN tool(s) 1906 can be configured to obtain in response to receiving the request and edit the RIN-related content in accordance with a user's editing instructions.

After the content item has been edited, in some circumstances the RIN experience tool(s) 1906 can also be utilized to re-publish the edited content item as a derivative RIN-related content item in accordance with the user's publishing instructions.

In addition to being configured to receive and/or obtain RIN-related content items, the RIN experience tool(s) 1906 can also be configured to perform a wide variety of sharing activities such as, without limitation, creating distributing, accessing, and/or acquiring the RIN-related content.

Note that here in this example, the RIN experience tool(s) 1906 (including the authoring system 1908 and presentation platform 1910) are surrounded and thus represented by dotted lines to emphasize and illustrate that the functionality of this tool might be provided by/via the RIN Books hosting platform 1902, might not be provided by/via the RIN books hosting platform 1902 (but nonetheless available via the network(s) 706), or some combination thereof.

For example, one or more non-hosting platform provided instances 1906(1) of the RIN experience tool(s) 1906 are shown outside of the RIN Books hosting platform 1902. Note that non-hosting platform instance(s) 1906(1) include, without limitation, one or more non-hosting platform instances 1908(1) of the authoring system 1908 and one or more non-hosting platform instances 1910(1) of the presentation platform 1910.

Similarly, one or more RIN Books hosting platform instances 1906(2) of the RIN experience tool(s) 1906 are shown as being provided by/via the RIN Books hosting platform 1902. Note that the platform provided instance(s) 1906(2) of the RIN experience tool(s) 1906 include, without limitation, one or more RIN Books hosting platform instances 1908(2) of the authoring system 1908 and one or more RIN Books hosting platform instances 1910(2) of the presentation platform.

Recall from above that RIN-related content may be accessed from one or more providers via the network(s) 706. Accordingly, to assist the reader's understanding, here one or more RIN-related content provider(s) 1912 is shown as being able to communicatively link with the network(s) 706. Note that the RIN-related content provider(s) 1912 can include or otherwise be affiliated with any number of individual providers of any type.

Also note that similar to the RIN experience tool(s) 1906, here the RIN-related content provider(s) 1912 is surrounded and thus represented by dotted lines to emphasize and illustrate that the RIN-related content provider(s) 1912 might be included or otherwise affiliated with the RIN Books hosting platform 1902, might not be included or otherwise affiliated with the RIN Books hosting platform 1902, or some combination thereof.

For example, an instance 1912(1) of the RIN-related content provider(s) 1912 is shown as not being included or otherwise affiliated with the RIN Books hosting platform 1902. Additionally, another instance 1912(2) of the RIN-related content provider(s) 1912 is shown as being included or otherwise affiliated with the media platform 1902.

As noted above, in at least one embodiment a RIN books hosting platform can be configured to allow RIN-related content items to be not only shared, but in some circumstances also monetized. As a practical example authors, owners, distributors, retailers, and/or end users can utilize the RIN Books hosting platform as a forum for creating, editing, publishing, distributing, accessing, and/or otherwise sharing the RIN-related content. To this end, one or more sharing models can thus be utilized to facilitate these sharing activities. For example, a free platform sharing model that allows users to freely engage in any sharing activities might be utilized.

Alternatively or additionally, one or more restrictive platform sharing models such as a museum-like model, educational-like model, or retail marketplace model might be utilized to monetize at least some of the shared RIN-related content. As explained above, these more restrictive models might include sharing limitations, such as restrictions based on user-specific restriction criteria and/or item-specific restriction criteria. To facilitate enforcing sharing restrictions (and thus enforcing these types of criteria), the RIN Books hosting platform may include any number of configurable sharing controls, such as platform-level sharing controls and/or data item-level sharing controls.

Accordingly, here in this example RIN Books hosting platform 1902 provides or otherwise facilitates configurable sharing controls 1914. The sharing controls 1914 can include, without limitation, one or more platform-level sharing controls 1916 and one or more data item-level sharing controls 1918. The sharing controls 1914 may be configured in any suitable manner. For example, in at least one embodiment, at least some of the sharing controls may be configured so that they may only be set or otherwise configured by a user with administrative rights for the RIN Books hosting platform 1902. To facilitate the management of a list of users with administrative rights, and to facilitate various other platform security concerns, the RIN Books hosting platform 1902 can include a platform security module 1920 and/or other suitable functionality.

The platform security module 1920 can be configured to permit authors and/or owners of RIN-related content to publish certain content items on, or otherwise interact with, the RIN Books hosting platform 1902. In this regard, the platform security module 1920 can enforce any number and type of sharing limitations by controlling the enforcement activity of each of the one or more of the sharing controls 1914. Consider a circumstance, for instance, where the platform security module 1920 utilizes one of the platform-level sharing controls 1916 to ensure that a publishing author/owner has paid a fee and/or is a registered member before allowing their content item to be published.

As another example, the platform security module 1920 might utilize one or more of the platform-level sharing controls 1916 and/or data item-level sharing controls 1918 to ensure that a user cannot circumvent being exposed to an embedded advertisement in a published content item in an unauthorized manner in order to access, edit, or otherwise perform a sharing activity. For instance, the user may try to access a free version of the content item, one or more embedded advertisements, and/or deactivate the advertisement(s) in some way.

As yet another example, the author and/or owner of a content item might determine that one or more portions (e.g., a first portion or one or more specific explorative paths) of the interactive explorative experience of a RIN or RIN book are to be free, while other portions may only be accessed for a fee, or by membership for instance. The platform security module 1920 might utilize one or more of the data item-level sharing controls 1918 to ensure that the fee and/or membership requirement is satisfied.

Recall that in at least one embodiment the RIN Books hosting platform 1902 can be configured to implement an online marketplace where individual published RIN-related content items can be shared, and at least some of the content items can be monetized. Accordingly, in this example, the RIN Books hosting platform 1902 is shown as implementing a RIN online marketplace 1922 wherein RIN-related content can be shared and monetized.

Finally, to facilitate the management of the various functionalities associated with hosting, maintaining, and otherwise implementing the RIN online marketplace 1922, the RIN Books hosting platform 1902 can also include a platform management module 1924. In operation, the platform management module 1924 may be configured to automatically coordinate, for example, the various functionalities associated with the components of the RIN Books hosting platform 1902. In doing so, the platform management module 1924 can thus be configured to effectively leverage or otherwise utilize the enforcement of the sharing controls 1914 to monetize published RIN-related content items.

More particularly, with respect to the sharing controls 1914 for instance, the platform management module 1924 can be configured to determine whether or not individual sharing restriction criteria of the sharing limitations are satisfied. For instance, the platform management module 1924 may receive payments, password authentication, and/or other required information.

In addition, the platform management module 1924 can be configured to cause the platform security module 1920 to control the enforcement activity of each of the sharing controls based on this determination. In other words, the platform management module 1924 can be configured to control the functioning of the platform security module 1920. Recall that the platform security module 1920 can enforce any number and type of sharing limitations by controlling the enforcement activity of each of the sharing controls 1914.

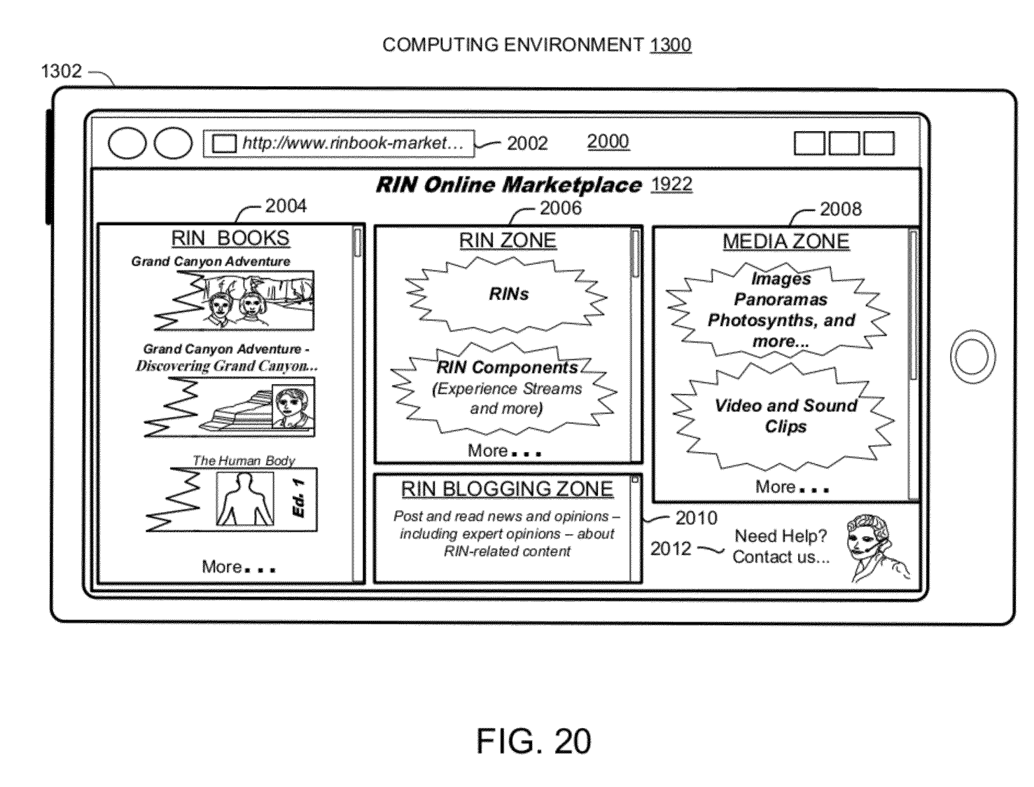

To further facilitate the reader's understanding, FIG. 20 illustrates an example of how the RIN online marketplace 1922 might be presented in the UI of a browser application 2000 implemented on the computing device 1302. The computing device 1302 is illustrated and described in the context of the example computing environment 1300. Note that this example is but one way the RIN online marketplace 1922 might be presented, and thus this example is not intended to be limiting. For example, alternatively or additionally RIN Books and other RIN-related content may be incorporated into existing application stores such as iTunes® by Apple® Incorporated of Cupertino, Calif., Windows Mobile Application Store® by Microsoft® Corporation, and Windows 8 Application Store by Microsoft® Corporation.

Here, also note that the RIN online marketplace is associated with a universal resource locator (URL) “www.rinbook-market . . . ” that is shown in an address window 2002 of the browsing application 2000. Thus, the browser application has navigated to this URL and presented the RIN online marketplace 1922. In this example, the RIN online marketplace 1922 includes several marketplace regions in which RIN-related content items are, and can be, shared and/or monetized. More particularly, note that a marketplace region 2004 entitled “RIN books” that includes a number of published RIN books, several of which are currently visible: the “Grand Canyon Adventure”, “Grand Canyon Adventure—Discovering Rock Formations” (both discussed above), and “The Human Body, Edition 1”. In addition, RIN Book publishers could be given the option of having their own marketplace domain name.

Additionally, the RIN online marketplace 1922 includes a marketplace region 2006 entitled “RIN ZONE” which includes sub-regions dedicated to RINs and RIN components, and a marketplace region 2008 entitled “MEDIA ZONE” which includes sub-regions dedicated to various types of media data items. Finally, the RIN online marketplace 1922 also includes a marketplace region 2010 entitled “RIN BLOGGING ZONE” and a marketplace region 2012 that facilitates a user contacting the marketplace 1922 to get help.

### VIII.A. Monetizing RIN-Related Content

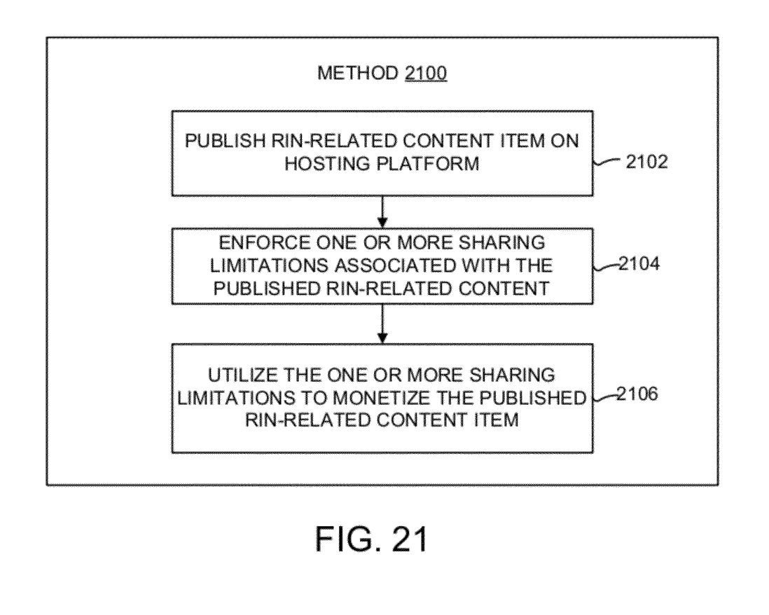

FIG. 21 illustrates a flowchart of a technique or method 2100 that is consistent with at least one described technique for sharing and monetizing RIN-related content.

At block 2102, a RIN-related content item can be published on a RIN Books hosting platform. In at least one embodiment, some or all of publishing the RIN-related content item can be performed automatically, such as by the RIN experience tool(s) 1906(1) for instance. More particularly, in at least one embodiment, the RIN document publishing module 880 described above can be utilized for example. With respect to the types of RIN-related content that may be published, recall that FIGS. 19 and 20, and the accompanying discussion, provide a practical example of such content that has been published on the RIN books hosting platform 1902, and thus made available on/via the RIN online marketplace 1922.

At block 2104, one or more sharing limitations associated with the RIN-related content item can be enforced. As explained above, sharing activities can include creating, editing, publishing, distributing, accessing, and/or acquiring that item. Thus, the sharing limitation(s) might restrict one or more of these activities. For example, a user might be permitted to interactively explore a published RIN book and even annotate that book with simple text notes and/or sound clips. However, the user might be restricted from further editing the RIN book to change its “look and feel” and then re-publishing the edited RIN book unless the user pays an acquisition fee.

As explained above, a sharing limitation might be based on any number and type of sharing restriction criteria, such as user-specific restriction criteria (e.g., age, user membership, date/time, etc,) and/or item-specific restriction criteria (e.g., digital rights management (DRM) protection, with or without embedded advertisements, required fee for partial or full access, etc.).

In at least one embodiment, the platform security module 1920 described above can be utilized to enforce the sharing limitation(s). As discussed above, this might include the platform security module 1920 utilizing one or more sharing controls, such as the sharing controls 1914 for instance.

At block 2106, the enforcement of the sharing limitation(s) can be utilized (e.g., leveraged) to monetize the RIN-related content item. For example, as noted above, a fee specific to the content item and/or associated with a membership/subscription to the RIN books hosting platform might be required to perform one or more types of the above-mentioned sharing activities. Alternatively or additionally, a free version of the content item that includes one or more embedded advertisements might be available along with another version associated with a fee that does not include the embedded advertisement(s).

In at least one embodiment, and as explained above, the platform management module 1924 described above can be utilized to effectively leverage or otherwise utilize the enforcement of sharing limitations via the sharing controls 1914 to monetize the published RIN-related content item.

### VIII.B. Example System

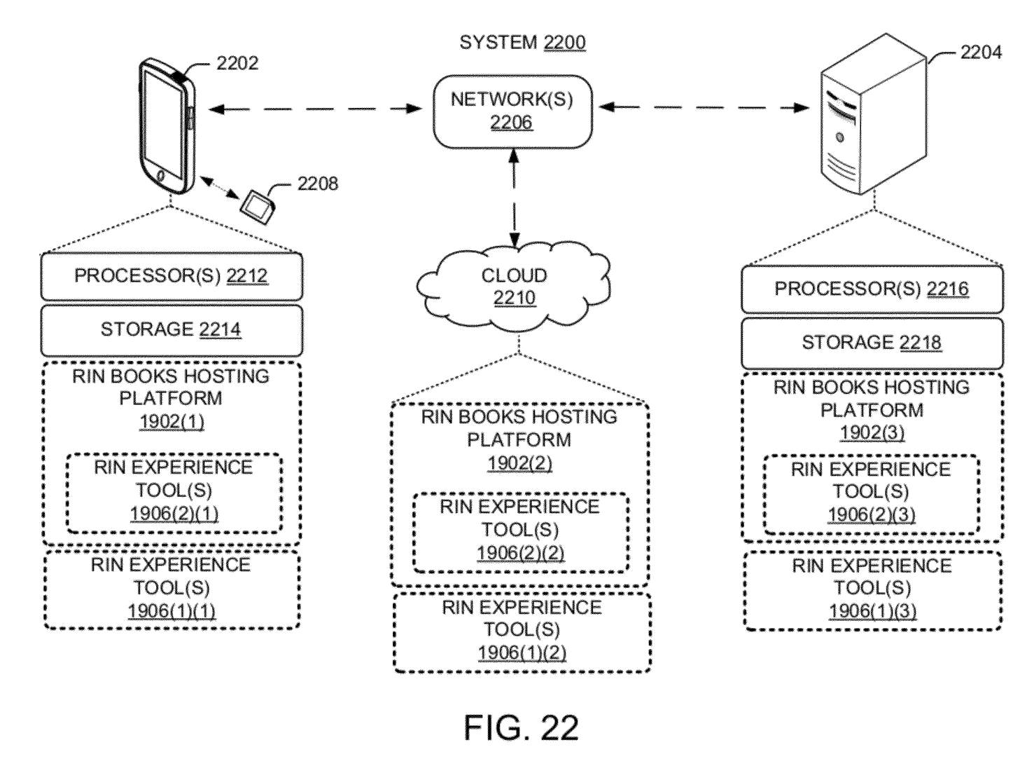

FIG. 22 illustrates an example system 2200 in which the described techniques may be implemented in accordance with at least one embodiment. In this example, the system 2200 includes multiple computing devices, represented here as computing devices 2202 and 2204. These computing devices can function in a stand-alone or cooperative manner to implement the described automatic UI rendering techniques. Here in this example, the computing device 2202 is shown embodied as a hand-held computing device, such as computing device 606 and/or 1302 described above for instance. Computing device 2204, in turn, is shown in this example embodied as one or more server computer devices. However, this is not intended to be limiting and it is to be appreciated and understood that the example system 2200 can include any number and type(s) of computing devices.

As noted above, the term “computing device”, as used herein, can include a device having at least some minimum computational capability, including, but not limited to, a personal computer, server computer, hand-held computing device, laptop or mobile computer, communications device such as cell phone, tablet, and/or PDA, multiprocessor system, microprocessor-based system, set top box, programmable consumer electronic, network PC, minicomputer, mainframe computer, audio or video media player, etc.

Computing devices 2202 and 2204 can indirectly and/or directly exchange data via one or more network(s) 2206 and/or by any other suitable means, such as via an external storage 2208 for instance. Examples of external storage can include optical storage devices (e.g., CDs, DVDs etc.) and flash storage devices (e.g., memory sticks or memory cards), among others.

Without limitation, the network(s) 2206 can include one or more local area networks (LANs), wide area networks (WANs), the Internet, and the like. One example of the network(s) 2206 is network(s) 706 described above. Additionally or alternatively, the computing devices 2202 and/or 2204 can exchange data with other resources, such as the cloud 2210 for example, via the network(s) 2206. As used herein, the cloud 2210 refers to computing-related resources/functionalities that can be accessed via the network(s) 2206, although the location of these computing resources and functionalities may not be readily apparent.

Here, computing devices 2202 and 2204 can each include a processor(s) (i.e., central processing unit(s)) and storage. More particularly, here the computing device 2202 includes processor(s) 2212 and storage 2214. Similarly, the computing device 2204 includes processor(s) 2216 and storage 2218. The processor(s) 2212 and 2216 can execute data in the form of computer-readable instructions to provide the functionality described herein. Data, such as computer-readable instructions, can be stored on the storage 2214 and/or 2218. The storage 2214 and/or 2218 can include one or more of volatile or non-volatile memory, hard drives, optical storage devices (e.g., CDs, DVDs etc.), or the like.

The devices 2202 and 2204 can also be configured to receive and/or generate data in the form of computer-readable instructions from one or more other storages, such as the external storage 2208 for instance. The computing devices may also receive data in the form of computer-readable instructions over the network(s) 2206 that are then stored on the computing device(s) for execution by the processor(s).

As used herein, the term “computer-readable media” can include transitory and non-transitory instructions. In contrast, the term “computer-readable storage media” excludes transitory instances. Computer-readable storage media can include “computer-readable storage devices”. Examples of computer-readable storage devices include volatile storage media, such as RAM, and non-volatile storage media, such as hard drives, optical discs, and flash memory, among others.

Recall that in accordance with the described techniques, a hosting platform such as the example RIN Books hosting platform 1902 described above can be configured to allow RIN-related content items to be shared and, in some circumstances, monetized. One way in which sharing activities may be performed is via functionality provided by the RIN experience tool(s) 1906, which may include functionality associated with the example RIN authoring system 1908 and/or presentation platform 1910 described above for instance.

Accordingly, here in this example the computing device 2202 is shown as being configured to implement at least part of the RIN Books hosting platform 1902. Note that in this regard, and as described above, all or part of the RIN experience tool(s) 1906 may be provided by/via the RIN Books hosting platform 1902—namely as RIN Books hosting platform instance(s) 1906(2) of the RIN experience tool(s) 1906.

Alternatively or additionally, all or part of the RIN experience tool(s) 1906 may be provided outside of the RIN Books hosting platform 1902. Accordingly, here the computing device 2202 is also shown as being configured to implement all or part of the non-RIN Books hosting platform instance(s) 1906(1) of the RIN experience tool(s) 1906.

To emphasize that all or part of the RIN Books hosting platform 1902 and/or the RIN experience tool(s) non-hosting platform instance(s) 1906(1) may be implemented by any number and suitable type of computing resources, here the cloud-based computing resources available via the cloud 2210, and the computing device 2204, are also each shown as being configured to implement at least part of the RIN Books hosting platform 1902 and/or RIN experience tool(s) non-hosting platform instance(s) 1906(1).

In operation, in at least one scenario the computing device 2202 may function in a stand-alone configuration such that all of the RIN Books hosting platform 1902 and/or RIN experience tool(s) 1906 are implemented by the computing device 2202. In at least one other scenario however, at least some (if not all) of the RIN Books hosting platform 1902 and/or RIN experience tool(s) 1906 are implemented by the cloud-based computing resources and/or by the computing device 2204.

### IX. Example RIN Book Annotation Console

In at least one embodiment, in accordance with the described techniques a player configured to implement a RIN book and/or the RIN book itself may provide one or more graphical tools to assist a user to add annotations or other types of edits while interactively exploring a scripted path through an environment provided by the RIN book. This tool(s) may, for instance, be presented in the context of a console that includes various selectable controls associated with an interactive explorative experience.

To facilitate the reader's understanding, recall that in accordance with the described techniques, a user may add an annotation to a RIN book by inserting a text note to one or more scenes associated with an environment in a RIN book. More particularly, consider the example above regarding the RIN book 1202 for instance. Recall that in that example, the user stopped the narrative associated with the interactive explorative experience 1208 at scene 1406. As one practical example of adding an annotation, also recall that the user decided to share a personal observation by adding a simple text annotation at and/or near the location point 1408 that stated: “This rock formation is beautiful, especially as the sun is setting.” To illustrate such an annotation, the callout 1502 is shown in FIG. 15.

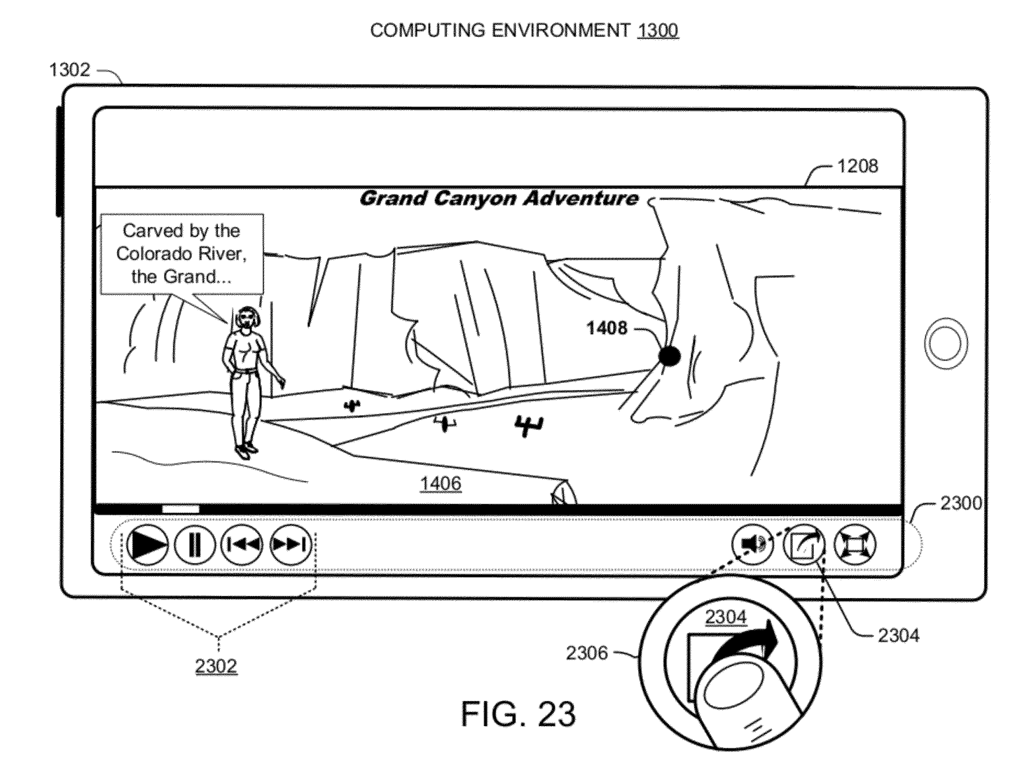

To further facilitate the reader's understanding, FIGS. 23-26 illustrate an example console with various selectable controls that might be implemented on the computing device 1302. The computing device 1302 is illustrated and described in the context of the example computing environment 1300. Referring to FIG. 23, for discussion purposes assume that in the above example, the RIN book 1202 and/or the player (e.g., RIN player) being used to access the RIN book 1202 is configured to provide the user with a console 2300 that includes various selectable controls for navigating and interacting with the interactive explorative experience 1208. For example, the console 2300 may include a set of various navigational controls 2302 and at least one annotation control 2304. Also assume that the user, having stopped the currently playing narrative by selecting a selectable pause/stop control (as shown in callout 1404 of FIG. 14), decides to select the annotation control 2304, as shown here in callout 2306.

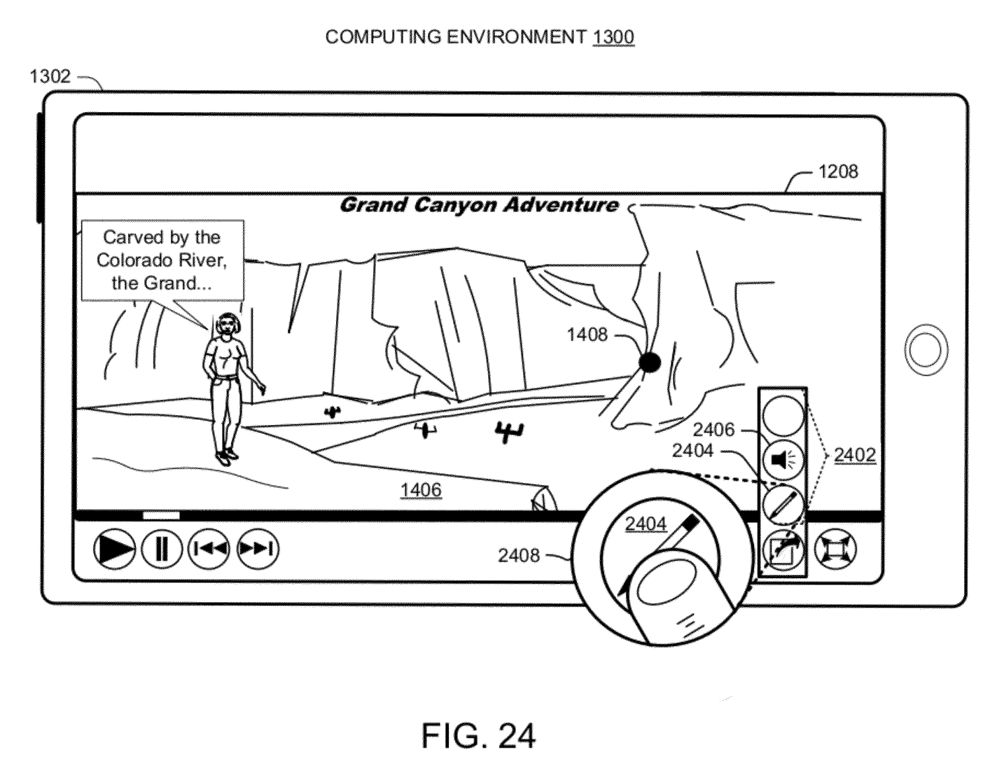

Continuing, as illustrated in FIG. 24, after selecting the annotation control 2304 in this example, a sub-set of selectable annotation controls 2402 can be automatically presented to the user. Note that each of the sub-set of annotation controls can be associated with a different type of annotation. For instance, here, the subset of annotation controls 2402 includes a text note annotation control 2404 and an audio note annotation control 2406. For discussion purposes, assume here that the user selects the text note annotation control 2404, as shown in callout 2408.

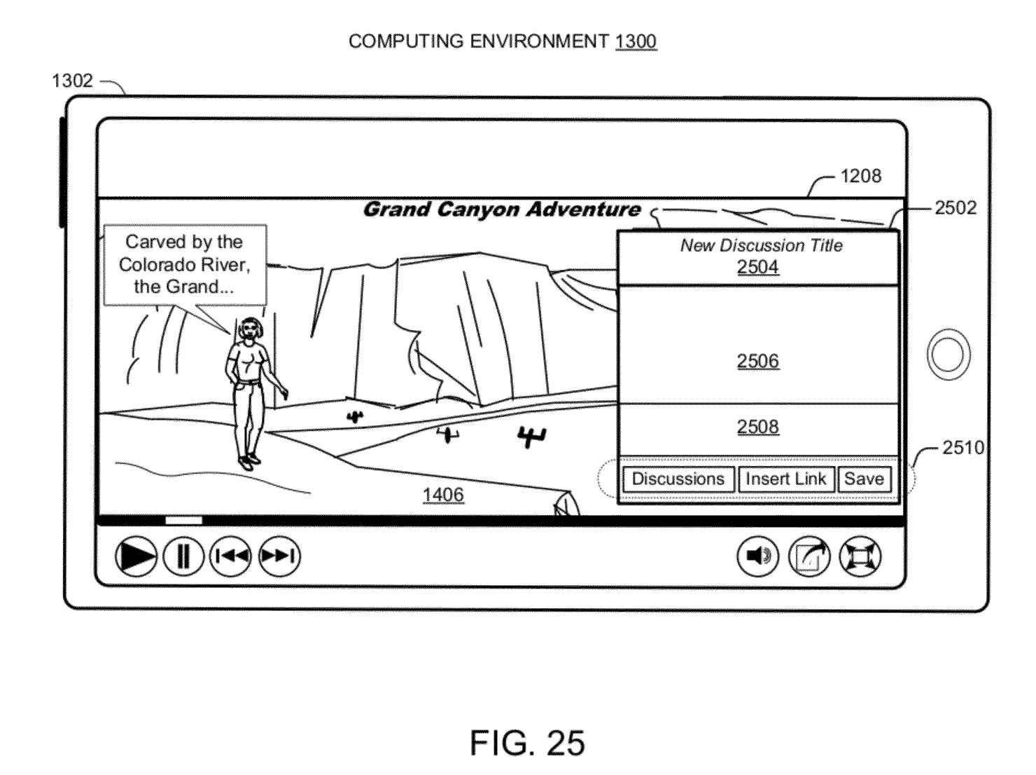

As shown in FIG. 25, as a result of the user selecting the text note annotation control 2404, a text note display and/or input box 2502 can be automatically presented to the user. In this scenario, since the user is not responding to another text note or other annotation, the text note display and/or input box 2502 includes a title portion 2504 that prompts the user to input a title for his/her discussion. In another scenario however, where the user is responding to an existing annotation, the title portion might, for instance, prompt the user to input a title for his/her response.

Continuing, in addition to the title portion 2504, in this example the text note display and/or input box 2502 also includes a text input region 2506 for the user to input his/her comments, a link region 2508 to display one or more inputted links (e.g., URLs) by the user, and a set of various selectable text note controls 2510, such as a discussions control to locate and/or link with other discussions, an insert link control to facilitate the user adding a link to the link region 2508, and a save control to allow the user to save his/her input as a final annotation after he/she is finished.

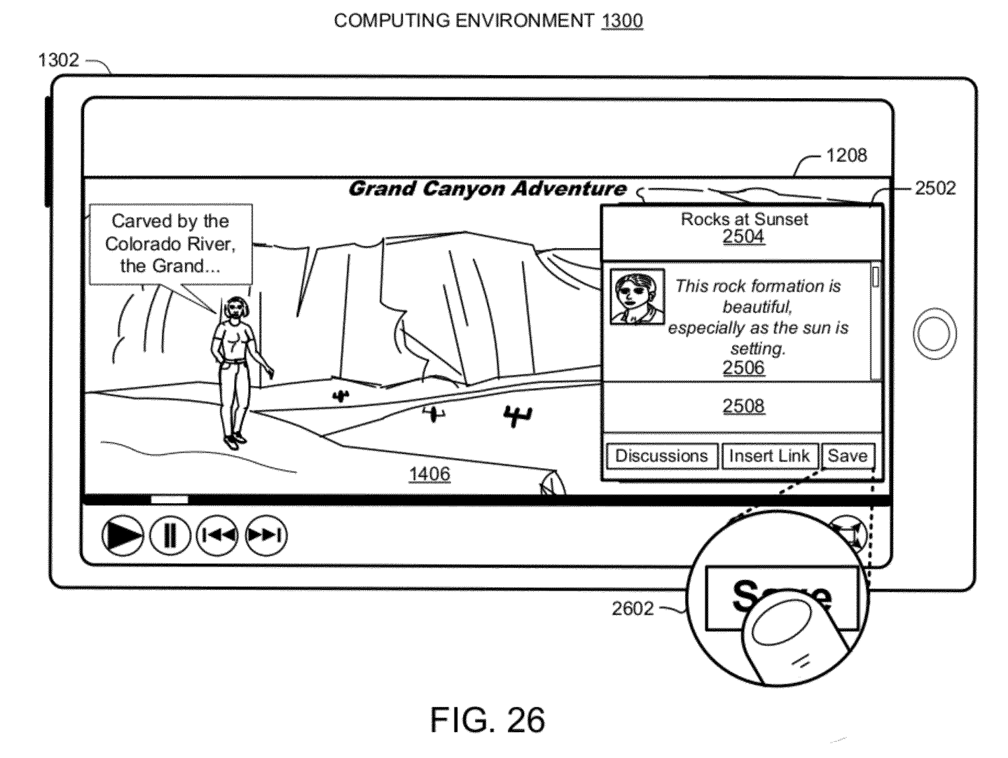

Now assume that as illustrated in FIG. 26, the user has finished adding (e.g., typing, etc.) their comments into the title portion 2504 and text input region 2506 of the text note display and/or input box 2502. Also assume that, as shown in callout 2602 the user then selects the save control to finalize and store their new annotation. As a result, and as shown in the callout 1502 of FIG. 15, the new annotation entitled “Rocks at Sunset” can be added to the RIN book 1202.

### X. Theming Support

Recall that the rich and personalized style of a RIN or RIN book can be manifest in that RIN's/RIN book's theme. A RIN's or RIN book's theme (i.e., RIN theme) can be thought of as the unique “look and feel” of that RIN/RIN book that defines the end-to-end styling and user experience that can be provided.

RIN themes may be created from scratch by an author. Alternatively or additionally, a new RIN theme may be created by the modification and/or enhancement of one or more existing RIN Themes. In at least one embodiment, functionality to facilitate RIN theming by a user (e.g., an RIN/RIN book author) can be provided by leveraging the structure of RIN Books, such as by leveraging the way RIN book resources are managed using one or more resource tables for instance.

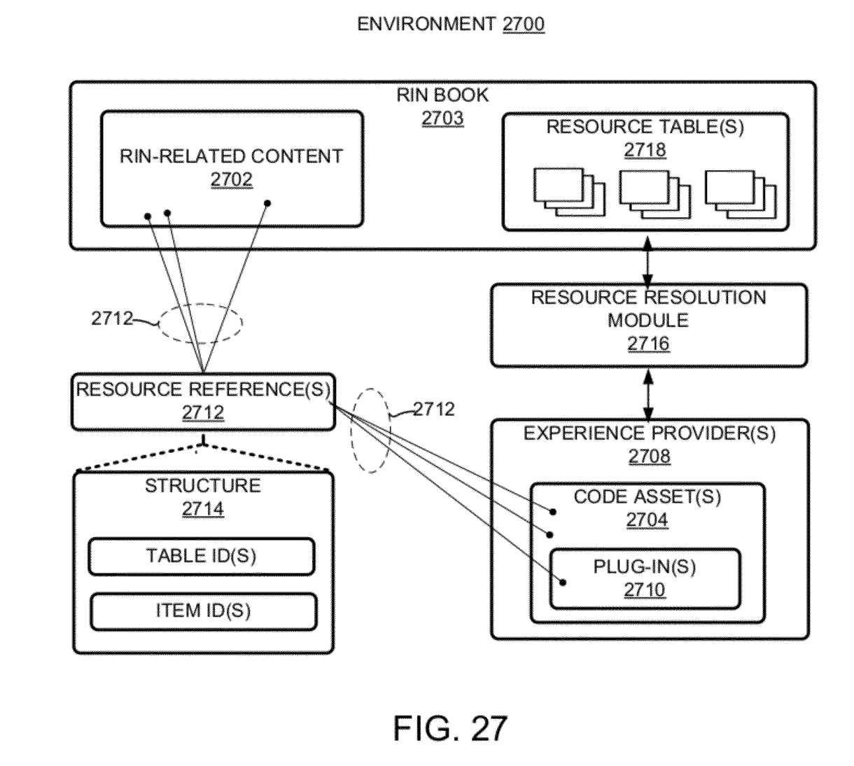

To facilitate the reader's understanding, FIG. 27 illustrates an example environment 2700 in which functionality to facilitate RIN theming can be provided by leveraging the way RIN book resources are managed using one or more resource tables.

Note that in this example, the example environment 2700 includes RIN-related content 2702 of a RIN book 2703 and one or more code assets 2704. Here, code asset(s) 2704 can include code or other types of functionality associated with one or more experience providers 2708. One practical example of code assets 2704 might be the code assets 1716A of RIN book 1702A described above and illustrated in FIG. 17A. The code assets 2704 can include, among other things, one or more plug-ins 2710 associated with (e.g., provided by) the experience provider(s) 2708. One practical example of an experience provider 2708 might be one of the RIN-related content providers 1912 described above and illustrated in FIG. 19.

Note that the RIN-related content 2702 and/or code assets 2704 may include any number of individual resource references 2712 identifying media, style information, and code that may be dynamically loaded to implement particular styles as dictated by a particular theme (e.g., for example icons, buttons, custom controls, etc.). For simplicity sake, only six individual lines representing six individual resource references are shown in this example.

As shown, in at least one embodiment, each of the individual resource references 2712 have a particular structure 2714 that includes one or more resource table identifier (table ID(s)) and resource item identifier (item ID(s)). Each table ID(s) of each individual resource reference can reference one or more particular resource tables in the RIN book 2703 and/or in any number of other RIN books. Each item ID(s) of each individual resource reference can reference one or more particular RIN-related content items within the resource table(s) referenced by the table ID of that resource reference.

In accordance with the described techniques, theming can be facilitated by implementing a resource resolution module 2716. The resource module may be implemented at least in part by one or more devices, such as one or more of the computing devices of the system 2200 and/or 3400 for instance.

The resource resolution module 2716 can be configured to select a set of resource tables 2718 of the RIN book to query to resolve a particular resource reference (of the resource reference(s) 2712) to a corresponding resource item containing data, such as one or more links (e.g., a uniform resource locator (URL)) to specific resources internal and/or external to the RIN book 2703.

While the resource resolution module 2716 may be implemented and configured in any suitable way, in at least one embodiment the resource resolution module 2716 can be implemented as part of a RIN player and/or RIN presentation platform, such as the RIN player 604, 602A, and/or as otherwise described herein (including in the U.S. patent application Ser. No. 13/008,324, filed Jan. 18, 2011, and which this application is a continuation-in-part of). As such, in at least one implementation, the resource resolution module 2716 may be included as one of the RIN experience tool(s) 1906 described above and illustrated in FIG. 19.

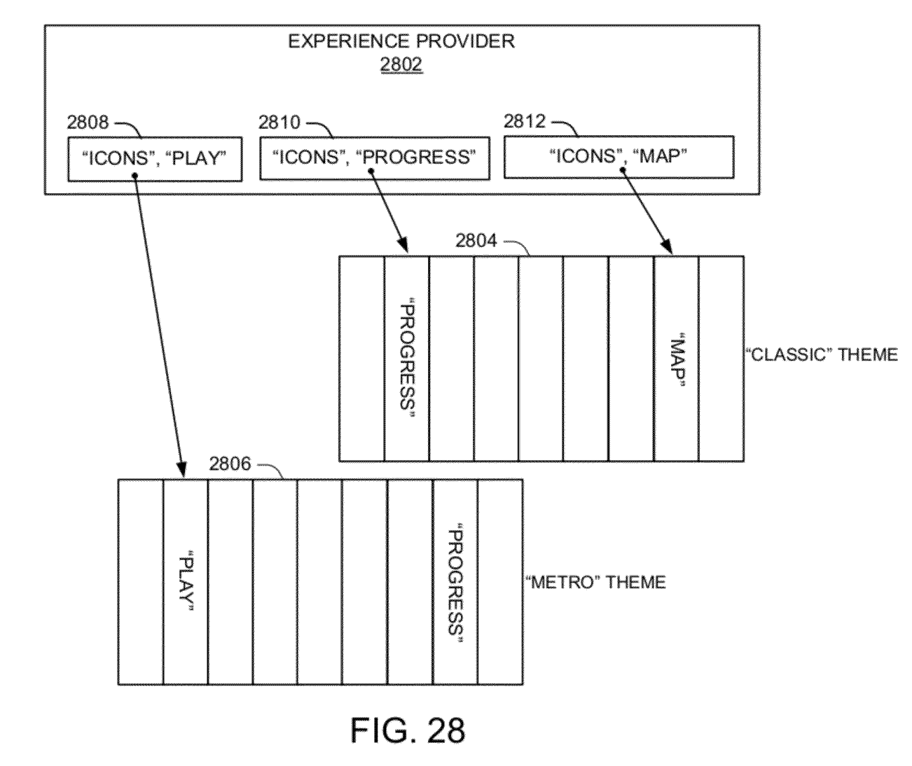

FIG. 28 illustrates an example of how the resource resolution module might be implemented, in at least one embodiment, to resolve a resource reference for table ID “icons” and three content item IDs, namely: “play”, “progress”, and “map”. In this example these three content item IDs refer to various RIN-related icon resources (referred to herein as icon content items) to be used for buttons in a RIN player control that may affect the RIN book's theme, such as RIN book 2703).

For discussion purposes, note that the example illustrated in FIG. 28 is described in the context of FIG. 27, including the example RIN book 2703, experience provider(s) 2708, resource resolution module 2716, resource table(s) 2718, etc.

Note that in this example, some of the icon content items from an experience provider 2802 of the experience provider(s) 2708 may be obtained via an icon resource table 2804 of the resource table(s) 2718 that is associated with a theme entitled “Classic”. Additionally, the other icon content items may obtained via an icon resource table 2806 of the resource table(s) 2718 that is associated with a theme entitled “Metro”.

Assume here that the theme “Classic” is derived from the theme “Classic”. Also assume that icon content items in the icon resource table 2804 (“Classic” theme) override corresponding identified icon content items in the icon resource table 2806 (“Metro” theme) if they exist. Thus, the resource resolution module 2716 can be configured to resolve individual icon content items provided by the experience provider 2802 to items listed in one of the icon resource tables 2804 or 2806.

More particularly, here in this example an icon content item 2808 (“icons”, “play”) is shown as being resolved to a listed item “play” in the icons resource table 2806 because there is no item with the “play” ID listed in the icons resource table 2804. On the other hand, an icon content item 2810 (“icons”, “progress”) is shown as being resolved to the icons resource table 2804 even though there is a content item with that ID in icons resource table 2806. This is because the icons resource table 2804 overrides the icons resource table 2806 in order to implement the functionality that the “Classic” theme derives (and possibly extends) from the “Metro” theme.

Continuing, an icon content item 2812 (“icons”, “map”) is also shown as being resolved to the icons resource table 2804. Note that there is no “map” item listed in the icons resource table 2806—thus illustrating the fact that a derived theme can extend the Classic theme. Note that even though this example refers to icon resources, this same technique can also apply to media assets, styling assets (such as Cascading Style Sheets or Microsoft XAML files), and code modules. In this way a new theme can override and extend an existing theme to any amount, depending on the degree of customization.

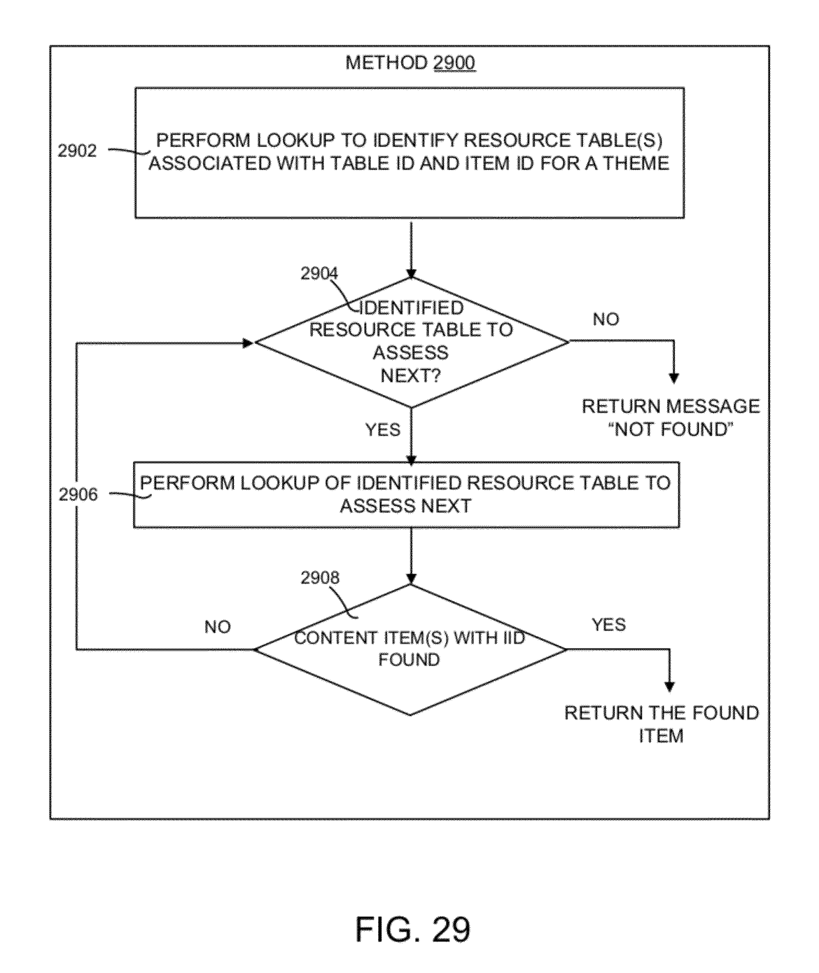

FIG. 29 illustrates a flowchart of a technique or method 2900 for facilitating RIN theming in accordance with the described techniques by processing a resource resolution request. The resource resolution request can identify a particular resource reference for a table ID (i.e., tid) and item ID (i.e., iid) associated with a certain theme (i.e., t).

In at least one embodiment, some or all of the technique or method 2900 may be implemented (e.g., as a computer algorithm, etc.) by a resource resolution module, such as the resource resolution module 2716 described above for instance. The resource module may be implemented at least in part by one or more computing resources, such as computing resources provided via one or more of the computing devices of the system 2200 or 3400, and/or via the cloud 2210 for instance. For example, in at least one embodiment, the resource resolution module can be included in the RIN experience tool(s) 1906.

At block 2902, a lookup of one or more resource tables (e.g., cascading resource tables) can be performed responsive to receiving a resource request referencing a tid and iid for one or more content items with a theme t. The lookup may result in the identification of one or more individual resource tables associated with tid and iid for t (if any exist). Furthermore, the lookup may also result in one or more base-resource tables corresponding to the resource table(s) (if any exist) and/or one or more additional resource tables associated with one or more ancestors of t (if any exist).

In at least one embodiment, identified resource table(s) can be organized in a list in an order. One example of such an order might be according to resource table derivation history (e.g., with the table associated with t (if any exist) occurring first and the base or default table occurring last).

In addition, a lookup can be performed to identify one or more resource tables representing a chain of one or more ancestor themes for the theme, if any such tables exist. This can be accomplished in any suitable way. For example, in at least one embodiment, an algorithm can resolve the resource table(s) based on a table ID reference (e.g., tid) and item ID reference (iid) associated with a particular theme (e.g., t).

In at least one embodiment the step at block 2902 only occurs once for a particular resource request (e.g., block 2902 might be an initialization step) and the results (e.g., the list) are cached or otherwise stored for retrieval.

At block 2904 a determination can be made of whether there is an identified resource table (e.g., any additional resource tables left) to assess next. For example, individual resource tables may be assessed from the top (i.e., first occurrence) of the list in descending order to the bottom of the list (i.e., the last occurrence). If there is not an identified resource table to assess next (e.g., the bottom of list has been reached), then a message such as “not found” can be returned.

However, if there is a resource table to assess next, then at block 2906 a lookup of the identified resource table to be assessed next (i.e., the identified resource table of interest) can be performed. Responsive to the lookup being performed at block 2906, at 2908 a determination can be made of whether one or more content items with the iid are found in the identified resource table of interest.

If a content item(s) is found, then the content item(s) can be returned. However, if a content item(s) is not found, a determination can then be made again at block 2904 whether any additional tables are left and the process described above can then followed again any number of times.

### XI RIN Segment Deep State

Recall that a user may watch and explore RIN related content such as a RIN or RIN book and at any point he/she may create an annotation that references their current point of exploration. This involves obtaining the logical state (keyframe) for the RIN Segment being explored as a whole, including accounting for the fact that the user may have paused the narrative and explored one or more experiences to get to a certain point that was not on the narrative path.

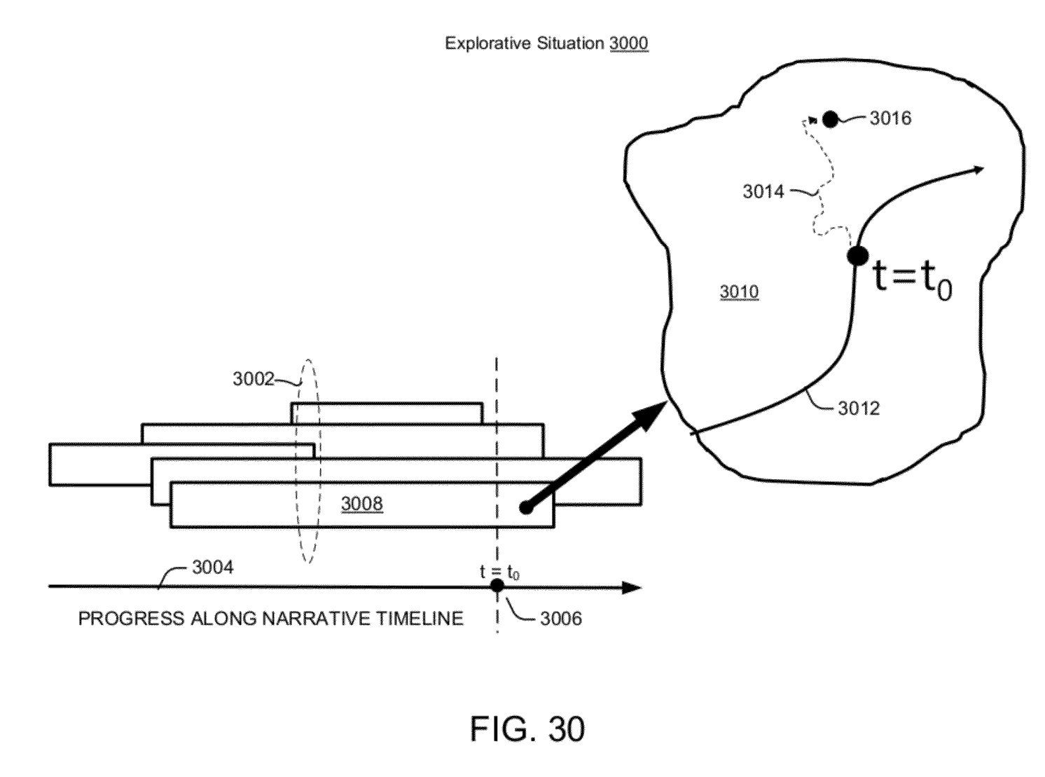

FIG. 30 illustrates an example interactive explorative situation 3000 where a user may be interactively exploring (and thus experiencing) a RIN Segment that is playing. More particularly, assume that in the explorative situation 3000 a set of experience streams 3002 is being orchestrated along a narrative timeline 3004 for the segment. Also assume that at some point 3006 (t=t₀ in narrative time), the user pauses the narrative (i.e., pauses the RIN segment) and then starts interactively exploring an experience associated with a particular experience stream 3008 of the set of experience streams 3002.

This interactive exploration by the user can be illustrated in a state space 3010 for the experience. The state space 3010 can represent the space of possible parameters (e.g., all possible parameters) that define the state of the experience at any point of time (e.g., as designated by a marker 502 in FIG. 5. Here, a scripted path is represented by a solid line 3012, while the path of user's interactive exploration is shown as the dotted line 3014 that leads to a certain point 3016 3012) in the state space 3010. The point 3016 can represent a certain configuration of the experience.

The state of the RIN Segment can be defined at this juncture. More particularly, the state of the RIN Segment can be defined as of the time 3006 at which the RIN Segment was paused, as well as the state (i.e. keyframe) of the experience at point 3012.

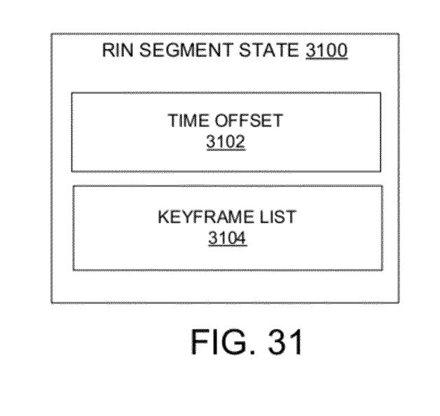

To further illustrate the state of a RIN segment in a more general sense, FIG. 31 illustrates a RIN segment state 3100 at a point where a user pauses the RIN segment to interactively explore an experience associated with a particular experience stream. Note that the RIN segment state 3100 can be defined by a RIN segment time offset 3102 and a keyframe list 3104. The time offset 3102 can be the time offset of the RIN segment being explored where the user pauses the experience stream (i.e., the segment pause time) to interactively explore the current environment. The keyframe list 3104 can be a list of one or more individual keyframes associated with the current state(s) of one or more experiences that have been modified by the user during their exploration subsequent to the user pausing the experience stream (i.e., after the segment pause time). In other words, the keyframe list 3104 can include keyframes for experience streams that the user has affected by their exploration.

Implicit in this RIN segment state definition is a possible situation when the experience stream associated with a first RIN segment being explored is itself a RIN Segment (e.g., is another second RIN segment within the first RIN segment). This situation can be thought of as a RIN-within-a-RIN scenario, and can include any number of hierarchical levels of RIN segments within other RIN segments (i.e., any number of RIN-within-a-RIN layers). As noted one or more annotations can be added to a RIN segment within another RIN segment, at any level or levels. In a RIN-within-a-RIN situation, the RIN segment state can be computed recursively. In other words, the state of the explored experience can be computed following the process of capturing the RIN segment state as already outlined—and as applied to the second RIN Segment. Because this RIN segment state can be computed recursively, this process can be applied to capture RIN Segments with arbitrary levels of complexity, including arbitrary levels of RIN Segments executing within RIN Segments.

### XII Alternative or Additional RIN Books Hosting Platform

Recall that to facilitate various sharing arrangements, a RIN Books hosting platform may implement virtual storefronts, each of which implements a particular set of policies as required by a particular publishing organization or individual. Feature options can include any number of configurable sharing controls which may impose and enforce various sharing limitations for all or some of the RIN-related content items published on the RIN Books hosting platform.

Also recall that to facilitate the reader's understanding, an example implementation environment 1900 was described above in the context of FIG. 19. The implementation environment 1900 included an example RIN books hosting platform 1902. However, the RIN books hosting platform 1902 is just one example of a wide variety of RIN books hosting platform embodiments that may be implemented to provide the functionality described herein.

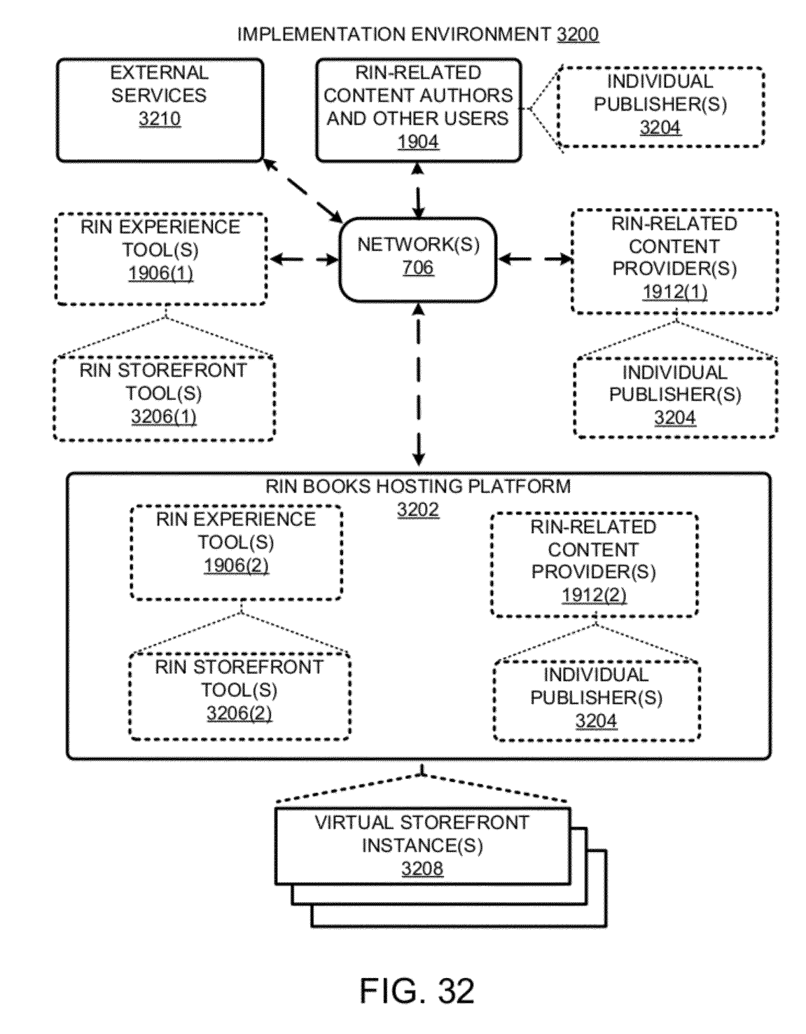

Therefore to further facilitate the reader's understanding, FIG. 32 illustrates an alternative or additional instance of implementation environment 1900, namely as an implementation environment 3200. Note that the implementation environment 3200 is also presented in the context of the one or more network(s) 706 of the generalized and exemplary environment illustrated in FIG. 7 and described above.

In this instance, the implementation environment 3200 includes a RIN books hosting platform 3202 that may be implemented alternatively to, or additionally with, the RIN books hosting platform 1902. For example, in at least one embodiment some or all of the RIN books hosting platform 1902 and the RIN books hosting platform 3202 can be implemented in accordance with the described techniques.

Note here that one or more individual RIN-related content publishers 3204 may be included in the RIN-related content authors and other users 1904, the RIN-related content provider(s) 1912(1), and/or the RIN-related content provider(s) 1912(1). Also note that one or more RIN storefront tools 3206 (e.g., RIN storefront software) may be included in the RIN experience tool(s) 1906(1) and/or 1906(2). The RIN storefront tool(s) 3206 may be utilized to allow individual RIN-related content publishers 3202 and/or other RIN-related content authors and other users 1904 to access the RIN books hosting platform 3202, and thus access one or more virtual storefront instance(s) 3208.

Note that in this example, the implementation environment 2300 includes one or more external services 3210 that may provide advertisements and/or other types of content to be included in one or more of the virtual storefront instance(s) 3208. Without limitation, examples of types of external services 3210 can include content management systems, content distribution systems, third-party advertisement serving platforms, third-party user authentication platforms, third-party application stores, third-party Web-based payment services, and the like.

In at least one embodiment, some or all of the functionality of the RIN books hosting platform 1902 (e.g., the security platform module 1920, sharing controls 1914, and/or platform management module 1924) may be provided by the RIN books hosting platform 3202. Alternatively, in at least one embodiment, the RIN books hosting platform 3202 may not include at least some of the functionality of the RIN books hosting platform 1902. In either case, functionality provided by the RIN books hosting platform 3202 can allow for hosting, maintaining, and otherwise implementing the virtual storefront instance(s) 3208.

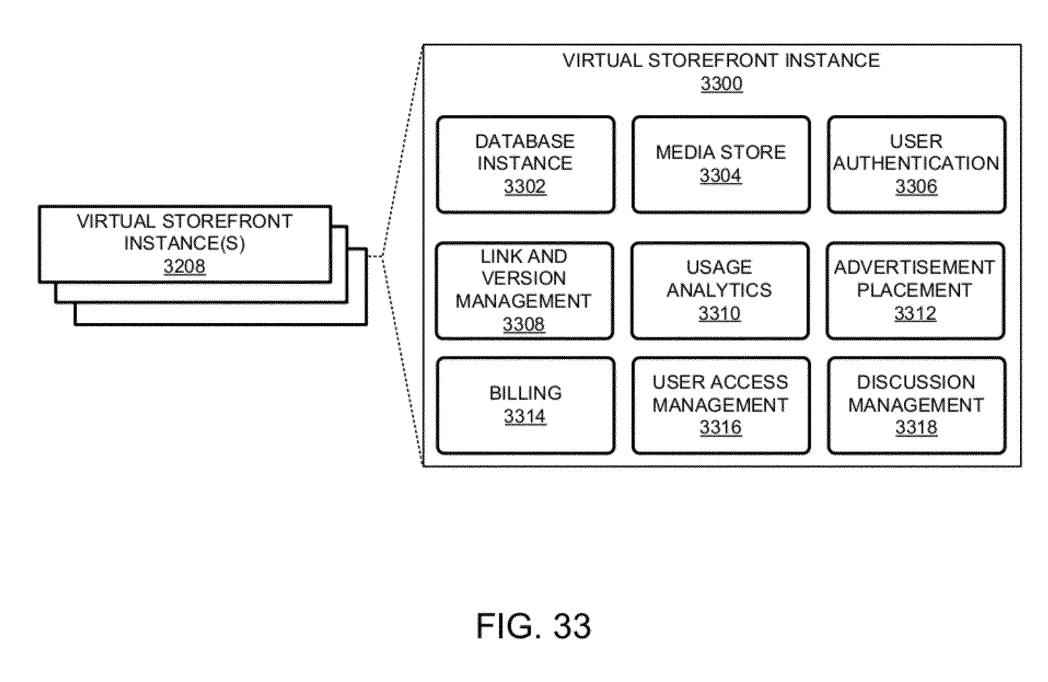

To further illustrate the features that may be associated with the virtual storefront instance(s) 3208, FIG. 33 illustrates an example virtual storefront instance 3300. Recall that in at least one embodiment, each individual storefront instance may correspond with and support an individual publisher (e.g., one of the individual publisher(s) 3204) to access the RIN books hosting platform 3202 via the RIN storefront tool(s) 3206.

Accordingly, assume that the virtual storefront instance 3300 corresponds with an individual publisher who can access the RIN books hosting platform 3202, and thus the virtual storefront instance 3300, via the RIN storefront tool(s) 3206. The RIN storefront tool(s) 3206 can be utilized by the publisher to perform RIN sharing activities related to a particular published RIN-related content (e.g., creating, editing, publishing, uploading, etc.). The RIN storefront tool(s) 3206 can also be utilized by other types of users to participate in discussions involving RIN books, edit and publish derived content based on existing RIN books, etc.

In at least one embodiment, each instance of a virtual storefront, including the virtual storefront instance 3300, can cater to a particular publisher and provide a set of virtual services and resources that behave according to particular policy setup (by the publisher) concerning user access models, monetization models, etc, as previously described.

Here in this example, note that the virtual storefront instance 3300 includes various components that might be utilized by the RIN storefront tool(s) 3206 to implement various services for publishers and users. More particularly, in this example, the virtual storefront 3300 includes a database instance 3302 that can be configured to store various RIN-book related content such as collections, resource tables, discussion lists, and the like.

In addition, the virtual storefront 3300 includes a media store 3304 that can be configured to store RIN-related content items such as text, audio, video, and the like. Furthermore, the virtual storefront 3300 includes additional components that can be configured for the corresponding publisher, including a user authentication component 3306 that can be configured to handle authentication activities, a user access management component 3316 which can be configured to restrict access to the virtual storefront instance 3300 based on the authentication activities, and a billing component 3314 which can be configured to handle financial billing transactions associated with RIN-related content published on the virtual storefront instance 3300.

Continuing, in addition to the above modules, here the virtual storefront instance 3300 also includes various services that are bound to data specific to the particular virtual storefront instance 3300. More particularly, the virtual storefront instance 3300 includes a link and version management component 3308. The link and version management component 3308 can be configured to track various versions of RIN-related content and maintain one or more links to ensure that individual versions are up to date. In this regard, the link and version management component 3308 can be configured to perform these tracking and maintenance functions even when the RIN-related content is being edited, and to flag internal and/or external links that may be invalid because they point to resources that no longer exist.

Additionally, the virtual storefront instance 3300 can also include an advertisement placement component 3312 that can be configured to create live RIN-related content, such as live embedded content based on advertisements provided by one or more third-party advertising serving platforms of the external services 3210.

Third-party advertising platforms may require reporting of advertisement statistics. Some reporting may happen directly from the RIN books hosting platform 3202 running on a user's device for instance. Alternatively or additionally however, the server-side statistics reporting can be handled in at least one embodiment by a usage analytics component 3310 of the virtual storefront instance 3300. The usage analytics component 3310 can additionally be configured to provide usage statistics to a publisher and/or to interact with the billing component 3314 to enforce any billing requirements for particular users.

The virtual storefront instance also includes a discussions management component 3318 that can be configured to manage user-contributed discussions over individual RIN Books and/or other RIN-related content hosted by that publisher and/or another publisher or user.

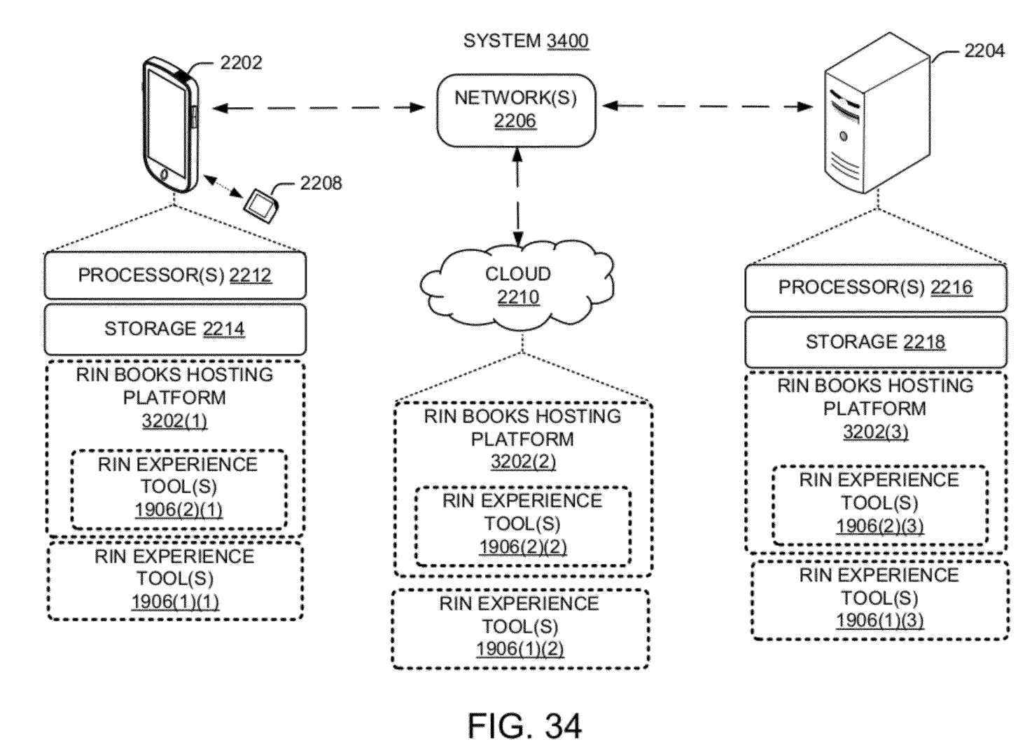

FIG. 34 illustrates an alternative or additional instance of the example system 2200 described above and illustrated in FIG. 22, namely as an example system 3400. Note that the system 3400 includes the multiple computing devices 2202 and 2204, the network(s) 2206 and the computing-related resources/functionalities of the cloud 2210.

Here in this example, the computing device 2202 is shown embodied as a hand-held computing device, such as computing device 606 and/or 1302 described above for instance. Computing device 2204, in turn, is shown in this example embodied as one or more server computer devices. However, this is not intended to be limiting and it is to be appreciated and understood that the example system 3400 can include any number and type(s) of computing devices.

Here in this example the computing device 2202 is shown as being configured to implement at least part of the RIN Books hosting platform 3202. Note that in this regard, and as described above, all or part of the RIN experience tool(s) 1906 (and thus all or part of the RIN storefront tool(s) 3206) may be provided by/via the RIN Books hosting platform 3202 as RIN Books hosting platform instance(s) 1906(2).

Alternatively or additionally, all or part of the RIN experience tool(s) 1906 may be provided outside of the RIN Books hosting platform 3202. Accordingly, here the computing device 2202 is also shown as being configured to implement all or part of the non-RIN Books hosting platform instance(s) 190 6(1) (and thus all or part of the RIN storefront tool(s) 3206) of the RIN experience tool(s) 1906.

To emphasize that all or part of the RIN Books hosting platform 3202 and/or the RIN storefront tool(s) 3206 may be implemented by any number and suitable type of computing resources, here the cloud-based computing resources available via the cloud 2210, and the computing device 2204, are also each shown as being configured to implement at least part of the RIN Books hosting platform 3202 and/or RIN experience tool(s) non-hosting platform instance(s) 1906(1).

In operation, in at least one scenario the computing device 2202 may function in a stand-alone configuration such that all of the RIN Books hosting platform 3202 and/or RIN experience tool(s) 1906 and thus all or part of the RIN storefront tool(s) 3206 are implemented by the computing device 2202. In at least one other scenario however, at least some (if not all) of the RIN Books hosting platform 3202 and/or RIN experience tool(s) 1906 are implemented by the cloud-based computing resources and/or by the computing device 2204.

### CONCLUSION

Methods, devices, systems, etc., pertaining to techniques associated with rich interactive narratives (RINs) and RIN-related content are described, including techniques for sharing and monetizing such content. However, it is to be understood that the subject matter defined in the appended claims is not necessarily limited to the specific features or acts described. Rather, the specific features and acts are disclosed as exemplary forms for implementing the claimed methods, devices, systems, etc.

1. A method comprising:
obtaining a content item comprising at least one rich interactive narrative (RIN) configured to provide an interactive explorative experience;
editing the content item with an annotation at a point in time along a scripted path of the interactive explorative experience; and
publishing the edited content item.

2. The method of claim 1, wherein the content item is a RIN book comprising the at least one RIN and one or more associated media data items.

3. The method of claim 1, wherein the annotation comprises at least one new linear or non-linear scripted path.

4. The method of claim 1, wherein editing the content item with the annotation comprises embedding an artifact or highlight in the content item, the artifact or highlight being configured to be positioned and rendered as the interactive explorative experience is interactively explored.

5. The method of claim 1, wherein editing the content item with the annotation comprises editing an experience stream of the content at the point in time, the experience stream associated with at least one other RIN and comprising at least one new scripted path through an environment of the interactive explorative experience.

6. The method of claim 1, wherein the content item comprises a published content item obtained from a hosting platform, and wherein publishing the edited content item comprises re-publishing the edited content item on the hosting platform as a derivative work of the content item.

7. A system comprising:
one or more tools configured to publish a content item on a hosting platform, the content item comprising at least one rich interactive narrative (RIN);
a security module configured to enforce one or more sharing limitations associated with the published content item; and
a management module configured to utilize enforcement of the one or more sharing limitations to monetize the published content item.

8. The system of claim 7, wherein the one or more tools comprise an authoring system or a presentation platform provided at least in part by the hosting platform.

9. The system of claim 7, wherein the sharing limitations are based on sharing restriction criteria comprising one or both of: user-specific restriction criteria or item-specific restriction criteria.

10. The system of claim 9, wherein the sharing restriction criteria comprise at least one of: digital rights management (DRM) protection, embedded advertisements, a membership or subscription requirement, or a fee requirement.

11. The system of claim 7, wherein the hosting platform comprises the security module and management module, and wherein the hosting platform is configured to implement an online marketplace for sharing the published content item.

12. The system of claim 7, wherein the security module is configured to enforce the one or more sharing limitations via one or more sharing controls.

13. The system of claim 12, wherein the one or more sharing controls comprise at least one platform-level sharing control or data item-level sharing control.

14. The system of claim 12, wherein the management module is configured to utilize the enforcement of the one or more sharing limitations to monetize the published content item at least in part by:
determining whether one or more sharing restriction criteria of the sharing limitations is satisfied; and
control an enforcement activity of one or more of the sharing controls based on the determination.

15. A method comprising;
editing a rich interactive narrative (RIN) book configured to provide an interactive explorative experience, the RIN book comprising at least one RIN with at least one scripted path associated with the interactive explorative experience, the editing comprising:
obtaining a RIN-related content item from a media platform;
utilizing the RIN-related content item to edit the RIN book; and
sharing the edited RIN book by publishing the edited RIN book on the hosting platform as a derivative work.

16. The method of claim 15, wherein the RIN-related content item comprises at least one other RIN or RIN component with at least one other scripted path.

17. The method of claim 16, wherein the editing further comprises changing a theme of the RIN book from a first theme to a second theme derived from the first theme.

18. The method of claim 15, wherein the RIN-related content item comprises an experience stream comprising environmental data, artifacts, highlights, and a trajectory that are associated with the at least one other scripted path.

19. The method of claim 17, wherein adding the at least one other RIN to the RIN book results in the RIN book being configured to provide a new interactive explorative experience.

20. The method of claim 15, wherein a scene of the at least one scripted path is composed of at least one RIN segment with an experience stream comprising at least one other RIN segment, and wherein utilizing the RIN-related content item to edit the RIN book comprises adding at least one annotation to the RIN book that references a point of exploration associated with the at least one other RIN segment.
